(19) United States
(12) Patent Application Publication
(10) Pub. No.: US 2015/0352450 A1
(43) Pub. Date: Dec. 10, 2015

(54) SYSTEMS AND METHODS FOR DISPLAYING FANTASY LEAGUE INFORMATION

(71) Applicants: Beth Burrows, North Bend, WA (US); Kevin Burrows, North Bend, WA (US); Aaron Ethington, North Bend, WA (US)

(72) Inventors: Beth Burrows, North Bend, WA (US); Kevin Burrows, North Bend, WA (US); Aaron Ethington, North Bend, WA (US)

(21) Appl. No.: 14/296,058

(22) Filed: Jun. 4, 2014

(51) Int. Cl. A63F 13/828; A63F 13/86

(52) U.S. Cl. CPC A63F 13/828; A63F 13/86

(57) ABSTRACT

Methods and systems for displaying fantasy league information are disclosed. In some embodiments, fantasy league information may be displayed as an overlay on broadcast content.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### SUMMARY

In one aspect, a method may include, but is not limited to, receiving information associated with at least one fantasy team that includes at least one fantasy team attribute selected by at least one participant in a fantasy league through a user interface, receiving information associated with one or more requests for broadcast content from the at least one participant through the user interface, transmitting the information that includes the at least one fantasy team attribute associated with the at least one fantasy team associated with the at least one participant in the fantasy league, and transmitting information associated with the one or more requests for broadcast content from the at least one participant. In some embodiments, a method may optionally include, but is not limited to, receiving one or more instructions to display one or more indicators selected by the participant in response to one or more events associated with one or more players selected by the at least one participant for inclusion on the at least one fantasy team and transmitting the one or more instructions to display the one or more indicators selected by the participant in response to the one or more events associated with the one or more players selected by the at least one participant. In addition to the foregoing, other method aspects are described in the claims, drawings, and text forming a part of the present disclosure.

In one aspect, a system may include, but is not limited to, circuitry configured to receive information associated with at least one fantasy team that includes at least one fantasy team attribute selected by at least one participant in a fantasy league, circuitry configured to receive information associated with one or more requests for broadcast content from the at least one participant, circuitry configured to transmit the information that includes the at least one fantasy team attribute associated with the at least one fantasy team associated with the at least one participant in the fantasy league, and circuitry configured to transmit the information associated with the one or more requests for broadcast content from the at least one participant. In some embodiments, a system may optionally include, but is not limited to, circuitry configured to receive one or more instructions to display one or more indicators selected by the participant in response to one or more events associated with one or more players selected by the at least one participant for inclusion on the at least one fantasy team and circuitry configured to transmit the one or more instructions to display the one or more indicators selected by the participant in response to the one or more events associated with the one or more players selected by the at least one participant. In addition to the foregoing, other system aspects are described in the claims, drawings, and text forming a part of the present disclosure.

In one aspect, a system may include, but is not limited to, a non-transitory signal-bearing medium bearing at least: one or more instructions to receive information associated with at least one fantasy team that includes at least one fantasy team attribute selected by at least one participant in a fantasy league through a user interface, one or more instructions to receive information associated with one or more requests for broadcast content from the at least one participant through the user interface, one or more instructions to transmit the information that includes the at least one fantasy team attribute associated with the at least one fantasy team associated with the at least one participant in the fantasy league, and one or more instructions to transmit the information associated with the one or more requests for broadcast content from the at least one participant. In some embodiments, a system may optionally include, but is not limited to, one or more instructions to receive one or more instructions to display one or more indicators selected by the participant in response to one or more events associated with one or more players selected by the at least one participant for inclusion on the at least one fantasy team and one or more instructions to transmit the one or more instructions to display the one or more indicators selected by the participant in response to the one or more events associated with the one or more players selected by the at least one participant. In addition to the foregoing, other system aspects are described in the claims, drawings, and text forming a part of the present disclosure.

In one aspect, a system may include, but is not limited to, means for receiving information associated with at least one fantasy team that includes at least one fantasy team attribute selected by at least one participant in a fantasy league through a user interface, means for receiving information associated with one or more requests for broadcast content from the at least one participant through the user interface, means for transmitting the information that includes the at least one fantasy team attribute associated with the at least one fantasy team associated with the at least one participant in the fantasy league, and means for transmitting the information associated with the one or more requests for broadcast content from the at least one participant. In some embodiments, a system may optionally include, but is not limited to, means for receiving one or more instructions to display one or more indicators selected by the participant in response to one or more events associated with one or more players selected by the at least one participant for inclusion on the at least one fantasy team and means for transmitting the one or more instructions to display the one or more indicators selected by the participant in response to the one or more events associated with the one or more players selected by the at least one participant. In addition to the foregoing, other system aspects are described in the claims, drawings, and text forming a part of the present disclosure.

In one aspect, a method may include, but is not limited to, receiving information associated with one or more players selected by at least one participant in a fantasy league for inclusion in a fantasy team associated with the at least participant, receiving information provided by the at least one participant associated with at least one fantasy team attribute of the fantasy team associated with the at least participant, receiving broadcast content in response to a request from the at least one participant, retrieving non-broadcast information associated with any of the one or more players selected by the at least one participant for inclusion in the fantasy team associated with the at least participant, transmitting one or more instructions to display a descriptor associated with at least one of the one or more players in accordance with their inclusion in the fantasy team associated with the at least one participant, transmitting one or more instructions to display the non-broadcast information associated with at least one of the one or more players in accordance with their inclusion in the fantasy team associated with the at least one participant, transmitting one or more instructions to display the at least one fantasy team attribute, and transmitting one or more instructions to display the broadcast content as an overlay display. In some embodiments, a method may optionally include, but is not limited to, transmitting one or more instructions to display one or more indicators in response to one or events associated with the one or more players. In addition to the foregoing, other method aspects are described in the claims, drawings, and text forming a part of the present disclosure.

In one aspect, a system may include, but is not limited to, circuitry configured to receive information associated with one or more players selected by at least one participant in a fantasy league for inclusion in a fantasy team associated with the at least participant, circuitry configured to receive information provided by the at least one participant associated with at least one fantasy team attribute of the fantasy team associated with the at least participant, circuitry configured to receive broadcast content in response to a request from the at least one participant, circuitry configured to retrieve non-broadcast information associated with any of the one or more players selected by the at least one participant for inclusion in the fantasy team associated with the at least participant, circuitry configured to transmit one or more instructions to display a descriptor associated with at least one of the one or more players in accordance with their inclusion in the fantasy team associated with the at least one participant, circuitry configured to transmit one or more instructions to display the non-broadcast information associated with at least one of the one or more players in accordance with their inclusion in the fantasy team associated with the at least one participant, circuitry configured to transmit one or more instructions to display the at least one fantasy team attribute, and circuitry configured to transmit one or more instructions to display the broadcast content as an overlay display. In some embodiments, a system may optionally include, but is not limited to, circuitry configured to transmit one or more instructions to display one or more indicators in response to one or events associated with the one or more players. In addition to the foregoing, other system aspects are described in the claims, drawings, and text forming a part of the present disclosure.

In one aspect, a system may include, but is not limited to, a non-transitory signal-bearing medium bearing at least: one or more instructions to receive information associated with one or more players selected by at least one participant in a fantasy league for inclusion in a fantasy team associated with the at least participant, one or more instructions to receive information provided by the at least one participant associated with at least one fantasy team attribute of the fantasy team associated with the at least participant, one or more instructions to receive broadcast content in response to a request from at least one participant, one or more instructions to retrieve non-broadcast information associated with any of the one or more players selected by the at least one participant for inclusion in the fantasy team associated with the at least participant, one or more instructions to transmit one or more instructions to display a descriptor associated with at least one of the one or more players in accordance with their inclusion in the fantasy team associated with the at least one participant, one or more instructions to transmit one or more instructions to display the non-broadcast information associated with at least one of the one or more players in accordance with their inclusion in the fantasy team associated with the at least one participant, one or more instructions to transmit one or more instructions to display the at least one fantasy team attribute, and one or more instructions to transmit one or more instructions to display the broadcast content as an overlay display. In some embodiments, a system may optionally include, but is not limited to, one or more instructions to transmit one or more instructions to display one or more indicators in response to one or events associated with the one or more players. In addition to the foregoing, other system aspects are described in the claims, drawings, and text forming a part of the present disclosure.

In one aspect, a system may include, but is not limited to, means for receiving information associated with one or more players selected by at least one participant in a fantasy league for inclusion in a fantasy team associated with the at least participant, means for receiving information provided by the at least one participant associated with at least one fantasy team attribute of the fantasy team associated with the at least participant, means for receiving broadcast content in response to a request from the at least one participant, means for retrieving non-broadcast information associated with any of the one or more players selected by the at least one participant for inclusion in the fantasy team associated with the at least participant, means for transmitting one or more instructions to display a descriptor associated with at least one of the one or more players in accordance with their inclusion in the fantasy team associated with the at least one participant, means for transmitting one or more instructions to display the non-broadcast information associated with at least one of the one or more players in accordance with their inclusion in the fantasy team associated with the at least one participant, means for transmitting one or more instructions to display the at least one fantasy team attribute; and means for transmitting one or more instructions to display the broadcast content as an overlay display. In some embodiments, a system may optionally include, but is not limited to, means for transmitting one or more instructions to display one or more indicators in response to one or events associated with the one or more players. In addition to the foregoing, other system aspects are described in the claims, drawings, and text forming a part of the present disclosure.

In one aspect, a method may include, but is not limited to, receiving one or more instructions to display at least one descriptor associated with at least one of one or more players that are included in a fantasy team associated with at least one participant in a fantasy league, receiving one or more instructions to display the non-broadcast information associated with at least one of the one or more players that are included in the fantasy team associated with the at least one participant, receiving one or more instructions to display at least one fantasy team attribute, receiving one or more instructions to display the broadcast content as an overlay display, displaying the at least one descriptor associated with the at least one of one or more players selected by the at least one participant, displaying the non-broadcast information associated with the at least one of the one or more players selected by the at least one participant, displaying at least one fantasy team attribute, and displaying the broadcast content as an overlay display. In some embodiments, a method may optionally include, but is not limited to, receiving one or more instructions to display one or more indicators in response to one or events associated with the one or more players and displaying the one or more indicators in response to one or events associated with the one or more players. In addition to the foregoing, other method aspects are described in the claims, drawings, and text forming a part of the present disclosure.

In one aspect, a system may include, but is not limited to, circuitry configured to receive one or more instructions to display at least one descriptor associated with at least one of one or more players that are included in a fantasy team associated with at least one participant in a fantasy league, circuitry configured to receive one or more instructions to display the non-broadcast information associated with at least one of the one or more players that are included in the fantasy team associated with the at least one participant, circuitry configured to receive one or more instructions to display at least one fantasy team attribute, circuitry configured to receive one or more instructions to display the broadcast content as an overlay display, circuitry configured to display the at least one descriptor associated with the at least one of one or more players selected by the at least one participant, circuitry configured to display the non-broadcast information associated with the at least one of the one or more players selected by the at least one participant, circuitry configured to display at least one fantasy team attribute, and circuitry configured to display the broadcast content as an overlay display. In some embodiments, a system may optionally include, but is not limited to, circuitry configured to receive one or more instructions to display one or more indicators in response to one or more events associated with the one or more players and circuitry configured to display the one or more indicators in response to one or events associated with the one or more players. In addition to the foregoing, other system aspects are described in the claims, drawings, and text forming a part of the present disclosure.

In one aspect, a system may include, but is not limited to, a non-transitory signal-bearing medium bearing at least: one or more instructions to receive one or more instructions to display at least one descriptor associated with at least one of one or more players that are included in a fantasy team associated with at least one participant in a fantasy league, one or more instructions to receive one or more instructions to display the non-broadcast information associated with at least one of the one or more players that are included in the fantasy team associated with the at least one participant, one or more instructions to receive one or more instructions to display at least one fantasy team attribute, one or more instructions to receive one or more instructions to display the broadcast content as an overlay display, one or more instructions to display the at least one descriptor associated with the at least one of one or more players selected by the at least one participant, one or more instructions to display the non-broadcast information associated with the at least one of the one or more players selected by the at least one participant, one or more instructions to display at least one fantasy team attribute, and one or more instructions to display the broadcast content as an overlay display. In some embodiments, a system may optionally include, but is not limited to, one or more instructions to receive one or more instructions to display one or more indicators in response to one or more events associated with the one or more players, and one or more instructions to display the one or more indicators in response to one or events associated with the one or more players. In addition to the foregoing, other system aspects are described in the claims, drawings, and text forming a part of the present disclosure.

In one aspect, a system may include, but is not limited to, means for receiving one or more instructions to display at least one descriptor associated with at least one of one or more players that are included in a fantasy team associated with at least one participant in a fantasy league, means for receiving one or more instructions to display the non-broadcast information associated with at least one of the one or more players that are included in the fantasy team associated with the at least one participant, means for receiving one or more instructions to display at least one fantasy team attribute, means for receiving one or more instructions to display the broadcast content as an overlay display, means for displaying the at least one descriptor associated with the at least one of one or more players selected by the at least one participant, means for displaying the non-broadcast information associated with the at least one of the one or more players selected by the at least one participant, means for displaying at least one fantasy team attribute, and means for displaying the broadcast content as an overlay display. In some embodiments, a system may optionally include, but is not limited to, means for receiving one or more instructions to display one or more indicators in response to one or more events associated with the one or more players and means for displaying the one or more indicators in response to one or events associated with the one or more players. In addition to the foregoing, other system aspects are described in the claims, drawings, and text forming a part of the present disclosure.

In one aspect, a method may include, but is not limited to, receiving information associated with at least one participant in a fantasy league, assigning a unique identifier to the at least one participant, receiving information associated with one or more players selected by the at least one participant to form at least one fantasy team that is associated with the at least one participant and linking the unique identifier assigned to the at least one participant to each of the players selected by the at least one participant, receiving information associated with at least one fantasy team attribute selected by the at least one participant and then linking the at least one fantasy team attribute selected by the at least one participant with the unique identifier assigned to the at least one participant, receiving broadcast content in response to a request from the at least one participant, retrieving non-broadcast information associated with any of the one or more players selected by the at least one participant and then linking the information to the unique identifier assigned to the at least one participant, transmitting one or more instructions to display a descriptor associated with the one or more players selected by the at least one participant, transmitting one or more instructions to display the non-broadcast information associated with the one or more players selected by the at least one participant, transmitting one or more instructions to display the fantasy team attribute selected by the at least one participant according to the unique identifier assigned to the at least one participant, and transmitting one or more instructions to display the broadcast content as an overlay display. In some embodiments, a method may optionally include, but is not limited to, transmitting one or more instructions to display one or more indicators in response to one or events associated with the one or more players selected by the at least one participant. In addition to the foregoing, other method aspects are described in the claims, drawings, and text forming a part of the present disclosure.

In one aspect, a system may include, but is not limited to, circuitry configured to receive information associated with at least one participant in a fantasy league, circuitry configured to assign a unique identifier to the at least one participant, circuitry configured to receive information associated with one or more players selected by the at least one participant to form at least one fantasy team that is associated with the at least one participant and linking the unique identifier assigned to the at least one participant to each of the players selected by the at least one participant, circuitry configured to receive information associated with at least one fantasy team attribute selected by the at least one participant and then linking the at least one fantasy team attribute selected by the at least one participant with the unique identifier assigned to the at least one participant, circuitry configured to receive broadcast content in response to a request from the at least one participant, circuitry configured to retrieve non-broadcast information associated with any of the one or more players selected by the at least one participant and then linking the information to the unique identifier assigned to the at least one participant, circuitry configured to transmit one or more instructions to display a descriptor associated with the one or more players selected by the at least one participant, circuitry configured to transmit one or more instructions to display the non-broadcast information associated with the one or more players selected by the at least one participant, circuitry configured to transmit one or more instructions to display the fantasy team attribute selected by the at least one participant according to the unique identifier assigned to the at least one participant, and circuitry configured to transmit one or more instructions to display the broadcast content as an overlay display. In some embodiments, a system may optionally include, but is not limited to, circuitry configured to transmit one or more instructions to display one or more indicators in response to one or events associated with the one or more players selected by the at least one participant. In addition to the foregoing, other system aspects are described in the claims, drawings, and text forming a part of the present disclosure.

In one aspect, a system may include, but is not limited to, a non-transitory signal-bearing medium bearing at least: one or more instructions to receive information associated with at least one participant in a fantasy league, one or more instructions to assign a unique identifier to the at least one participant, one or more instructions to receive information associated with one or more players selected by the at least one participant to form at least one fantasy team that is associated with the at least one participant and linking the unique identifier assigned to the at least one participant to each of the players selected by the at least one participant, one or more instructions to receive information associated with at least one fantasy team attribute selected by the at least one participant and then linking the at least one fantasy team attribute selected by the at least one participant with the unique identifier assigned to the at least one participant, one or more instructions to receive broadcast content in response to a request from the at least one participant, one or more instructions to retrieve non-broadcast information associated with any of the one or more players selected by the at least one participant and then linking the information to the unique identifier assigned to the at least one participant, one or more instructions to transmit one or more instructions to display a descriptor associated with the one or more players selected by the at least one participant, one or more instructions to transmit one or more instructions to display the non-broadcast information associated with the one or more players selected by the at least one players, one or more instructions to transmit one or more instructions to display the fantasy team attribute selected by the at least one participant according to the unique identifier assigned to the at least one participant, and one or more instructions to transmit one or more instructions to display the broadcast content as an overlay display. In some embodiments, a system may optionally include, but is not limited to, one or more instructions to transmit one or more instructions to display one or more indicators in response to one or events associated with the one or more players selected by the at least one participant. In addition to the foregoing, other system aspects are described in the claims, drawings, and text forming a part of the present disclosure.

In one aspect, a system may include, but is not limited to, means for receiving information associated with at least one participant in a fantasy league, means for assigning a unique identifier to the at least one participant, means for receiving information associated with one or more players selected by the at least one participant to form at least one fantasy team that is associated with the at least one participant and linking the unique identifier assigned to the at least one participant to each of the players selected by the at least one participant, means for receiving information associated with at least one fantasy team attribute selected by the at least one participant and then linking the at least one fantasy team attribute selected by the at least one participant with the unique identifier assigned to the at least one participant, means for receiving broadcast content in response to a request from the at least one participant, means for retrieving non-broadcast information associated with any of the one or more players selected by the at least one participant and then linking the information to the unique identifier assigned to the at least one participant, means for transmitting one or more instructions to display a descriptor associated with the one or more players selected by the at least one participant, means for transmitting one or more instructions to display the non-broadcast information associated with the one or more players selected by the at least one participant, means for transmitting one or more instructions to display the fantasy team attribute selected by the at least one participant according to the unique identifier assigned to the at least one participant, and means for transmitting one or more instructions to display the broadcast content as an overlay display. In some embodiments, a system may optionally include, but is not limited to, means for transmitting one or more instructions to display one or more indicators in response to one or events associated with the one or more players selected by the at least one participant. In addition to the foregoing, other system aspects are described in the claims, drawings, and text forming a part of the present disclosure.

In one or more embodiments, means may include, but are not limited to, circuitry and/or programming for effecting the herein referenced functional aspects; the circuitry and/or programming can be numerous combinations of hardware and/or firmware configured to effect the herein referenced functional aspects depending upon the design choices of the system designer. In some embodiments, the hardware and/or firmware may be configured to include software fixed in a tangible non-transient medium to effect the herein referenced functional aspects depending upon the design choices of the system designer. In addition to the foregoing, other system aspects means are described in the claims, drawings, and/or text forming a part of the present disclosure.

In one or more various aspects, related systems include but are not limited to circuitry and/or programming for effecting the herein-referenced method aspects; the circuitry and/or programming can be numerous combinations of hardware and/or firmware configured to effect the herein referenced functional aspects depending upon the design choices of the system designer. In some embodiments, the hardware and/or firmware may be configured to include software fixed in a tangible non-transient medium to effect the herein referenced functional aspects depending upon the design choices of the system designer. In some embodiments, a system may include, but is not limited to, a non-transitory signal-bearing medium bearing at least one or more instructions. The one or more instructions may be, for example, computer executable and/or logic-implemented instructions. In some embodiments, the non-transitory signal-bearing medium may include a computer-readable medium. In some embodiments, the non-transitory signal-bearing medium may include a recordable medium. In some embodiments, the non-transitory signal-bearing medium may include a communications medium. In addition to the foregoing, other system aspects are described in the claims, drawings, and/or text forming a part of the present application.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 illustrates an example system 100 in which embodiments may be implemented.

FIG. 2 illustrates example embodiments of components that may be included within system 100.

FIG. 3 illustrates an operational flow 300 in which embodiments may be implemented.

FIG. 4 illustrates an operational flow 400 in which embodiments may be implemented.

FIG. 5 illustrates an operational flow 500 in which embodiments may be implemented.

FIG. 6 illustrates an operational flow 600 in which embodiments may be implemented.

FIG. 7 illustrates an operational flow 700 in which embodiments may be implemented.

FIG. 8 illustrates an operational flow 800 in which embodiments may be implemented.

FIG. 9 illustrates an embodiment of a display device 900 in which embodiments may be implemented.

FIG. 10 illustrates an embodiment of a display device 1000 in which embodiments may be implemented.

FIG. 11 illustrates an embodiment of a display device 1100 in which embodiments may be implemented.

FIG. 12 illustrates an embodiment of a display device 1200 in which embodiments may be implemented.

FIG. 13 illustrates an embodiment of a display device 1300 in which embodiments may be implemented.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

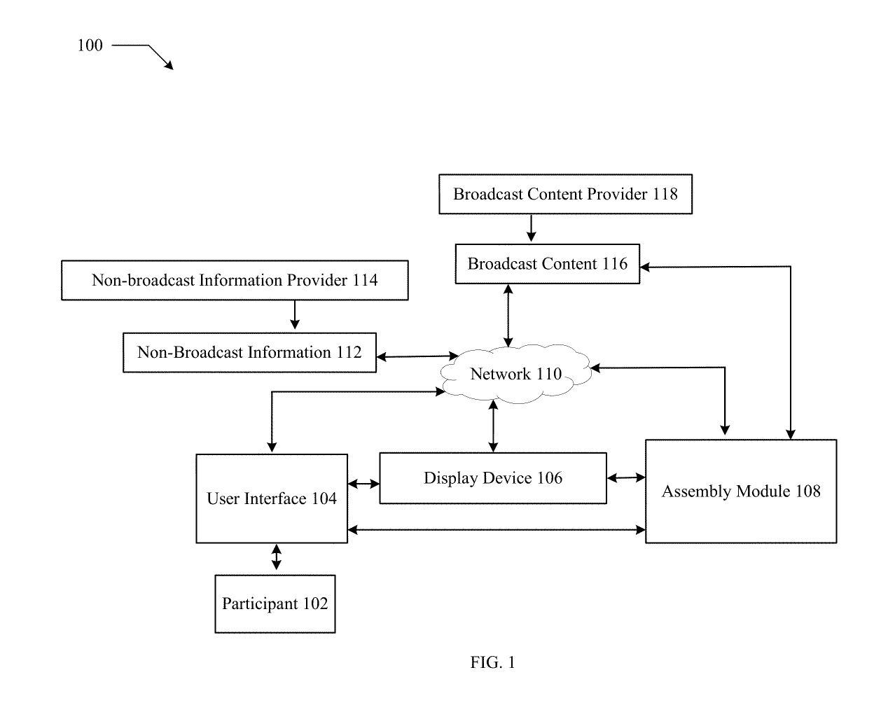

FIG. 1 illustrates an example system 100 in which embodiments may be implemented. System 100 may include one or more user interfaces 104. System 100 may include one or more display devices 106. System 100 may include one or more assembly modules 108. System 100 may include one or more networks 110. System 100 may include broadcast content 116. System 100 may include one or more broadcast content providers 118. System 100 may include non-broadcast information 112. System 100 may include non-broadcast information providers 114. System 100 may include one or more participants 102.

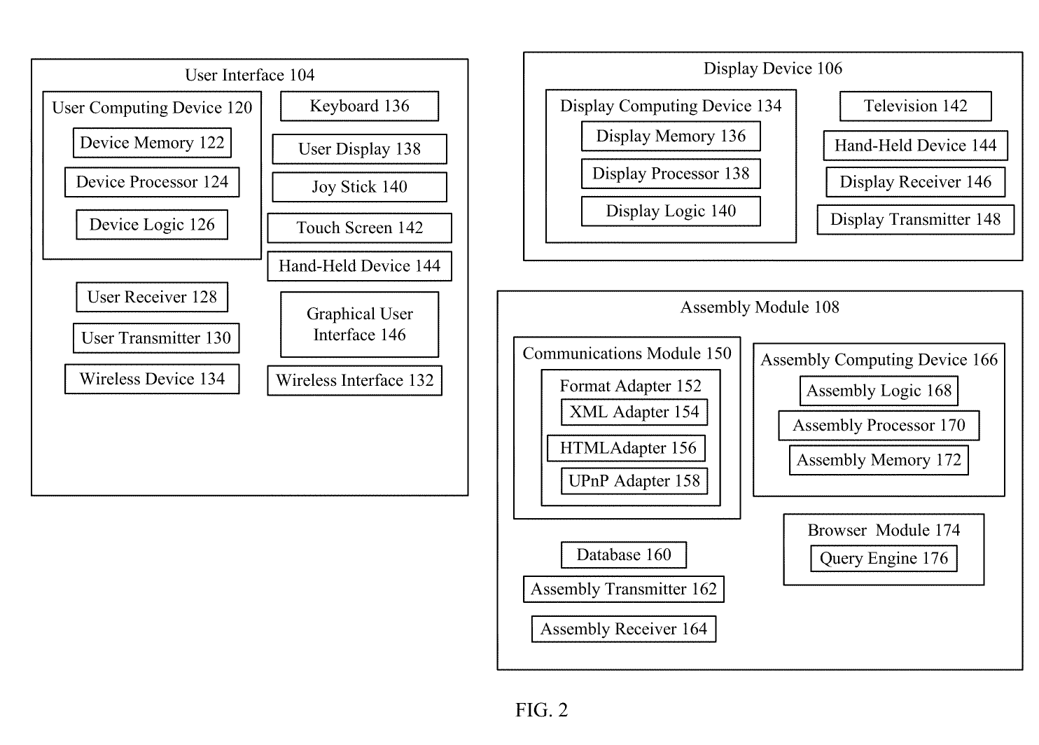

FIG. 2 illustrates example components that may be included within system 100. Various configurations of a user interface 104, a display device 106, and an assembly module 108 are illustrated.

### User Interface

In some embodiments, system 100 may include one or more user interfaces 104. System 100 may include numerous types of user interfaces 104 that may be configured in numerous ways. Examples of such configurations include, but are not limited to, keyboards 136, user displays 138, user transmitters 130, user receivers 128, graphical user interfaces 146, wireless interfaces 132, touch screens 142, joy sticks 140, hand-held devices 144, user computing devices 120 (e.g., device memory 122, device processor 124, device logic 126), wireless devices 134, and the like. In some embodiments, a user interface 104 may include one or more types of interfaces. For example, in some embodiments, a user interface 104 may include a keyboard 136 and a joy stick 140 that are operably coupled to a user computing device 120. In some embodiments, a user interface 104 may include an interactive device that includes a user display 138 that also serves as a touch screen 142. In some embodiments, a user interface 104 may include a wireless device 134 that communicates with the user interface 104.

In some embodiments, a wireless device 134 may be used to communicate with a user interface 104. For example, in some embodiments, a cellular telephone may be used to communicate with a user interface 104. In some embodiments, a personal digital assistant may be used to communicate with a user interface 104. Accordingly, in some embodiments, a user interface 104 may include a wireless interface 132 that allows the user interface 104 to communicate with numerous types of wireless devices 134. For example, in some embodiments, a participant 102 may enter information into a wireless device 134 that transmits the information to a user interface 104 that receives the information.

In some embodiments, a user interface 104 may include one or more user displays 138. A user interface 104 may include, or be operably coupled to, numerous types of user displays 138. Examples of user displays 138 include, but are not limited to, active displays (e.g., active matrix display), passive displays (e.g., passive matrix display, passive liquid crystal display), liquid crystal displays, monitors, interactive displays, and the like.

In some embodiments, a user interface 104 may include one or more user transmitters 130. A user interface 104 may include numerous types of user transmitters 130. User transmitters 130 may be configured in numerous ways to transmit numerous types of signals. Examples of such signals include, but are not limited to, wireless signals, acoustic signals, optical signals, magnetic signals, digital signals, analog signals, encrypted signals, and the like. In some embodiments, a user interface 104 may transmit one or more signals that are received by one or more assembly modules 108. In some embodiments, a user interface 104 may transmit one or more signals that are received by one or more display devices 106. In some embodiments, a user interface 104 may transmit one or more signals through a network 110. In some embodiments, a user interface 104 may transmit one or more signals that are received by one or more broadcast content providers 118. In some embodiments, a user interface 104 may transmit one or more signals that are received by one or more non-broadcast information providers 114.

In some embodiments, a user interface 104 may include one or more user receivers 128. A user interface 104 may include numerous types of user receivers 128. User receivers 128 may be configured in numerous ways to receive numerous types of signals. Examples of such signals include, but are not limited to, wireless signals, acoustic signals, optical signals, magnetic signals, digital signals, analog signals, encrypted signals, and the like. In some embodiments, a user interface 104 may receive one or more signals transmitted by one or more assembly modules 108. In some embodiments, a user interface 104 may receive one or more signals transmitted by one or more display devices 106. In some embodiments, a user interface 104 may receive one or more signals transmitted through a network 110. In some embodiments, a user interface 104 may receive one or more signals transmitted by one or more broadcast content providers 118. In some embodiments, a user interface 104 may receive one or more signals transmitted by one or more non-broadcast information providers 114.

In some embodiments, a user interface 104 may include one or more graphical user interfaces 104. A graphical user interface 104 may be configured in numerous ways. Examples of such graphical user interfaces 104 include, but are not limited to, two-dimensional graphical user interfaces 104, three-dimensional graphical user interfaces 104, graphical keyboards 136, WIMP (windows, icons, menus, pointer) interfaces, touchscreens 142, and the like.

In some embodiments, a user interface 104 may be configured to display a listing of broadcast content 116 from which a participant 102 may select. Numerous types of broadcast content 116 may be selected through use of a user interface 104. Example of such broadcast content 116 include, but are not limited to, radio broadcast content 116, television broadcast content 116, cable television broadcast content 116, direct-broadcast satellite content 116, webcast content, satellite radio content, and the like.

In some embodiments, a user interface 104 may be configured to display a listing of non-broadcast information 112 from which a participant 102 may select. Numerous types of non-broadcast information 112 may be selected through use of a user interface 104. Example of such non-broadcast information 112 include, but are not limited to, internet-based content, subscription-based content, private network content, participant provided content, and the like.

In some embodiments, a user interface 104 may be configured to display a listing of preferences from which a participant 102 (e.g., a participant in a fantasy league and/or other users) may select (e.g., for association with a fantasy league and/or a fantasy team and/or a player in a fantasy league and/or fantasy team). In some embodiments, a user interface 104 may be configured to display a list of attributes from which a participant 102 may select (e.g., for association with in a fantasy league and/or a fantasy team and/or a player in a fantasy team and/or league). Numerous types of attributes may be selected by a participant 102. Examples of such attributes may include, but are not limited to, colors, sounds, logos, patterns, symbols, numbers, shapes, and the like. In some embodiments, a user interface 104 may configured to display a list of players from which a participant 102 may select (e.g., a list of players from which a participant 102 may select for inclusion on a fantasy team and/or a fantasy league). In some embodiments, a user interface 104 may be configured to display a list of activities from which a participant 102 may select (e.g., a list of sporting events). Examples of such activities include, but are not limited to, football, baseball, hockey, auto racing, motorcycle racing, bicycle racing, tennis, badminton, soccer, field hockey, boxing, wrestling, rugby, ice skating, skiing, volleyball, track and field, swimming, martial arts fighting, lacrosse, basketball, and the like.

In some embodiments, a user interface 104 may be configured to display a listing of events associated with an activity from which a participant 102 may select. For example, with regard to a football game, a user interface 104 may display events that include, but are not limited to, a touchdown, a field goal, a touch back, a tackle, an interception, a player injury, a penalty, and the like. With regard to a baseball game, a user interface 104 may display events that include, but are not limited to, an out, a hit, an injury, an ejection, and the like. With regard to a hockey game, a user interface 104 may display events that include, but are not limited to, a goal, an injury, a penalty, a power play, and the like. Accordingly, numerous types of events that are associated with numerous types of activities may be displayed on a user interface 104.

In some embodiments, a user interface 104 may be configured to display a listing of indicators associated with one or more events from which a participant 102 may select. Examples of such indicators include, but are not limited to, symbols, sounds, pictures, colors, words, messages, and the like. For example, in some embodiments, a participant 102 may select a starburst pattern that is to be displayed in response to the occurrence of an event. Accordingly, in some embodiments, a participant 102 may select a starburst pattern that is to be displayed when a player on the participant's fantasy football team makes a touchdown. In some embodiments, the selected indicator may be displayed on a display device 106 as an overlay onto broadcast content 116.

In some embodiments, a user interface 104 may be configured to receive participant associated information. Numerous types of participant associated information may be received by a user interface 104. Examples of such participant associated information include, but are not limited to, a participant name, a participant alias, a participant avatar, and the like. In some embodiments, a user interface 104 may be configured to receive participant financial information. For example, in some embodiments, a user interface 104 may be configured to receive participant credit card information, bank account information, debit card information, Paypal™ information, and the like. In some embodiments, a user interface 104 may be configured to receive participant verification information. For example, in some embodiments, a user interface 104 may be configured to receive password information, biometric information (e.g., fingerprint information, facial recognition information, retinal scan information), location information, credit history, transaction history, wagering information, and the like.

In some embodiments, a user interface 104 may include one or more user computing devices 120. A user computing device 120 may be configured in numerous ways. In some embodiments, a user computing device 120 may include device memory 122. Examples of device memory 122 include, but are not limited to, random access memory (e.g., dynamic, static), read-only memory, flash memory, cache, virtual memory, video memory, and the like. In some embodiments, device memory 122 may be associated with a database. In some embodiments, a user computing device 120 may include one or more device processors 124 that are configured to carry out the instructions of a computer program (e.g., transistor processor, integrated circuit processor). In some embodiments, a user computing device 120 may include device logic 126 which is configured to perform arithmetic and logical operations. For example, in some embodiments, device logic 126 may be configured to assign a unique identifier to a participant 102. Numerous types of unique identifiers may be associated with a participant 102. Examples of such identifiers include, but are not limited to, numeric identifiers (e.g., digits, binary identifiers, alphabetic identifiers, alphanumeric identifiers), graphical identifiers (e.g., symbol, avatar, bar code), location identifiers (e.g., global position coordinates), financial identifiers (e.g., account identifier), and the like. In some embodiments, device logic 126 may be configured to link participant selections and/or preferences to the unique identifier that is assigned to the participant 102. In some embodiments, device logic 126 may be configured to link participant selections and/or preferences to the unique identifier that is assigned to the participant 102 and save the information in a database.

### Assembly Module

In some embodiments, system 100 may include one or more assembly modules 108. Assembly modules 108 may be configured in numerous ways and may include numerous types of components. For example, in some embodiments, an assembly module 108 may include one or more of the following components arranged in numerous configurations: an assembly transmitter 162, an assembly receiver 164, a communications module 150, an assembly computing device 166 that may include, an assembly processor 170, assembly memory 172, assembly logic 168 (e.g., participant verification logic, participant account logic, billing logic, overlay logic, tracking logic, etc.), a browser module 174, a database 160, and the like. In some embodiments, an assembly module 108 may include one or more functionalities described for one or more display devices 106.

In some embodiments, an assembly module 108 may include one or more assembly transmitters 162. An assembly module 108 may include numerous types of assembly transmitters 162. Assembly transmitters 162 may be configured in numerous ways to transmit numerous types of signals. Examples of such signals include, but are not limited to, wireless signals, acoustic signals, optical signals, magnetic signals, digital signals, analog signals, encrypted signals, and the like. In some embodiments, an assembly module 108 may transmit one or more signals that are received by one or more user interfaces 104. In some embodiments, an assembly module 108 may transmit one or more signals that are received by one or more display devices 106. In some embodiments, an assembly module 108 may transmit one or more signals through a network 110. In some embodiments, an assembly module 108 may transmit one or more signals that are received by one or more broadcast content providers 118. In some embodiments, an assembly module 108 may transmit one or more signals that are received by one or more non-broadcast information providers 114. In some embodiments, an assembly module 108 may transmit one or more signals that include one or more instructions associated with display of non-broadcast information 112. In some embodiments, an assembly module 108 may transmit one or more signals that include one or more instructions associated with display of broadcast content 116. In some embodiments, an assembly module 108 may transmit one or more signals that include one or more instructions associated with display of non-broadcast information 112 and broadcast content 116.

In some embodiments, an assembly module 108 may include one or more assembly receivers 164. An assembly module 108 may include numerous types of assembly receivers 164. Assembly receivers 164 may be configured in numerous ways to receive numerous types of signals. Examples of such signals include, but are not limited to, wireless signals, acoustic signals, optical signals, magnetic signals, digital signals, analog signals, encrypted signals, and the like. In some embodiments, an assembly module 108 may receive one or more signals transmitted by one or more user interfaces 104. In some embodiments, an assembly module 108 may receive one or more signals transmitted by one or more display devices 106. In some embodiments, an assembly module 108 may receive one or more signals transmitted through a network 110. In some embodiments, an assembly module 108 may receive one or more signals transmitted by one or more broadcast content providers 118. In some embodiments, an assembly module 108 may receive one or more signals transmitted by one or more non-broadcast information providers 114. In some embodiments, an assembly module 108 may receive one or more signals that include one or more instructions associated with display of non-broadcast information 112. In some embodiments, an assembly module 108 may receive one or more signals that include one or more instructions associated with display of broadcast content 116. In some embodiments, an assembly module 108 may receive one or more signals that include one or more instructions associated with display of non-broadcast information 112 and broadcast content 116.

In some embodiments, an assembly module 108 may include one or more communications modules 150. In some embodiments, a communications module 150 may be configured to convert data from a first format into a second format. In some embodiments, a communications module 150 may be configured to convert data from a first format into a second format that is compatible with other types of data formats. For example, in some embodiments, a communications module 150 may receive data associated with broadcast content that is in a first format and then covert the data into a second format that is compatible with the format in which non-broadcast data is received. Accordingly, in some embodiments, a communications module 150 may include one or more format adapters 152. Examples of such format adapters 152 include, but are not limited to, an extensible markup language (XML) adapter 154, a hypertext markup language (HTML) adapter 156, a universal plug and play (UPnP) adapter 158, and the like (e.g., U.S. Pat. No. 7,458,096: System and method for presenting fantasy sports content with broadcast content; U.S. Patent Application Publication Number 2005/0050576: System and method for integrating broadcast content and non-broadcast content).

In some embodiments, a communications module 150 may be configured to utilize numerous transmission technologies that may include, but are not limited to, code division multiple access (CDMA), global system for mobile communications (GSM), universal mobile telecommunications system (UMTS), time division multiple access (TDMA), frequency division multiple access (FDMA), transmission control protocol/internet protocol (TCP/IP), short messaging service (SMS), multimedia messaging service (MMS), e-mail, instant messaging service (IMS), Bluetooth™, IEEE 802.11, and the like.

In some embodiments, an assembly module 108 may include one or more assembly computing devices 166. Assembly computing devices 166 may be configured in numerous ways. In some embodiments, an assembly computing device 166 may include assembly memory 175. Examples of assembly memory 175 include, but are not limited to, random access memory (e.g., dynamic, static), read-only memory, flash memory, cache, virtual memory, video memory, and the like. In some embodiments, assembly memory 172 may be associated with a database. In some embodiments, an assembly computing device 166 may include one or more assembly processors 170 that are configured to carry out the instructions of a computer program (e.g., transistor processor, integrated circuit processor). Numerous types of assembly processors 170 may be associated with an assembly computing device 166. In some embodiments, an assembly computing device 166 may include assembly logic 168 which is configured to perform arithmetic and logical operations. Assembly logic 168 may be configured in numerous ways. For example, in some embodiments, assembly logic 168 may include overlay logic that is configured to overlay non-broadcast information on broadcast content (e.g., U.S. Pat. No. 7,458,093: System and method for presenting fantasy sports content with broadcast content; U.S. Pat. No. 7,458,096: System and method for presenting fantasy sports content with broadcast content; U.S. Patent Application Publication Number 2005/0050576: System and method for integrating broadcast content and non-broadcast content; U.S. Published Patent Application Number 20080101456: Method for insertion and overlay of media content upon an underlying visual media). In some embodiments, assembly logic 168 may include billing logic. In some embodiments, assembly logic 168 may include participant 102 account logic that is configured to manage a participant's account. In some embodiments, assembly logic 168 may include participant 102 verification logic that is configured to verify a participant's identity and/or credentials. In some embodiments, assembly logic 168 may include tracking logic that is configured to determine the position of a player and/or an object on displayed broadcast content 116.

In some embodiments, assembly logic 168 may be configured to assign a unique identifier to a participant 102. In some embodiments, assembly logic 168 may be configured to assign a unique identifier to a participant 102 and then save the linked information in a database. Numerous types of unique identifiers may be assigned to a participant 102. Examples of such identifiers include, but are not limited to, numeric identifiers (e.g., digits, binary identifiers, alphabetic identifiers, alphanumeric identifiers), graphical identifiers (e.g., symbol, avatar, bar code), location identifiers (e.g., global position coordinates), financial identifiers (e.g., account identifier), and the like.

In some embodiments, assembly logic 168 may be configured to link participant 102 selections and/or preferences to the unique identifier that is assigned to the participant 102. For example, in some embodiments, assembly logic 168 may be configured to link players selected by a participant 102 for inclusion in the participant's fantasy team to the unique identifier assigned to the participant 102. In some embodiments, assembly logic 168 may be configured to link participant selections and/or preferences to the unique identifier that is assigned to the participant 102 and save the information in a database.

In some embodiments, assembly logic 168 may be configured to link one or more participant selected fantasy team attributes to the unique identifier that is assigned to the participant 102. For example, in some embodiments, assembly logic 168 may be configured to link a team logo, a team sound, a team song, a team color, and the like that is selected by a participant 102 for association with the participant's fantasy team to the unique identifier assigned to the participant 102. In some embodiments, assembly logic 168 may be configured to link one or more fantasy team attributes selected by a participant 102 to the unique identifier that is assigned to the participant 102 and save the information in a database.

In some embodiments, assembly logic 168 may be configured to link one or more descriptors associated with one or more players selected by a participant 102 for inclusion on the participant's fantasy team to the unique identifier that is assigned to the participant 102. For example, in some embodiments, assembly logic 168 may be configured to link a player name, a player position, a player number, a player team name, and the like to a player that is selected by a participant 102 for association with the participant's fantasy team to the unique identifier assigned to the participant 102. In some embodiments, assembly logic 168 may be configured to link one or more descriptors associated with one or more players selected by a participant 102 for inclusion on the participant's fantasy team to the unique identifier that is assigned to the participant 102 and save the information in a database.

In some embodiments, assembly logic 168 may include overlay logic that is configured to overlay non-broadcast information 112 on broadcast content 116 (e.g., U.S. Pat. No. 7,458,096: System and method for presenting fantasy sports content with broadcast content; U.S. Patent Application Publication Number 2005/0050576: System and method for integrating broadcast content and non-broadcast content). Numerous types of non-broadcast information 112 may be displayed as an overlay on numerous types of broadcast content 116. Examples of non-broadcast information 112 include, but are not limited to, participant 102 provided content, statistics, display of content in response to one or more events, one or more team attributes, one or more descriptors associated with one or more fantasy teams and/or one or more players on one or more fantasy teams, positional information, and the like. Examples of broadcast content 116 include, but are not limited to, broadcast sports games (e.g., football games, soccer games, basketball games, baseball games, hockey games, rugby matches, auto races, motorcycle races, and the like).

In some embodiments, overlay logic may be configured to overlay content (e.g., non-broadcast information 112) onto broadcast content 116 in a manner that is dependent upon one or more unique identifiers assigned to one or more participants 102. For example, in some embodiments, overlay logic may access one or more databases to retrieve a listing of players that are associated with a unique identifier assigned to a participant 102 in a fantasy league and then display non-broadcast information 112 that is associated with the players associated with the unique identifier. Accordingly, in some embodiments, overlay logic may be configured to display non-broadcast information 112 that is associated with one or more players that are included on a participant's fantasy team as an overlay on broadcast content 116.

In some embodiments, overlay logic may be configured to overlay one or more descriptors associated with one or more players selected by a participant 102 for inclusion on the participant's fantasy team. Numerous types of descriptors may be associated with one or more players selected by a participant 102 for inclusion on the participant's fantasy team. Examples of such descriptors include, but are not limited to, a player name, a player team logo, a player team color, a player team song, a player team sound, a player position on a fantasy team (e.g., wide receiver, quarterback, running back, forward, guard, etc.) and the like. In some embodiments, overlay logic may be configured to display one or more descriptors and one or more statistics associated with one or more players on a participant's fantasy team as an overlay on broadcast content 116.

In some embodiments, overlay logic may be configured to overlay non-broadcast information 112 onto broadcast content 116 for multiple participants 102 in a fantasy league. In some embodiments, overlay logic may be configured to overlay non-broadcast information 112 associated with one or more players that are each selected by one or more participants 102 in a fantasy league for inclusion on their individual fantasy team onto broadcast content 116. For example, in some embodiments, a first player may be selected by a first participant 102 for inclusion on their fantasy team in a fantasy league and a second player may be selected by a second participant 102 for inclusion on their fantasy team in the fantasy league. Accordingly, in some embodiments, overlay logic may be configured to overlay non-broadcast information 112 that is associated with the first player and the second player on broadcast content 116. For example, in some embodiments, statistics associated with a first football player selected for inclusion on a fantasy football team associated with a first participant 102 and a second football player selected for inclusion on a different fantasy football team associated with a second participant 102 may be displayed as an overlay on a broadcast football game. Accordingly, in some embodiments, overlay logic may be configured to display non-broadcast information 112 that is associated with numerous fantasy team players and/or numerous fantasy teams that are selected by numerous different participants 102 in a fantasy league as an overlay on broadcast content 116.

In some embodiments, overlay logic may be configured to overlay content (e.g., non-broadcast information) on broadcast content 116 in a manner that preserves perspective. In some embodiments, overlay logic may be configured to determine the relative size of an image displayed as broadcast content 116 and then display content (e.g., non-broadcast information 112) as an overlay in response to the relative size of the displayed image. For example, in some embodiments, overlay logic may be configured to display a participant 102 selected fantasy team attribute, such as a star symbol, as an overlay on a broadcast image of one or more players selected by the participant 102 for inclusion on the participant's fantasy team. Accordingly, in some embodiments, overlay logic may be configured to determine the relative size of the one or more displayed images of the one or more players and display the star symbol as an overlay associated with the one or more players (e.g., on one or more helmets associated with the one or more players) in the correct size.

In some embodiments, assembly logic may include tracking logic that is configured to determine the position of one or more players and/or one or more objects that are displayed on broadcast content 116 (see e.g., Lei et al., An adaptive search window algorithm for player tracking in broadcast tennis videos, International Journal of Innovative Computing, Information and Control, 8:10(A), October 2012; Zhu et al., Player action recognition in broadcast tennis video with applications to semantic analysis of sports game, Proceedings of the 14^{th} annual ACM international conference on Multimedia, Pages 431-440, ACM, New York, USA, 2006; Choi and Seo, Tracking soccer ball in TV broadcast video, Image Analysis and Processing—ICIAP 2005, Lecture Notes in Computer Science, Vol. 3617, pp. 661-668, 2005; Zhang et al., Robust multi-object tracking via cross-domain contextual information for sports video analysis, In Acoustics, Speech and Signal Processing (ICASSP), 2012 IEEE International Conference on (pp. 985-988). IEEE, March, 2012). For example, in some embodiments, tracking logic may be configured to determine the position of one or more players and/or one or more objects that are displayed on broadcast content 116. For example, in some embodiments, tracking logic may be configured to determine and track the position of a displayed image of a football player as it is displayed on a broadcast football game.

In some embodiments, tracking logic and overlay logic may be configured to function together to overlay non-broadcast information 112 onto broadcast content 116 in a coupled manner. For example, in some embodiments, non-broadcast information 112 may displayed as an overlay on broadcast content 116 in a manner that is coupled to the position of one or more players and/or one or more objects that are displayed on broadcast content 116. In some embodiments, a fantasy team attribute selected by a participant 102 for association with the participant's fantasy team may be displayed as an overlay on broadcast content 116 that includes one or more displayed images of one or more players and/or objects that are associated with the participant's fantasy team. For example, in some embodiments, a participant 102 may select an image of a star as a fantasy football team attribute that is associated with players selected by the participant 102 for inclusion on the participant's fantasy football team. In some embodiments, overlay logic and tracking logic may be configured to function together to track the position of a displayed image of one or more players that are included on the participant's fantasy football team and to overlay the image of a star that was selected by the participant 102 on the one or more displayed images of the one or more players (e.g., star overlay on a displayed image of a players helmet).

In some embodiments, tracking logic may be configured to utilize digital analysis (e.g., optical character recognition, pixel analysis) to overlay information on broadcast content 116 (see e.g., U.S. Pat. No. 8,102,405: TV Screen Text Capture; U.S. Pat. No. 8,683,031: Methods and systems for scanning and monitoring content on a network; U.S. Pat. No. 8,682,077: Method for omnidirectional processing of 2D images including recognizable characters; U.S. Pat. No. 7,689,613: OCR input to search engine; U.S. Pat. No. 7,506,356: Skimming continuous multimedia content; U.S. Published Patent Application Number 20100192178: Capture of stylized TV table data via OCR; U.S. Published Patent Application Number 20080226119: Content image search; Borse and Rangdale, Online and offline extraction of text from television program, International Journal of Advanced Research in Computer Science and Software Engineering, Vol. 4(1), January 2014). For example, in some embodiments, tracking logic may be configured to utilize digital analysis to determine the position of a displayed image of a football player that was selected by a participant 102 for inclusion on the participant's fantasy football team. The positional information may then be used to overlay a participant 102 selected fantasy team logo on the displayed image of the football player (e.g., broadcast football game) that was selected by the participant 102. In another example, in some embodiments, tracking logic may be configured to utilize optical character recognition to determine the position of a displayed image of a football player that was selected by a participant 102 for inclusion on the participant's fantasy team based on the player's number (e.g., number on the player's jersey and/or helmet). The positional information may then be used to overlay a participant selected fantasy team logo on the displayed image of the football player (e.g., broadcast football game) that was selected by the participant 102. In another example, in some embodiments, tracking logic may be configured to utilize pixel analysis (e.g., facial recognition, pattern recognition) to identify a player that was selected by a participant 102 for inclusion on the participant's fantasy team and then determine the position of a displayed image of the player (see e.g., Lei et al., An adaptive search window algorithm for player tracking in broadcast tennis videos, International Journal of Innovative Computing, Information and Control, 8:10(A), October 2012; Zhu et al., Player action recognition in broadcast tennis video with applications to semantic analysis of sports game, Proceedings of the 14^{th} annual ACM international conference on Multimedia, Pages 431-440, ACM, New York, USA, 2006; Choi and Seo, Tracking soccer ball in TV broadcast video, Image Analysis and Processing—ICIAP 2005, Lecture Notes in Computer Science, Vol. 3617, pp. 661-668, 2005; Zhang et al., Robust multi-object tracking via cross-domain contextual information for sports video analysis, In Acoustics, Speech and Signal Processing (ICASSP), 2012 IEEE International Conference on (pp. 985-988). IEEE, March, 2012).

In some embodiments, tracking logic may be configured to obtain positional information through use of one or more sensor networks. In some embodiments, a player or object that is associated with an activity may be associated with a tag (e.g., radio frequency identification tag, magnetic tag, transmitter, etc.) that allows the identity and/or position of the player or object to be determined. For example, in some embodiments, a player on a football team may be associated with an identification tag that allows the identity and position of the player to be determined. In some embodiments, a race car may be associated with an identification tag that allows the position of the race car to be determined. In some embodiments, a hockey puck may be associated with a tag that allows the position of the hockey puck to be determined. In some embodiments, a soccer ball may be associated with a tag that allows the position of the soccer ball to be determined. Accordingly, in some embodiments, the position of a player and/or object may be determined and/or tracked. In some embodiments, the positional information obtained from a sensor network may be used in combination with overlay logic to display content on an image of a player and/or object displayed as broadcast content 116. For example, in some embodiments, a participant selected fantasy football team attribute may be displayed as an overlay on a displayed image of a football player that is included on the participant's fantasy football team. In some embodiments, positional information may include one or more characteristics associated with position and/or movement. For example, in some embodiments, positional information may include the velocity at which a player and/or object is moving. In some embodiments, positional information may include acceleration and/or deceleration associated with a player and/or object.

In some embodiments, tracking logic and overlay logic may be configured to function together to overlay content (e.g., non-broadcast information) onto broadcast content 116 through the use of a coordinate system (e.g., Cartesian coordinates, spherical coordinates, polar coordinates, cylindrical coordinates). For example, in some embodiments, a coordinate grid may be applied to broadcast content 116 to assign a set of coordinates to each position on the displayed broadcast content 116. In some embodiments, a coordinate set may be assigned to the position of a displayed image included within broadcast content 116 such that non-broadcast information 112 may be displayed as an overlay on the broadcast content 116 in accordance with the overlapping grid coordinates. For example, in some embodiments, tracking logic may be configured to determine a coordinate set for a displayed image of a football player during a broadcast football game and then overlay logic may overlay one or more fantasy team attributes on the displayed image of the football player in accordance with the coordinate set of the displayed image.

In some embodiments, assembly logic 168 may be configured to direct the display of one or more indicators in response to the occurrence of one or more events that are associated with an activity (e.g., a football game, a hockey game, a soccer game, a tennis match, an auto race, a motorcycle race, a baseball game, basketball game, and the like). Assembly logic 168 may be configured to direct the display of one or more indicators in response to the occurrence of numerous types of events. Examples of such events include, but are not limited to, a touchdown, a field goal, a touch back, a tackle, an interception, a player injury, a penalty, an out, a hit, an ejection, a goal, a power play, an accident, and the like. Accordingly, assembly logic 168 may direct the display of one or more indicators in response to numerous types of events that are associated with numerous types of activities. Numerous types of indicators may be displayed in response to numerous types of events. Examples of such indicators include, but are not limited to, symbols, sounds, pictures, colors, words, messages, and the like. For example, in some embodiments, assembly logic 168 may direct a display device 106 to display a starburst pattern in response to the occurrence of an event. For example, in some embodiments, a starburst pattern may be displayed when a player on the participant's fantasy football team makes a touchdown. In some embodiments, assembly logic 168 may direct a display device 106 to display a selected indicator as an overlay onto broadcast content 116.

In some embodiments, assembly logic 168 may include billing logic. Billing logic may be configured in numerous ways. For example, in some embodiments, billing logic may be configured to determine services used by a participant 102 and calculate a fee based on participant 102 usage. In some embodiments, such services may be billing according to an amount of time used by a participant 102 (e.g., time spent watching broadcast content). In some embodiments, such services may be billing according to one or more specific services provided to a participant 102 (e.g., maintaining a participant 102 account for a period of time). In some embodiments, billing logic may be configured to mail an invoice to a participant 102 provided address. In some embodiments, billing logic may be configured to send an electronic mail message containing an invoice to a participant 102 provided email address. In some embodiments, billing logic may be configured to receive payment from a participant 102. For example, in some embodiments, billing logic may be configured to receive payment from a credit card account associated with a participant 102. In some embodiments, billing logic may be configured to receive payment from a debit card account associated with a participant 102. In some embodiments, billing logic may be configured to receive payment from a bank account associated with a participant 102.

In some embodiments, assembly logic 168 may include participant 102 account logic that is configured to manage a participant's account. For example, in some embodiments, account logic may be configured to access a participant's account (e.g., credit card account, bank account, Paypal™ account, debit card account, and the like) and debit the account based on services provided to a participant 102. In some embodiments, account logic may be configured to access a participant's account (e.g., credit card account, bank account, Paypal™ account, debit card account, and the like) and credit the account.

In some embodiments, assembly logic 168 may include verification logic. Verification logic may be configured in numerous ways. In some embodiments, verification logic may be used to verify a participant's identity. For example, in some embodiments, verification logic may be used to verify a participant's identity through use of a password, biometric methods (e.g., fingerprint analysis, retinal scan, voice recognition, facial recognition, etc.), location information, and the like.

In some embodiments, an assembly module 108 may include one or more browser modules 174. Browser modules 174 may be configured in numerous ways. For example, in some embodiments, a browser module 174 may be configured to search a network (e.g., the internet). Accordingly, in some embodiments, a browser module 174 may include one or more query engines 176 (e.g., U.S. Pat. No. 8,612,420: Configuring web crawler to extract web page information; U.S. Published Patent Application Number 20120259833: Configurable web crawler; U.S. Published Patent Application Number 20120259828: Network search engine using objective and subjective user favorites for searching; U.S. Published Patent Application Number 20050144158: Computer network search engine; U.S. Pat. No. 8,452,855: System and method for presentation of media related to a context). In some embodiments, a browser module 174 may be configured to retrieve information through use of a public web browser (e.g., Google, Netscape Navigator™, Safari™, Explorer™, etc.). In some embodiments, a browser module 174 may be configured to retrieve information associated with a fantasy league from a database and then search a network 110 for information related to the information retrieved from the database. For example, in some embodiments, a browser module 174 may retrieve information associated with one or more players selected by a participant 102 for inclusion on the participant's fantasy team from a database. The browser module 174 may then query one or more networks 110 for information associated with the one or more players, receive the information, and then transmit the information to one or more assembly modules 108 and/or display devices 106. In some embodiments, a browser module 174 may retrieve one or more unique identifiers associated with a fantasy league and/or fantasy team and then search one or more networks to retrieve information associated with the one or more unique identifiers and then link the retrieved information to the associated unique identifier. In some embodiments, such linked information may be saved in a database.

### Display Device

In some embodiments, system 100 may include one or more display devices 106. A display device 106 may include numerous types of components and combinations of components. Examples of such components include, but are not limited to, a display computing device 134, a display transmitter 148, a display receiver 146, a hand-held device 144, a television 142, and the like. In some embodiments, a display device 106 may be configured to receive information that includes broadcast content 116 which includes an overlay of non-broadcast information 112. In some embodiments, a display device 106 may receive information that includes broadcast content 116 and non-broadcast information 112 and be configured to overlay the non-broadcast information 112 on the broadcast content 116. In some embodiments, a display device 106 may include one or more functionalities described for one or more assembly modules 108.

Display devices 106 may be configured in numerous ways. Examples of such configurations include, but are not limited to, televisions 142, monitors, projectors, hand-held devices 144, active displays, passive displays, and the like.

In some embodiments, a display device 106 may include one or more display receivers 146. Accordingly, in some embodiments, a display device 106 may receive one or more signals. Numerous types of signals may be received. Examples of such signals include, but are not limited to, wireless signals, acoustic signals, optical signals, magnetic signals, digital signals, analog signals, encrypted signals, and the like. In some embodiments, a display device 106 may receive one or more signals transmitted by one or more assembly modules 108. In some embodiments, a display device 106 may receive one or more signals transmitted by one or more user interfaces 104. In some embodiments, a display device 106 may receive one or more signals transmitted through a network 110. In some embodiments, a display device 106 may receive one or more signals transmitted by one or more broadcast content providers 118. In some embodiments, a display device 106 may receive one or more signals transmitted by one or more non-broadcast information providers 114.

In some embodiments, a display device 106 may include one or more display transmitters 148. Accordingly, in some embodiments, a display device 106 may transmit one or more signals. Numerous types of signals may be transmitted. Examples of such signals include, but are not limited to, wireless signals, acoustic signals, optical signals, magnetic signals, digital signals, analog signals, encrypted signals, and the like. In some embodiments, a display device 106 may transmit one or more signals that are received by one or more assembly modules 108. In some embodiments, a display device 106 may transmit one or more signals that are received by one or more user interfaces 104. In some embodiments, a display device 106 may transmit one or more signals through a network 110. In some embodiments, a display device 106 may transmit one or more signals that are received by one or more broadcast content providers 118. In some embodiments, a display device 106 may transmit one or more signals that are received by one or more non-broadcast information providers 114.

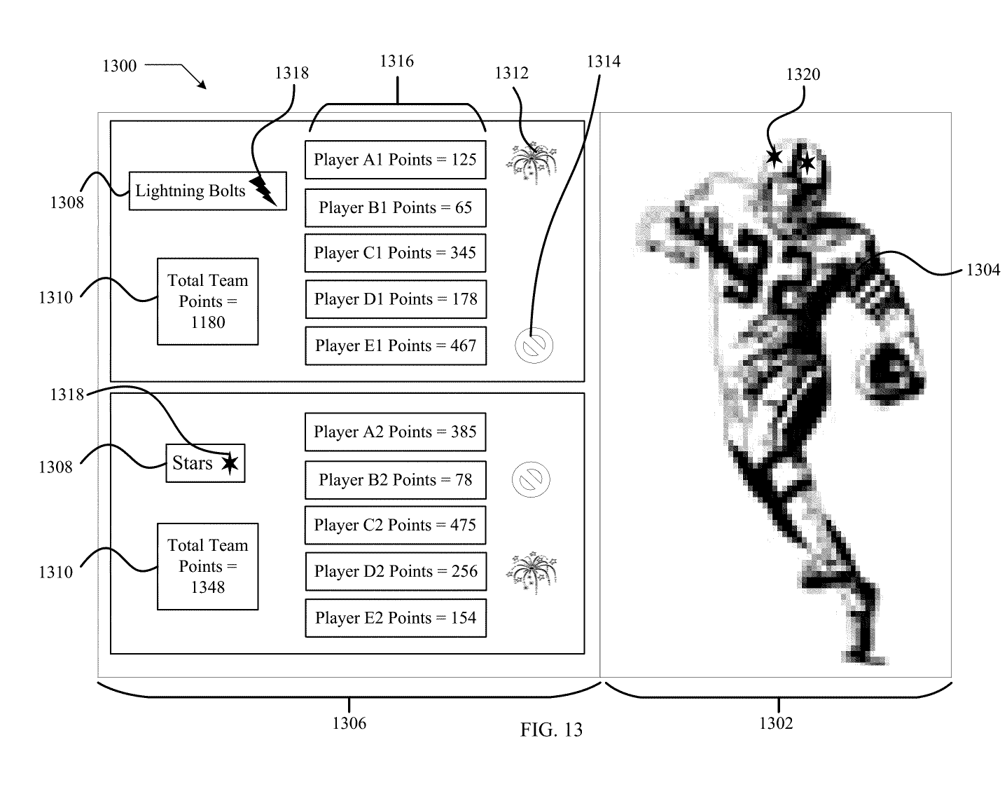

In some embodiments, a display device 106 may include one or more display computing devices 134. Accordingly, in some embodiments, a display device 106 may include a display processor 138, display memory 136, display logic 140, and the like. Display computing devices 134 may be configured in numerous ways. For example, in some embodiments, a display computing device 134 may be configured to receive one or more signals that include instructions to display content. In some embodiments, a display device 106 may display broadcast content 116. In some embodiments, a display device 106 may display non-broadcast information 112. In some embodiments, a display device 106 may display broadcast content 116 and non-broadcast information 112. In some embodiments, a display device 106 may display non-broadcast information 112 as an overlay on broadcast content 116 (e.g., U.S. Pat. No. 7,458,096: System and method for presenting fantasy sports content with broadcast content; U.S. Patent Application Publication Number 2005/0050576: System and method for integrating broadcast content and non-broadcast content). In some embodiments, a display device 106 may display a participant 102 (e.g., participant 102 in a fantasy league) selected attribute (e.g., non-broadcast information) as an overlay on broadcast content 116. For example, in some embodiments, a display device 106 may display a participant selected fantasy team logo (e.g., star) as an overlay on a displayed image of a player (e.g., on the player's helmet) selected by the participant 102 for inclusion on the participant's fantasy team (see e.g., FIG. 13).

In some embodiments, a display device 106 may include a display processor 138 that is configured to process positional information to overlay content on broadcast content 116. For example, in some embodiments, a display device 106 may process positional information associated with a football player that was selected by a participant 102 for inclusion on the participant's fantasy football team. The positional information may then be used to overlay a participant selected fantasy team logo on the displayed image of the football player (e.g., broadcast football game) that was selected by the participant 102. In some embodiments, a display device 106 may include a display processor 138 that is configured to utilize digital analysis (e.g., optical character recognition, pixel analysis) to overlay content (e.g., information) on broadcast content 116 (see e.g., U.S. Pat. No. 8,102,405: TV Screen Text Capture; U.S. Pat. No. 8,683,031: Methods and systems for scanning and monitoring content on a network; U.S. Pat. No. 8,682,077: Method for omnidirectional processing of 2D images including recognizable characters; U.S. Pat. No. 7,689,613: OCR input to search engine; U.S. Pat. No. 7,506,356: Skimming continuous multimedia content; U.S. Published Patent Application Number 20100192178: Capture of stylized TV table data via OCR; U.S. Published Patent Application Number 20080226119: Content image search; Borse and Rangdale, Online and offline extraction of text from television program, International Journal of Advanced Research in Computer Science and Software Engineering, Vol. 4(1), January 2014). For example, in some embodiments, a display device 106 may utilize digital analysis to determine the position of a displayed image of a football player that was selected by a participant 102 for inclusion on the participant's fantasy football team. The positional information may then be used to overlay a participant selected fantasy team logo on the displayed image of the football player (e.g., broadcast football game) that was selected by the participant 102. In another example, in some embodiments, a display device 106 may utilize optical character recognition to determine the position of a displayed image of a football player that was selected by a participant 102 for inclusion on the participant's fantasy team based on the player's number (e.g., number on the player's jersey and/or helmet). The positional information may then be used to overlay a participant selected fantasy team logo on the displayed image of the football player (e.g., broadcast football game) that was selected by the participant 102. In another example, in some embodiments, a display device 106 may utilize pixel analysis (e.g., facial recognition, pattern recognition) to identify a player that was selected by a participant 102 for inclusion on the participant's fantasy team and then determine the position of a displayed image of the player (see e.g., Lei et al., an Adaptive Search Window Algorithm for Player Tracking in Broadcast Tennis videos, International Journal of Innovative Computing, Information and Control, 8:10(A), October 2012; Zhu et al., Player action recognition in broadcast tennis video with applications to semantic analysis of sports game, Proceedings of the 14^{th} annual ACM international conference on Multimedia, Pages 431-440, ACM, New York, USA, 2006; Choi and Seo, Tracking soccer ball in TV broadcast video, Image Analysis and Processing—ICIAP 2005, Lecture Notes in Computer Science, Vol. 3617, pp. 661-668, 2005; Zhang et al., Robust multi-object tracking via cross-domain contextual information for sports video analysis, In Acoustics, Speech and Signal Processing (ICASSP), 2012 IEEE International Conference on (pp. 985-988). IEEE, March, 2012).

In some embodiments, positional information may be obtained through use of sensor networks. In some embodiments, a player or object that is associated with an activity may be associated with an identification tag (e.g., radio frequency identification tag) that allows the position of the player or object to be determined. For example, in some embodiments, a player on a football team may be associated with an identification tag that allows the position of the player to be determined. In some embodiments, a race car may be associated with an identification tag that allows the position of the race car to be determined. In some embodiments, a hockey puck may be associated with an identification tag that allows the position of the hockey puck to be determined. In some embodiments, a soccer ball may be associated with an identification tag that allows the position of the soccer ball to be determined. Accordingly, in some embodiments, the position of a player and/or object may be determined and/or tracked.

In some embodiments, the positional information may be used to overlay a participant 102 selected fantasy team logo on the displayed image of the player (e.g., broadcast soccer game) that was selected by the participant 102. In some embodiments, a display device 106 may use one or more methods to determine the position of a player on displayed broadcast content 116.

In some embodiments, a display device 106 may display non-broadcast information 112 as an overlay on displayed broadcast content 116. For example, in some embodiments, a display device 106 may display statistics (e.g., retrieved non-broadcast information 112) associated with one or more football players on a participant's fantasy football team as an overlay on a broadcast of a football game (e.g., broadcast content 116).

In some embodiments, a display device 106 may be configured to display one or more indicators in response to the occurrence of one or more events that are associated with an activity (e.g., a football game, a hockey game, a soccer game, a tennis match, an auto race, a motorcycle race, a baseball game, basketball game, and the like). A display device 106 may display one or more indicators in response to the occurrence of numerous types of events. Examples of such events include, but are not limited to, a touchdown, a field goal, a touch back, a tackle, an interception, a player injury, a penalty, an out, a hit, an ejection, a goal, a power play, an accident, and the like. Accordingly, a display device 106 may display one or more indicators in response to numerous types of events that are associated with numerous types of activities. Numerous types of indicators may be displayed in response to numerous types of events. Examples of such indicators include, but are not limited to, symbols, sounds, pictures, colors, words, messages, and the like. For example, in some embodiments, a display device 106 may display a starburst pattern in response to the occurrence of an event. For example, in some embodiments, a starburst pattern may be displayed when a player on the participant's fantasy football team makes a touchdown. In some embodiments, the selected indicator may be displayed on a display device as an overlay onto broadcast content 116.

### Participant

In some embodiments, system 100 may include one or more participants 102. In some embodiments, a participant 102 may be a participant 102 in a fantasy league. In some embodiments, a participant 102 may include multiple participants 102 in a fantasy league. In some embodiments, a participant 102 may be a user who is not a member in a fantasy league.

### Non-Broadcast Information

In some embodiments, system 100 may include non-broadcast information 112. Numerous types of non-broadcast information 112 may be included within system 100. In some embodiments, non-broadcast information 112 may include participant provided content. For example, in some embodiments, a participant 102 may input a team logo, a team color, a team song, a sound, and the like that is associated with the participant's fantasy team and/or a player on a participant's fantasy team. In some embodiments, a participant 102 may input an indicator that will be displayed in response to an event associated with the participant's fantasy team and/or a player on a participant's fantasy team. In some embodiments, a participant 102 may input an indicator that will be displayed in response to a use selected event. For example, in some embodiments, a participant 102 may input a picture (e.g., a starburst) that will be displayed in response to a use selected event (e.g., a touchdown associated with the participant's fantasy team and/or a touchdown made by a player on the participant's fantasy football team). In some embodiments, non-broadcast information 112 may include information received through searching a network 110. For example, in some embodiments, non-broadcast information 112 may include statistics associated with a participant's fantasy team and/or a player associated with a participant's fantasy team received through searching the internet.

### Non-Broadcast Information Provider

In some embodiments, system 100 may include one or more non-broadcast information providers 114. Numerous types of non-broadcast information providers 114 may be included within system 100. Examples of non-broadcast information providers 114 include, but are not limited to, internet service providers, non-broadcast multiple access networks, and the like.

### Broadcast Content

In some embodiments, system 100 may include broadcast content 116. Numerous types of broadcast content 116 may be included within system 100. Examples of broadcast content 116 include, but are not limited to, cable television transmissions, wireless television transmissions, radio transmissions, and the like.

### Broadcast Content Provider

In some embodiments, system 100 may include one or more broadcast content providers 118. Numerous types of broadcast content providers 118 may be included within system 100. Examples of broadcast content providers 118 include, but are not limited to, cable television providers, television networks, radio stations, and the like.

### Network

In some embodiments, system 100 may include one or more networks 110. Numerous types of networks 110 may be included within system 100. Examples of networks 110 include, but are not limited to, telecommunications networks 110, cable networks 110, wireless networks 110, wired networks 110, the internet, television networks 110, radio networks 110, local area networks 110, and the like.

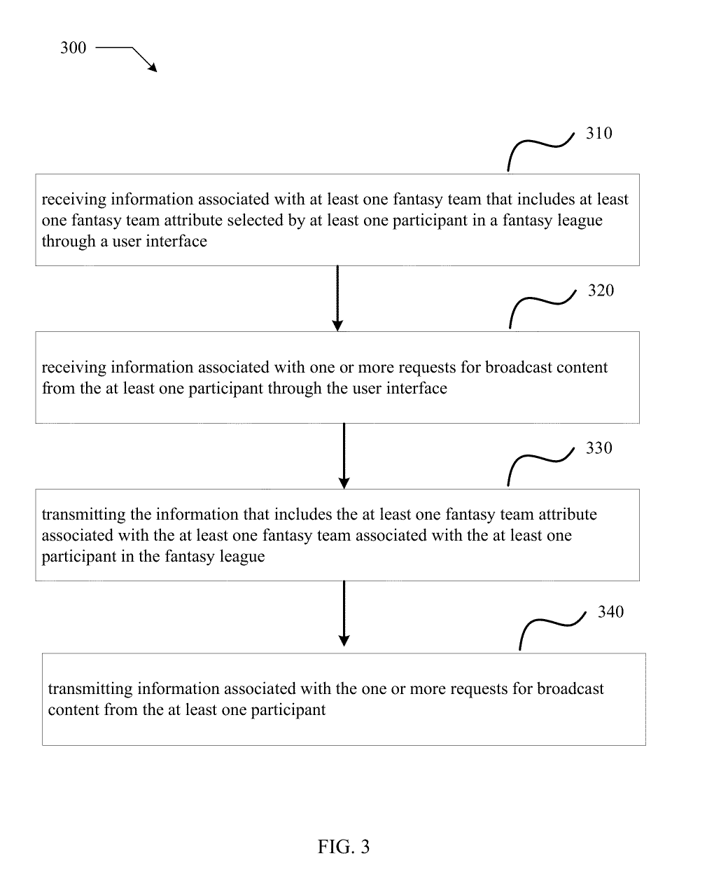

FIG. 3 illustrates an operational flow 300 representing examples of operations that are related to the performance of a method for receiving and transmitting information. In FIG. 3 and in following description that includes various examples of operations used during performance of the method, discussion and explanation may be provided with respect to the above-described example of FIG. 3, and/or with respect to other examples and contexts. However, it should be understood that the operations may be executed in a number of other environments and contexts, and/or modified versions of FIG. 3. Also, although the various operations are presented in the sequence(s) illustrated, it should be understood that the various operations may be performed in other orders than those which are illustrated, or may be performed concurrently. In some embodiments, the operations that are illustrated in FIG. 3 may be carried out in the context of system 100 as illustrated in FIG. 1.

Operation 310 includes receiving information associated with at least one fantasy team that includes at least one fantasy team attribute selected by at least one participant 102 in a fantasy league through a user interface 104. In some embodiments, one or more user interfaces 104 may receive information associated with at least one fantasy team that includes at least one fantasy team attribute selected by at least one participant 102 in a fantasy league. In some embodiments, a user interface 104 may receive one or more signals that include the information associated with at least one fantasy team that includes at least one fantasy team attribute selected by at least one participant 102 in a fantasy league. Numerous types of information may be received by a user interface 104. In some embodiments, a user interface 104 may receive information associated with one or more participants 102 associated with a fantasy league. Examples of such information include, but are not limited to, a participant's name, an identifier associated with a participant 102, payment information associated with the participant 102, financial information associated with the participant 102, a location associated with the participant 102, verification information associated with a participant 102, payment information associated with a participant 102, account information associated with a participant 102, and the like. In some embodiments, a user interface 104 may receive information associated with a fantasy league. Examples of such information include, but are not limited to, a type of activity associated with the fantasy league (e.g., football, baseball, basketball, hockey, lacrosse, soccer, etc.), the identity of one or more participants 102 in the fantasy league, information associated with one or more players that are selected by one or more participants 102 in the fantasy league for inclusion on each of their fantasy teams (e.g., names of players, position of player on a fantasy team, etc.), and the like. In some embodiments, a user interface 104 may receive information associated with one or more fantasy team attributes. Numerous types of fantasy team attributes may be received. Examples of such fantasy team attributes include, but are not limited to, a fantasy team logo, a fantasy team sound, a fantasy team color, a fantasy team song, a fantasy team symbol, a fantasy team, and the like. In some embodiments, a user interface 104 may receive information associated with one or more unique identifiers associated with a participant 102 in a fantasy league. Information associated with numerous types of identifiers may be received. Examples of such identifiers include, but are not limited to, numeric identifiers (e.g., digits, binary identifiers, alphabetic identifiers, alphanumeric identifiers), graphical identifiers (e.g., symbol, avatar, bar code), location identifiers (e.g., global position coordinates), financial identifiers (e.g., account identifier), and the like. In some embodiments, such unique identifiers may be associated with a participant's fantasy team. For example, in some embodiments, a unique identifier associated with a participant 102 in a fantasy league may be linked to players selected by that participant 102 for inclusion in their fantasy team. In some embodiments, a unique identifier associated with a participant 102 in a fantasy league may be linked to other types of information that may include, but is not limited to, account information, financial information, verification information, and the like. In some embodiments, such information may be stored in a database. For example, in some embodiments, a database may be constructed where a unique identifier that is associated with a participant 102 in a fantasy league is linked to information associated with the participant 102 (e.g., account information, financial information, verification information, location information, etc.) and to information associated with the participant's fantasy team (e.g., identity of players selected by the participant, positions of the players selected by the participant 102, etc.), and the like. Accordingly, in some embodiments, the unique identifier may be used to access information associated with a particular participant 102 and information associated with participant's fantasy team.

Operation 320 includes receiving information associated with one or more requests for broadcast content 116 from the at least one participant 102 through the user interface 104. In some embodiments, one or more user interfaces 104 may receive information associated with one or more requests for broadcast content 116 from at least one participant 102. In some embodiments, a user interface 104 may receive one or more signals that include the information associated with one or more requests for broadcast content 116 from at least one participant 102. Numerous types of information associated with broadcast content 116 may be received from a participant 102. In some embodiments, a participant 102 may request broadcast content 116 that is associated with one or more players on the participant's fantasy team. In some embodiments, a participant 102 may request broadcast content 116 that is associated with the unique identifier associated with the participant 102. For example, in some embodiments, broadcast content 116 may be retrieved that is associated with a player that is linked to the unique identifier.

Operation 330 includes transmitting the information that includes the at least one fantasy team attribute associated with the at least one fantasy team associated with the at least one participant 102 in the fantasy league. In some embodiments, one or more user interfaces 104 may transmit information associated with at least one fantasy team attribute associated with at least one fantasy team associated with at least one participant 102 in a fantasy league. In some embodiments, one or more user interfaces 104 may transmit one or more signals that include information associated with at least one fantasy team attribute associated with at least one fantasy team associated with at least one participant 102 in a fantasy league. Numerous types of information may be transmitted by a user interface 104. In some embodiments, a user interface 104 may transmit information associated with one or more participants 102 associated with a fantasy league. Examples of such information include, but are not limited to, a participant's name, an identifier associated with a participant 102, payment information associated with the participant 102, financial information associated with the participant 102, a location associated with the participant 102, verification information associated with a participant 102, payment information associated with a participant 102, account information associated with a participant 102, and the like. In some embodiments, a user interface 104 may transmit information associated with a fantasy league. Examples of such information include, but are not limited to, a type of activity associated with the fantasy league (e.g., football, baseball, basketball, hockey, lacrosse, soccer, etc.), the identity of one or more participants 102 in the fantasy league, information associated with one or more players that are selected by one or more participants 102 in the fantasy league for inclusion on each of their fantasy teams (e.g., names of players, position of player on a fantasy team, etc.), and the like. In some embodiments, a user interface 104 may transmit information associated with one or more fantasy team attributes. Numerous types of fantasy team attributes may be transmitted. Examples of such fantasy team attributes include, but are not limited to, a fantasy team logo, a fantasy team sound, a fantasy team color, a fantasy team song, a fantasy team symbol, a fantasy team, and the like. In some embodiments, a user interface 104 may transmit information associated with one or more unique identifiers associated with a participant 102 in a fantasy league. Information associated with numerous types of identifiers may be transmitted. Examples of such identifiers include, but are not limited to, numeric identifiers (e.g., digits, binary identifiers, alphabetic identifiers, alphanumeric identifiers), graphical identifiers (e.g., symbol, avatar, bar code), location identifiers (e.g., global position coordinates), financial identifiers (e.g., account identifier), and the like. In some embodiments, such unique identifiers may be associated with a participant's fantasy team. For example, in some embodiments, a unique identifier associated with a participant 102 in a fantasy league may be linked to players selected by that participant 102 for inclusion in their fantasy team. In some embodiments, a unique identifier associated with a participant 102 in a fantasy league may be linked to other types of information that may include, but is not limited to, account information, financial information, verification information, and the like. In some embodiments, such information may be stored in a database. For example, in some embodiments, a database may be constructed where a unique identifier that is associated with a participant 102 in a fantasy league is linked to information associated with the participant 102 (e.g., account information, financial information, verification information, location information, etc.) and to information associated with the participant's fantasy team (e.g., identity of players selected by the participant, positions of the players selected by the participant, etc.), and the like. Accordingly, in some embodiments, the unique identifier may be used to access information associated with a particular participant 102 and information associated with participant's fantasy team.

Operation 340 includes transmitting information associated with the one or more requests for broadcast content 116 from the at least one participant 102. In some embodiments, one or more user interfaces 104 may transmit information associated with one or more requests for broadcast content 116 from at least one participant 102. In some embodiments, a user interface 104 may transmit one or more signals that include the information associated with one or more requests for broadcast content 116 from at least one participant 102. Numerous types of information associated with broadcast content 116 may be transmitted. In some embodiments, a request for broadcast content 116 that is associated with one or more players on a participant's fantasy team may be transmitted. In some embodiments, a request for broadcast content 116 that is associated with a unique identifier associated with a participant 102 may be transmitted. For example, in some embodiments, a request for broadcast content 116 that is associated with one or more players that are linked to a unique identifier associated with a participant 102 may be transmitted.

In some embodiments, operation 310 includes receiving one or more signals that include the information associated with the at least one fantasy team that includes the at least one fantasy team attribute selected by the at least one participant 102 in the fantasy league. In some embodiments, a user interface 104 may receive one or more signals that include information associated with at least one fantasy team that includes at least one fantasy team attribute selected by at least one participant 102 in the fantasy league. Numerous types of signals may be received. Examples of such signals include, but are not limited to, wireless signals, acoustic signals, optical signals, magnetic signals, digital signals, analog signals, encrypted signals, and the like.

In some embodiments, operation 310 includes receiving at least one representation associated with the at least one participant 102. In some embodiments, a user interface 104 may receive at least one representation associated with at least one participant 102. Numerous types of representations may be received. Examples of such representations include, but are not limited to, an avatar, a numeric representation, a symbolic representation, a name, and the like.

In some embodiments, operation 310 includes receiving verification information associated with the at least one participant 102. In some embodiments, a user interface 104 may receive verification information associated with at least one participant 102. Numerous types of verification information may be received. Examples of such verification information include, but are not limited to, a password, biometric information (e.g., a fingerprint, a retinal scan, facial recognition information, etc.), an encryption key, and the like.

In some embodiments, operation 310 includes receiving payment information associated with the at least one participant 102. In some embodiments, a user interface 104 may receive payment information associated with at least one participant 102. Numerous types of payment information may be received. Examples of such payment information include, but are not limited to, a scanned image of a check, a receipt, a debit record, and the like.

In some embodiments, operation 310 includes receiving account information associated with the at least one participant 102. In some embodiments, a user interface 104 may receive account information associated with at least one participant 102. Numerous types of account information may be received. Examples of such account information include, but are not limited to, information associated with a credit card account, information associated with a checking account, information associated with a debit card account, information associated with a Paypal™ account, information associated with a prepaid card account, and the like.

In some embodiments, operation 310 includes receiving fantasy league information associated with the at least one participant 102. In some embodiments, a user interface 104 may receive fantasy league information associated with at least one participant 102. Numerous types of fantasy league information may be received. Examples of such fantasy league information include, but are not limited to, one or more names associated with a fantasy league, identities of participants 102 in the fantasy league, unique identifiers associated with participants 102 in a fantasy league, symbols associated with a fantasy league, team logos associated with a fantasy league, fantasy teams associated with a fantasy league, information associated with players selected for inclusion in fantasy teams associated with a fantasy league, and the like.

In some embodiments, operation 310 includes receiving information associated with one or more players selected by the at least one participant 102 to form the at least one fantasy team that is associated with the at least one participant 102. In some embodiments, a user interface 104 may receive information associated with one or more players selected by at least one participant 102 to form at least one fantasy team that is associated with at least one participant 102. Numerous types of information associated with one or more players may be received. Examples of such information include, but are not limited to, a name of a player, a position of a player (e.g., running back, quarterback, wide receiver, tackle, kicker, pitcher, forward, guard, etc.), an activity associated with a player (e.g., football, baseball, hockey, lacrosse, soccer, etc.), a unique identifier associated with a player, statistics associated with a player, and the like.

In some embodiments, operation 310 includes receiving information associated with a name associated with each of one or more players selected by the at least one participant 102 to form the at least one fantasy team. In some embodiments, a user interface 104 may receive information associated with a name associated with each of one or more players selected by at least one participant 102 to form at least one fantasy team. Examples of such information include, but are not limited to, a real name associated with a player, a nickname associated with a player, a participant 102 assigned name associated with a player, and the like.

In some embodiments, operation 310 includes receiving information associated with a position on the fantasy team occupied by each of one or more players selected by the at least one participant 102. In some embodiments, a user interface 104 may receive information associated with a position on a fantasy team occupied by each of one or more players selected by at least one participant 102. Examples of such positions occupied by a player include, but are not limited to, a running back, a quarterback, a wide receiver, a tackle, a kicker, a pitcher, a forward, a guard, and the like.

In some embodiments, operation 310 includes saving the information associated with the at least one fantasy team in a database. In some embodiments, a user interface 104 may save information associated with at least one fantasy team in a database. Information may be saved in numerous types of databases. In some embodiments, information may be saved in a database that is linked to a unique identifier that is associated with a particular participant 102 in a fantasy league. For example, in some embodiments, participant 102 information may be linked to unique identifier assigned to the participant 102. In some embodiments, information associated with a participant's fantasy team may be linked to unique identifier assigned to the participant 102. Examples of such information include, but are not limited to, a name of a player, a position occupied by a player on a fantasy team, a participant 102 selected attribute associated with a fantasy team, and the like. In some embodiments, a database may be associated with a database management system. Examples of such database management systems include, but are not limited to, MySQL, PostgreSQL, Microsoft SQL Server, SQLite, SAP HANA, dBASE, FoxPro, IBM DB2, MariaDB, LibreOffice Base, FileMaker Pro, and the like.

In some embodiments, operation 310 includes receiving information associated with at least one participant 102 selected name associated with the at least one fantasy team. In some embodiments, a user interface 104 may receive information associated with at least one participant 102 selected name associated with at least one fantasy team. For example, in some embodiments, a participant 102 may select a name that is associated with the participant's fantasy team. Examples of such names include, but are not limited to, stars, lions, tigers, jets, jaguars, cougars, and the like. In some embodiments, such names may be linked to a unique identifier associated with the participant 102 that selected the fantasy team name.

In some embodiments, operation 310 includes receiving information associated with at least one participant 102 selected sound associated with the at least one fantasy team. In some embodiments, a user interface 104 may receive information associated with at least one participant 102 selected sound associated with at least one fantasy team. Numerous sounds may be provided and/or selected by a participant 102. In some embodiments, such sounds may include, but are not limited to, a lion's roar, a jet engine sound, a cheering crowd, a fight song, and the like.

In some embodiments, operation 310 includes receiving information associated with at least one participant 102 selected color associated with the at least one fantasy team. In some embodiments, a user interface 104 may receive information associated with at least one participant 102 selected color associated with at least one fantasy team. Numerous colors and combinations of colors may be selected by a participant 102. Examples of such colors and color combinations include, but are not limited to, blue, green, yellow, red, blue and green, yellow and red, orange and black, and the like.

In some embodiments, operation 310 includes receiving information associated with at least one participant selected symbol associated with the at least one fantasy team. In some embodiments, a user interface 104 may receive information associated with at least one participant selected symbol associated with at least one fantasy team. Numerous types of symbols may be selected and/or provided by a participant 102. Examples of such symbols include, but are not limited to, a lion, a tiger, a leopard, a bear, a star, a lightning bolt, and the like.

In some embodiments, operation 320 includes receiving one or more signals that include the information associated with the one or more requests for the broadcast content 116 from the at least one participant 102. In some embodiments, a user interface 104 may receive one or more signals that include information associated with one or more requests for broadcast content 116 from at least one participant 102. In some embodiments, signals may be received that include numerous types of information associated with one or more requests for broadcast content 116. In some embodiments, a request may include a request for a broadcast sporting event. Examples of broadcast sporting events include, but are not limited to, a broadcast football game, a broadcast baseball game, a broadcast hockey game, a broadcast soccer game, a broadcast rugby game, a broadcast tennis match, and the like. In some embodiments, a request for broadcast content 116 may be from a listing of broadcast media. For example, in some embodiments, a participant 102 may make a request for broadcast content 116 from a television listing. In some embodiments, a participant 102 may request broadcast content 116 that will be presented at a future time. For example, in some embodiments, a participant 102 may select a football game that will be broadcast at a future time.

In some embodiments, operation 320 includes receiving one or more requests for broadcast content 116 that is associated with at least one of the one or more players that were selected by the at least one participant 102. In some embodiments, a user interface 104 may receive one or more requests for broadcast content 116 that is associated with at least one of the one or more players that were selected by at least one participant 102 for inclusion on their fantasy team. For example, in some embodiments, a participant 102 may request broadcast content 116 associated with a team that includes a player that was selected by the participant 102 for inclusion on the participant's fantasy team.

In some embodiments, operation 330 includes transmitting one or more signals that include the information that includes the at least one fantasy team attribute associated with the at least one fantasy team associated with the at least one participant 102 in the fantasy league. In some embodiments, a user interface 104 may transmit one or more signals that include information that includes at least one fantasy team attribute associated with at least one fantasy team associated with at least one participant 102 in a fantasy league. Numerous types of signals may be transmitted. Examples of such signals include, but are not limited to, wireless signals, acoustic signals, optical signals, magnetic signals, digital signals, analog signals, encrypted signals, and the like.

In some embodiments, operation 330 includes transmitting the information that includes at least one representation associated with the at least one participant 102. In some embodiments, a user interface 104 may transmit information that includes at least one representation associated with at least one participant 102. Numerous types of representations may be transmitted. Examples of such representations include, but are not limited to, an avatar, a numeric representation, a symbolic representation, a name, and the like.

In some embodiments, operation 330 includes transmitting verification information associated with the at least one participant 102. In some embodiments, a user interface 104 may transmit verification information associated with at least one participant 102. Numerous types of verification information may be transmitted. Examples of such verification information include, but are not limited to, a password, biometric information (e.g., a fingerprint, a retinal scan, facial recognition information, etc.), an encryption key, and the like.

In some embodiments, operation 330 includes transmitting payment information associated with the at least one participant 102. In some embodiments, a user interface 104 may transmit payment information associated with at least one participant 102. Numerous types of payment information may be transmitted. Examples of such payment information include, but are not limited to, a scanned image of a check, a receipt, a debit record, and the like.

In some embodiments, operation 330 includes transmitting account information associated with the at least one participant 102. In some embodiments, a user interface 104 may transmit account information associated with at least one participant 102. Numerous types of account information may be transmitted. Examples of such account information include, but are not limited to, information associated with a credit card account, information associated with a checking account, information associated with a debit card account, information associated with a Paypal™ account, information associated with a prepaid card account, and the like.

In some embodiments, operation 330 includes transmitting fantasy league information associated with the at least one participant 102. In some embodiments, a user interface 104 may transmit fantasy league information associated with at least one participant 102. Numerous types of fantasy league information may be transmitted. Examples of such fantasy league information include, but are not limited to, one or more names associated with a fantasy league, identities of participants 102 in the fantasy league, unique identifiers associated with participants 102 in a fantasy league, symbols associated with a fantasy league, team logos associated with a fantasy league, fantasy teams associated with a fantasy league, information associated with players selected for inclusion in fantasy teams associated with a fantasy league, and the like.

In some embodiments, operation 330 includes transmitting information associated with one or more players selected by the at least one participant 102 to form the at least one fantasy team that is associated with the at least one participant 102. In some embodiments, a user interface 104 may transmit information associated with one or more players selected by at least one participant 102 to form at least one fantasy team that is associated with at least one participant 102. Numerous types of information associated with one or more players may be transmitted. Examples of such information include, but are not limited to, a name of a player, a position of a player (e.g., running back, quarterback, wide receiver, tackle, kicker, pitcher, forward, guard, etc.), an activity associated with a player (e.g., football, baseball, hockey, lacrosse, soccer, etc.), a unique identifier associated with a player, statistics associated with a player, and the like.

In some embodiments, operation 330 includes transmitting information associated with a name associated with each of one or more players selected by the at least one participant 102 to form the at least one fantasy team. In some embodiments, a user interface 104 may transmit information associated with a name associated with each of one or more players selected by at least one participant 102 to form at least one fantasy team. Examples of such information include, but are not limited to, a real name associated with a player, a nickname associated with a player, a participant 102 assigned name associated with a player, and the like.

In some embodiments, operation 330 includes transmitting information associated with a position on the fantasy team occupied by each of one or more players selected by the at least one participant 102 to form the at least one fantasy team. In some embodiments, a user interface 104 may transmit information associated with a position on a fantasy team occupied by each of one or more players selected by at least one participant 102 to form at least one fantasy team. Examples of such positions occupied by a player include, but are not limited to, a running back, a quarterback, a wide receiver, a tackle, a kicker, a pitcher, a forward, a guard, and the like.

In some embodiments, operation 330 includes transmitting information associated with at least one participant 102 selected name associated with the at least one fantasy team. In some embodiments, a user interface 104 may transmit information associated with at least one participant 102 selected name associated with at least one fantasy team. For example, in some embodiments, a participant 102 may select a name that is associated with the participant's fantasy team. Examples of such names include, but are not limited to, stars, lions, tigers, jets, jaguars, cougars, and the like. In some embodiments, such names may be linked to a unique identifier associated with the participant 102 that selected the fantasy team name.

In some embodiments, operation 330 includes transmitting information associated with at least one participant 102 selected sound associated with the at least one fantasy team. In some embodiments, a user interface 104 may transmit information associated with at least one participant 102 selected sound associated with at least one fantasy team. Numerous sounds may be provided and/or selected by a participant 102. In some embodiments, such sounds may include, but are not limited to, a lion's roar, a jet engine sound, a cheering crowd, a fight song, and the like.

In some embodiments, operation 330 includes transmitting information associated with at least one participant 102 selected color associated with the at least one fantasy team. In some embodiments, a user interface 104 may transmit information associated with at least one participant 102 selected color associated with at least one fantasy team. Numerous colors and combinations of colors may be selected by a participant 102. Examples of such colors and color combinations include, but are not limited to, blue, green, yellow, red, blue and green, yellow and red, orange and black, and the like.

In some embodiments, operation 330 includes transmitting information associated with at least one participant selected symbol associated with the at least one fantasy team. In some embodiments, a user interface 104 may transmit information associated with at least one participant selected symbol associated with at least one fantasy team. Numerous types of symbols may be selected and/or provided by a participant 102. Examples of such symbols include, but are not limited to, a lion, a tiger, a leopard, a bear, a star, a lightning bolt, and the like.

In some embodiments, operation 340 includes transmitting one or more signals that include the information associated with the one or more requests for broadcast content 116 from the at least one participant 102. In some embodiments, a user interface 104 may transmit one or more signals that include information associated with one or more requests for broadcast content 116 from at least one participant 102. In some embodiments, signals may be transmitted that include numerous types of information associated with one or more requests for broadcast content 116. In some embodiments, a request may include a request for a broadcast sporting event. Examples of broadcast sporting events include, but are not limited to, a broadcast football game, a broadcast baseball game, a broadcast hockey game, a broadcast soccer game, a broadcast rugby game, a broadcast tennis match, and the like. In some embodiments, a request for broadcast content 116 may be from a listing of broadcast media. For example, in some embodiments, a participant 102 may make a request for broadcast content 116 from a television listing. In some embodiments, a participant 102 may request broadcast content 116 that will be presented at a future time. For example, in some embodiments, a participant 102 may select a football game that will be broadcast at a future time.

In some embodiments, operation 340 includes transmitting one or more requests for broadcast content 116 that is associated with at least one of the one or more players that were selected by the at least one participant 102. In some embodiments, a user interface 104 may transmit one or more requests for broadcast content 116 that is associated with at least one of one or more players that were selected by at least one participant 102. For example, in some embodiments, a participant 102 may request broadcast content 116 associated with a team that includes a player that was selected by the participant 102 for inclusion on the participant's fantasy team.

In some embodiments, operation 340 includes transmitting one or more requests to display at least one fantasy team attribute selected by the at least one participant 102 mapped onto at least one displayed image of at least one player selected by the at least one participant 102. In some embodiments, a user interface 104 may transmit one or more requests to display at least one fantasy team attribute selected by at least one participant 102 mapped onto at least one displayed image of at least one player selected by at least one participant 102. For example, in some embodiments, a participant 102 may request that a fantasy team logo (e.g., star) be displayed as an overlay on broadcast content 116 and mapped onto a displayed image of a helmet worn by a player selected by the participant 102 for inclusion on their fantasy team. In some embodiments, a participant 102 may request that a fantasy team color (e.g., green) be displayed as an overlay on broadcast content 116 and mapped onto a displayed image of a helmet worn by a player selected by the participant 102 for inclusion on their fantasy team. Accordingly, a user interface 104 may transmit requests to display numerous types of fantasy team attributes that are to be mapped onto a displayed image of a player selected by the participant 102.

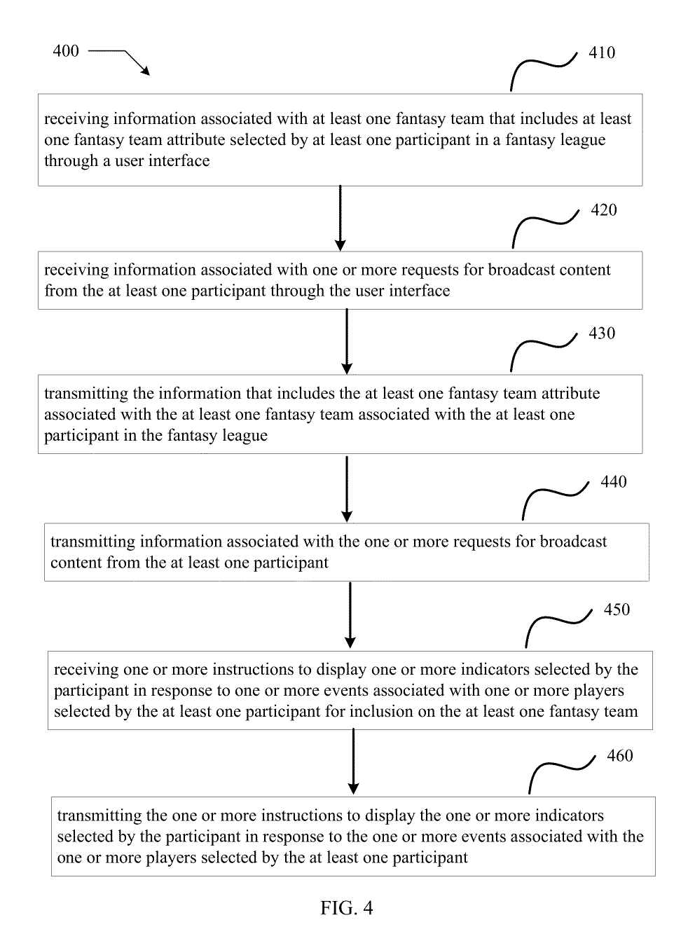

FIG. 4 illustrates an operational flow 400 representing examples of operations that are related to the performance of a method for receiving and transmitting information. In FIG. 4 and in following description that includes various examples of operations used during performance of the method, discussion and explanation may be provided with respect to the above-described example of FIG. 4, and/or with respect to other examples and contexts. However, it should be understood that the operations may be executed in a number of other environments and contexts, and/or modified versions of FIG. 4. Also, although the various operations are presented in the sequence(s) illustrated, it should be understood that the various operations may be performed in other orders than those which are illustrated, or may be performed concurrently. In some embodiments, the operations that are illustrated in FIG. 4 may be carried out in the context of system 100 as illustrated in FIG. 1. In some embodiments, operations 410, 420, 430, and 440, as illustrated in FIG. 4, correspond to operations 310, 320, 330, and 340 as illustrated and described with respect to FIG. 3.

Operation 450 includes receiving one or more instructions to display one or more indicators selected by the participant 102 in response to one or more events associated with one or more players selected by the at least one participant 102 for inclusion on the at least one fantasy team. In some embodiments, a user interface 104 may receive one or more instructions to display one or more indicators selected by a participant 102 in response to one or more events associated with one or more players selected by the participant 102 for inclusion on the participant's fantasy team. In some embodiments, indicators may be provided by a participant 102. For example, in some embodiments, a participant 102 may provide a digital image for use as an indicator. Accordingly, numerous indicators may be selected and/or provided by a participant 102. In some embodiments, an indicator may be a visual indicator. Examples of such visual indicators include, but are not limited to, colors, pictures (e.g., starburst picture), symbols (e.g., Greek symbol, no symbol, yes symbol, check mark symbol, denied symbol, etc.), logos, cartoons (e.g., cartoon thumbs up, cartoon thumbs down), and the like. In some embodiments, an indicator may be an audio indicator. Examples of such audio indicators include, but are not limited to, songs (e.g., team fight song, theme song), cheers, jeers, crying, jet engine sounds, crashing sounds, fireworks, and the like. Indicators may be displayed in response to numerous types of events. Examples of such events include, but are not limited to, a touchdown, a field goal, a goal, a penalty, a catch, a completed pass, a tackle, and the like. In some embodiments, a specific indicator may be displayed in response to a specific event. For example, in some embodiments, a cheering sound may be displayed when a player on a participant's fantasy football team makes a touchdown. In some embodiments, a star burst picture may be displayed when a player on a participant's fantasy football team makes a touchdown. In some embodiments, a booing sound may be displayed when a participant's fantasy football team receives a penalty. Accordingly, numerous types of indicators may be displayed in response to numerous types of events.

Operation 460 includes transmitting the one or more instructions to display the one or more indicators selected by the participant 102 in response to the one or more events associated with the one or more players selected by the at least one participant 102. In some embodiments, a user interface 104 may transmit one or more instructions to display one or more indicators selected by a participant 102 in response to one or more events associated with one or more players selected by the participant 102 for inclusion on the participant's fantasy team. Instructions to display numerous types of indicators may be transmitted. In some embodiments, an indicator may be a visual indicator. Examples of such visual indicators include, but are not limited to, colors, pictures (e.g., starburst picture), symbols (e.g., Greek symbol, no symbol, yes symbol, check mark symbol, denied symbol, etc.), logos, cartoons (e.g., cartoon thumbs up, cartoon thumbs down), and the like. In some embodiments, an indicator may be an audio indicator. Examples of such audio indicators include, but are not limited to, songs (e.g., team fight song, theme song), cheers, jeers, crying, jet engine sounds, crashing sounds, fireworks, and the like. Instructions to display one or more indicators in response to numerous types of events may be transmitted. Examples of such events include, but are not limited to, a touchdown, a field goal, a goal, a penalty, a catch, a completed pass, a tackle, and the like. In some embodiments, instructions to display a specific indicator in response to a specific event may be transmitted. For example, in some embodiments, a cheering sound may be displayed when a player on a participant's fantasy football team makes a touchdown. In some embodiments, a star burst picture may be displayed when a player on a participant's fantasy football team makes a touchdown. In some embodiments, a booing sound may be displayed when a participant's fantasy football team receives a penalty. Accordingly, instructions to display numerous types of indicators in response to numerous types of events may be transmitted.

In some embodiments, operation 450 includes receiving one or more signals that include the one or more instructions to display the one or more indicators selected by the participant 102 in response to the one or more events associated with the one or more players selected by the at least one participant 102 for inclusion on the at least one fantasy team. In some embodiments, a user interface 104 may receive one or more signals that include one or more instructions to display one or more indicators selected by a participant 102 in response to one or more events associated with one or more players selected by a participant 102 for inclusion on the participant's fantasy team. Numerous types of signals may be received. Examples of such signals include, but are not limited to, wireless signals, acoustic signals, optical signals, magnetic signals, digital signals, analog signals, encrypted signals, and the like.

In some embodiments, operation 450 includes receiving one or more instructions to display the one or more indicators in response to one or more events associated with a positive event. In some embodiments, a user interface 104 may receive one or more instructions to display one or more indicators in response to one or more events associated with a positive event. An indicator may be displayed in response to numerous types of positive events. Examples of positive events include, but are not limited to, a touchdown made by a participant's fantasy team, a touchdown made by a player on a participant's fantasy team, a goal made by a participant's fantasy team, a goal made by a player on a participant's fantasy team, a tackle made by a participant's fantasy team, a tackle made by a player on a participant's fantasy team, and the like.

In some embodiments, operation 450 includes receiving one or more instructions to display the one or more indicators in response to one or more events selected from at least one of a touchdown, a field goal, a safety, a goal, a tackle, a checkered flag, a win, or a hole-in-one. In some embodiments, a user interface 104 may receive one or more instructions to display one or more indicators in response to one or more events selected from at least one of a touchdown, a field goal, a safety, a goal, a tackle, a checkered flag, a win, or a hole-in-one.

In some embodiments, operation 450 includes receiving one or more instructions to display the one or more indicators in response to one or more events associated with a negative event. In some embodiments, a user interface 104 may receive one or more instructions to display one or more indicators in response to one or more events associated with a negative event. An indicator may be displayed in response to numerous types of negative events. Examples of negative events include, but are not limited to, a player on a participant's fantasy team being tackled, a participant's fantasy team being given a penalty, a participant's fantasy racing team being involved in a crash, and the like.

In some embodiments, operation 450 includes receiving one or more instructions to display the one or more indicators in response to one or more events selected from at least one of a penalty, a fumble, a tackle, an interception, a crash, a goal, or a loss. In some embodiments, a user interface 104 may receive one or more instructions to display one or more indicators in response to one or more events selected from at least one of a penalty, a fumble, a tackle, an interception, a crash, a goal, or a loss.

In some embodiments, operation 460 includes transmitting one or more signals that include the one or more instructions to display the one or more indicators selected by the participant 102 in response to the one or more events associated with the one or more players selected by the at least one participant 102. In some embodiments, a user interface 104 may transmit one or more signals that include one or more instructions to display one or more indicators selected by a participant 102 in response to one or more events associated with one or more players selected by the participant 102. Numerous types of signals may be transmitted. Examples of such signals include, but are not limited to, wireless signals, acoustic signals, optical signals, magnetic signals, digital signals, analog signals, encrypted signals, and the like.

In some embodiments, operation 460 includes transmitting one or more instructions to display the one or more indicators in response to one or more events associated with a positive event. In some embodiments, a user interface 104 may transmit one or more instructions to display one or more indicators in response to one or more events associated with a positive event. Instructions may be transmitted to display an indicator in response to numerous types of positive events. Examples of positive events include, but are not limited to, a touchdown made by a participant's fantasy team, a touchdown made by a player on a participant's fantasy team, a goal made by a participant's fantasy team, a goal made by a player on a participant's fantasy team, a tackle made by a participant's fantasy team, a tackle made by a player on a participant's fantasy team, and the like.

In some embodiments, operation 460 includes transmitting one or more instructions to display the one or more indicators in response to one or more events selected from at least one of a touchdown, a field goal, a safety, a goal, a tackle, a checkered flag, a win, or a hole-in-one. In some embodiments, a user interface 104 may transmit one or more instructions to display one or more indicators in response to one or more events selected from at least one of a touchdown, a field goal, a safety, a goal, a tackle, a checkered flag, a win, or a hole-in-one.

In some embodiments, operation 460 includes transmitting one or more instructions to display the one or more indicators in response to one or more events associated with a negative event. In some embodiments, a user interface 104 may transmit one or more instructions to display one or more indicators in response to one or more events associated with a negative event. Instructions may be transmitted to display an indicator in response to numerous types of negative events. Examples of negative events include, but are not limited to, a player on a participant's fantasy team being tackled, a participant's fantasy team being given a penalty, a participant's fantasy racing team being involved in a crash, and the like.

In some embodiments, operation 460 includes transmitting one or more instructions to display the one or more indicators in response to one or more events selected from at least one of a penalty, a fumble, a tackle, an interception, a crash, a goal, or a loss. In some embodiments, a user interface 104 may transmit one or more instructions to display one or more indicators in response to one or more events selected from at least one of a penalty, a fumble, a tackle, an interception, a crash, a goal, or a loss.

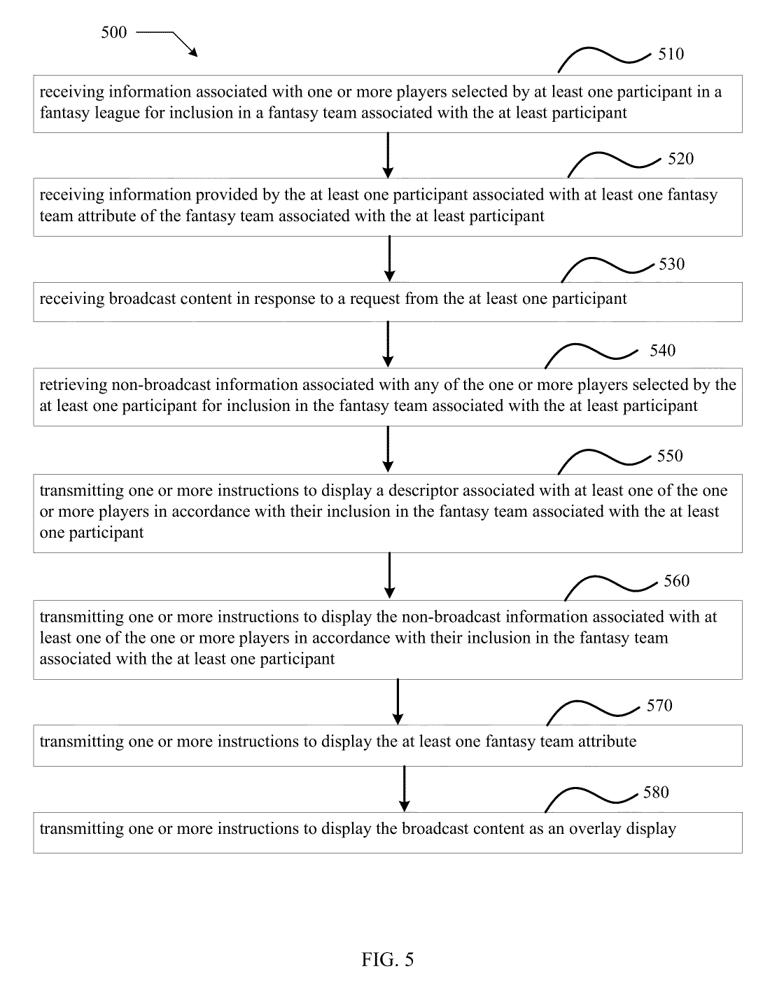

FIG. 5 illustrates an operational flow 500 representing examples of operations that are related to the performance of a method for receiving and transmitting information. In FIG. 5 and in following description that includes various examples of operations used during performance of the method, discussion and explanation may be provided with respect to the above-described example of FIG. 5, and/or with respect to other examples and contexts. However, it should be understood that the operations may be executed in a number of other environments and contexts, and/or modified versions of FIG. 5. Also, although the various operations are presented in the sequence(s) illustrated, it should be understood that the various operations may be performed in other orders than those which are illustrated, or may be performed concurrently. In some embodiments, the operations that are illustrated in FIG. 5 may be carried out in the context of system 100 as illustrated in FIG. 1.

Operation 510 includes receiving information associated with one or more players selected by at least one participant 102 in a fantasy league for inclusion in a fantasy team associated with the at least participant 102. In some embodiments, an assembly module 108 receives information associated with one or more players selected by at least one participant 102 in a fantasy league for inclusion in a fantasy team associated with the at least participant 102. Numerous types of information associated with one or more players may be received. Examples of such information include, but are not limited to, a name of a player, a position of a player (e.g., running back, quarterback, wide receiver, tackle, kicker, pitcher, forward, guard, etc.), an activity associated with a player (e.g., football, baseball, hockey, lacrosse, soccer, etc.), a unique identifier associated with a player, statistics associated with a player, and the like.

Operation 520 includes receiving information provided by the at least one participant 102 associated with at least one fantasy team attribute of the fantasy team associated with the at least participant 102. In some embodiments, an assembly module 108 receives information provided by the at least one participant 102 associated with at least one fantasy team attribute of the fantasy team associated with the at least participant 102. Numerous types of fantasy team attributes may be received. Examples of such fantasy team attributes include, but are not limited to, a fantasy team logo, a fantasy team sound, a fantasy team color, a fantasy team song, a fantasy team symbol, a fantasy team, and the like.

Operation 530 includes receiving broadcast content 116 in response to a request from the at least one participant 102. In some embodiments, an assembly module 108 receives broadcast content 116 in response to a request from the at least one participant 102. In some embodiments, a participant 102 may request broadcast content 116 directly. For example, in some embodiments, a participant 102 may request broadcast content 116 from a listing (e.g., television listing). In some embodiments, a participant 102 may request broadcast content 116 through identifying the broadcast content 116 according to a name and/or title assigned to the broadcast content 116. In some embodiments, a participant 102 may request broadcast content 116 indirectly. For example, in some embodiments, a participant 102 may request broadcast content 116 by requesting broadcast content 116 associated with a player included on the participant's fantasy team. Accordingly, in some embodiments, an assembly module 108 may be configured to search for broadcast content 116 that is related to a player on a participant's fantasy team. For example, in some embodiments, an assembly module 108 may be configured to search a broadcast listing for broadcast content 116 using the name of a player that is included in a participant's fantasy team and then retrieve the broadcast content 116. Numerous types of broadcast content 116 may be requested and received. Examples of such broadcast content 116 include, but are not limited to, television broadcasts, network based broadcasts (e.g., internet broadcast content 116), and the like. Broadcast content 116 may be related to numerous activities (e.g., broadcast sporting events). Examples of such activities include, but are not limited to, football games, baseball games, rugby matches, hockey games, soccer games, and the like.

Operation 540 includes retrieving non-broadcast information 114 associated with any of the one or more players selected by the at least one participant 102 for inclusion in the fantasy team associated with the at least participant 102. In some embodiments, an assembly module 108 receives non-broadcast information 114 associated with any of the one or more players selected by the at least one participant 102 for inclusion in the fantasy team associated with the at least participant 102. In some embodiments, an assembly module 108 may include a browser module that is configured to query and retrieve non-broadcast information 114. In some embodiments, an assembly module 108 may access one or more databases and retrieve information associated with one or more players that were selected by a participant 102 for inclusion on the participant's fantasy team. The assembly module 108 may than use the retrieved information to query non-broadcast information 114 for information associated with the one or more players and then retrieve the information. Numerous types of non-broadcast information 114 may be retrieved. Examples of such non-broadcast information 114 include, but are not limited to, statistics associated with one or more players, statistics associated with one or more teams on which the one or more players are members, events associated with one or more players, events associated with one or more teams on which the one or more players are members, positional information associated with one or more players, and the like.

Operation 550 includes transmitting one or more instructions to display a descriptor associated with at least one of the one or more players in accordance with their inclusion in the fantasy team associated with the at least one participant 102. In some embodiments, an assembly module 108 transmits one or more instructions to display a descriptor associated with at least one of the one or more players in accordance with their inclusion in the fantasy team associated with the at least one participant 102. Instructions associated with numerous types of descriptors may be transmitted. Examples of such descriptors include, but are not limited to, a player name, a player team logo, a player team color, a player team song, a player team sound, a player position on a fantasy team (e.g., wide receiver, quarterback, running back, forward, guard, etc.) and the like.

Operation 560 includes transmitting one or more instructions to display the non-broadcast information 114 associated with at least one of the one or more players in accordance with their inclusion in the fantasy team associated with the at least one participant 102. In some embodiments, an assembly module 108 transmits one or more instructions to display the non-broadcast information 114 associated with at least one of the one or more players in accordance with their inclusion in the fantasy team associated with the at least one participant 102. Numerous types of non-broadcast information 114 may be displayed. Examples of such non-broadcast information 114 include, but are not limited to, statistics associated with one or more players, statistics associated with one or more teams on which the one or more players are members, events associated with one or more players, events associated with one or more teams on which the one or more players are members, positional information associated with one or more players, and the like.

Operation 570 includes transmitting one or more instructions to display the at least one fantasy team attribute. In some embodiments, an assembly module 108 transmits one or more instructions to display the at least one fantasy team attribute. Instructions to display numerous types of fantasy team attributes may be transmitted. Examples of such fantasy team attributes include, but are not limited to, a fantasy team logo, a fantasy team sound, a fantasy team color, a fantasy team song, a fantasy team symbol, a fantasy team, and the like. In some embodiments, an assembly module 108 may be configured to transmit one or more instructions that include the position in which one or more fantasy team attributes are displayed. For example, in some embodiments, an assembly module 108 may transmit one or more instructions to have a fantasy team logo displayed on an image of a helmet worn by a player on a fantasy team that is part of broadcast content 116. Accordingly, in some embodiments, an assembly module 108 may be configured to utilize information associated with the position of an image that is broadcast to overlay non-broadcast information 114 (e.g., a fantasy team attribute) on the broadcast image in a position dependent manner. Positional information may be obtained through use of numerous methods and technologies. Examples of such methods and technologies include, but are not limited to, digital analysis (e.g., pixel analysis, optical character recognition), sensor networks, and the like. In some embodiments, an assembly module 108 may be configured to apply a grid to a displayed image of broadcast content 116 to assign coordinates to the displayed broadcast content 116 and then transmit one or more instructions to display non-broadcast information 114 (e.g., one or more fantasy team attributes) according to grid coordinates.

Operation 580 includes transmitting one or more instructions to display the broadcast content 116 as an overlay display. In some embodiments, an assembly module 108 transmits one or more instructions to display the broadcast content 116 as an overlay display. In some embodiments, an assembly module 108 may transmit one or more instructions to display non-broadcast information 114 as an overlay on the broadcast content 116. For example, in some embodiments, an assembly module 108 may transmit one or more instructions to display statistics associated with one or more players on a fantasy football team and/or statistics associated with a fantasy football team as an overlay on broadcast content 116 associated with a broadcast football game. In some embodiments, an assembly module 108 may be configured to transmit one or more instructions that include the position in which information is displayed as an overlay on broadcast content 116. For example, in some embodiments, an assembly module 108 may transmit one or more instructions to have a fantasy team logo displayed on an image of a soccer ball that is part of broadcast content 116. Accordingly, in some embodiments, an assembly module 108 may be configured to utilize information associated with the position of an image that is broadcast (e.g., soccer ball) to overlay non-broadcast information 114 (e.g., a fantasy team logo) on the broadcast image in a position dependent manner.

In some embodiments, operation 510 includes receiving one or more signals that include the information associated with the one or more players selected by the at least one participant 102 in a fantasy league for inclusion in the fantasy team associated with the at least one participant 102. In some embodiments, an assembly module 108 receives one or more signals that include information associated with one or more players selected by at least one participant 102 in a fantasy league for inclusion in fantasy team associated with the participant 102. Assembly modules 108 may be configured in numerous ways to receive numerous types of signals. Examples of such signals include, but are not limited to, wireless signals, acoustic signals, optical signals, magnetic signals, digital signals, analog signals, encrypted signals, and the like. Numerous types of information associated with one or more players may be received. Examples of such information include, but are not limited to, a name of a player, a position of a player (e.g., running back, quarterback, wide receiver, tackle, kicker, pitcher, forward, guard, etc.), an activity associated with a player (e.g., football, baseball, hockey, lacrosse, soccer, etc.), a unique identifier associated with a player, statistics associated with a player, and the like.

In some embodiments, operation 510 includes receiving information associated with the at least one participant 102 in the fantasy league. In some embodiments, an assembly module 108 receives information associated with at least one participant 102 in a fantasy league. Numerous types of information may be received. Examples of such information include, but are not limited to, a name associated with a participant, a location associated with a participant, verification information associated with a participant, account information associated with a participant, billing information associated with a participant, and the like.

In some embodiments, operation 510 includes receiving information associated with a name associated with each of the one or more players selected by the at least one participant 102. In some embodiments, an assembly module 108 receives information associated with a name associated with each of one or more players selected by a participant 102. Examples of such information include, but are not limited to, a real name associated with a player, a nickname associated with a player, a participant 102 assigned name associated with a player, and the like.

In some embodiments, operation 510 includes receiving information associated with a position on the fantasy team occupied by each of the one or more players selected by the at least one participant 102. In some embodiments, an assembly module 108 receives information associated with a position on a fantasy team occupied by each of one or more players selected by a participant 102. Examples of such positions occupied by a player include, but are not limited to, a running back, a quarterback, a wide receiver, a tackle, a kicker, a pitcher, a forward, a guard, and the like.

In some embodiments, operation 510 includes grouping the one or more players selected by the at least one participant 102 into the at least one fantasy team and linking the fantasy team attribute to the fantasy team. In some embodiments, an assembly module 108 may be configured to group one or more players selected by a participant 102 into a fantasy team and link a fantasy team attribute to the fantasy team. For example, in some embodiments, players selected by a participant 102 may all be linked to a unique identifier to which a fantasy team attribute is also linked.

In some embodiments, operation 510 includes saving the information associated with the one or more players selected by the at least one participant 102 to form the at least one fantasy team in a database. In some embodiments, an assembly module 108 may be configured to save information associated with one or more players selected by a participant 102 to form a fantasy team in a database. Information may be saved in numerous types of databases. In some embodiments, information may be saved in a database that is linked to a unique identifier that is associated with a particular participant 102 in a fantasy league. For example, in some embodiments, participant 102 information may be linked to unique identifier assigned to the participant 102. In some embodiments, information associated with a participant's fantasy team may be linked to unique identifier assigned to the participant 102. Examples of such information include, but are not limited to, a name of a player, a position occupied by a player on a fantasy team, a participant 102 selected attribute associated with a fantasy team, and the like. In some embodiments, a database may be associated with a database management system. Examples of such database management systems include, but are not limited to, MySQL, PostgreSQL, Microsoft SQL Server, SQLite, SAP HANA, dBASE, FoxPro, IBM DB2, MariaDB, LibreOffice Base, FileMaker Pro, and the like.

In some embodiments, operation 520 includes receiving one or more signals that include the information associated with the at least one fantasy team attribute selected by the at least one participant 102. In some embodiments, an assembly module 108 receives one or more signals that include information associated with at least one fantasy team attribute selected by a participant 102. Numerous types of signals may be received. Examples of such signals include, but are not limited to, wireless signals, acoustic signals, optical signals, magnetic signals, digital signals, analog signals, encrypted signals, and the like.

In some embodiments, operation 520 includes receiving information associated with at least one participant selected name associated with the at least one fantasy team. In some embodiments, an assembly module 108 receives information associated with at least one participant selected name associated with a fantasy team. For example, in some embodiments, a participant 102 may select a name that is associated with the participant's fantasy team. Examples of such names include, but are not limited to, stars, lions, tigers, jets, jaguars, cougars, and the like. In some embodiments, such names may be linked to a unique identifier associated with the participant 102 that selected the fantasy team name.

In some embodiments, operation 520 includes receiving information associated with at least one participant selected sound associated with the at least one fantasy team. In some embodiments, an assembly module 108 receives information associated with a participant selected sound associated with a fantasy team. Numerous sounds may be provided and/or selected by a participant 102. In some embodiments, such sounds may include, but are not limited to, a lion's roar, a jet engine sound, a cheering crowd, a fight song, and the like.

In some embodiments, operation 520 includes receiving information associated with at least one participant selected color associated with the at least one fantasy team. In some embodiments, an assembly module 108 receives information associated with a participant selected color associated with a fantasy team. Numerous colors and combinations of colors may be selected by a participant 102. Examples of such colors and color combinations include, but are not limited to, blue, green, yellow, red, blue and green, yellow and red, orange and black, and the like.

In some embodiments, operation 520 includes receiving information associated with at least one participant selected symbol associated with the at least one fantasy team. In some embodiments, an assembly module 108 receives information associated with a participant selected symbol associated with a fantasy team. Numerous types of symbols may be selected and/or provided by a participant 102. Examples of such symbols include, but are not limited to, a lion, a tiger, a leopard, a bear, a star, a lightning bolt, and the like.

In some embodiments, operation 530 includes receiving one or more signals that include the broadcast content 116. In some embodiments, an assembly module 108 receives one or more signals that include broadcast content 116. Examples of such signals include, but are not limited to, wireless signals, acoustic signals, optical signals, magnetic signals, digital signals, analog signals, encrypted signals, and the like. Numerous types of broadcast content 116 may be received. Examples of broadcast content 116 include, but are not limited to, broadcast sporting events, television programs, and the like.

In some embodiments, operation 530 includes receiving broadcast content 116 that is associated with at least one of the one or more players that were selected by the at least one participant 102. In some embodiments, an assembly module 108 receives broadcast content 116 that is associated with at least one of the one or more players that were selected by a participant 102. For example, in some embodiments, broadcast content 116 may be received that is associated with a player that was selected by a participant 102 for inclusion on the participant's fantasy team.

In some embodiments, operation 530 includes receiving broadcast content 116 that is associated with at least one of the one or more players that were selected by the at least one participant 102 and then linking the one or more players included within the broadcast content 116 to the fantasy team attribute. In some embodiments, an assembly module 108 may be configured to receive broadcast content 116 that is associated with at least one of one or more players that were selected by a participant 102 and then link the one or more players included within the broadcast content 116 to a fantasy team attribute. For example, in some embodiments, an assembly module 108 may receive broadcast content 116 that includes a broadcast football game and then link one or more players that are included in a participant's fantasy team and in the broadcast football game to a fantasy team logo selected by the participant 102. Accordingly, in some embodiments, an assembly module 108 may be configured to link a unique identifier assigned to a participant 102 to each of the players selected for inclusion in the participant's fantasy team and to a fantasy team attribute. The assembly module 108 may query broadcast content 116 for players associated with the unique identifier and then associate a fantasy team attribute associated with the unique identifier to each of the players.

In some embodiments, operation 530 includes querying one or more listings of broadcast content 116 to determine broadcast content 116 that is associated with at least one of the one or more players that were selected by the at least one participant 102 and then receiving the broadcast content 116 that is associated with the one or more players that were selected by the at least one participant 102. In some embodiments, an assembly module 108 may query one or more listings of broadcast content 116 to determine broadcast content 116 that is associated with at least one of one or more players that were selected by a participant 102 and then receive broadcast content 116 that is associated with the one or more players that were selected by the participant 102. For example, in some embodiments, an assembly module 108 may query information associated with a roster of players associated with a football team and then determine if the team includes one or more players that were selected by a participant 102 for inclusion on the participant's fantasy football team. The assembly module 108 may then receive a broadcast football game that is associated with one or more players that are included on the participant's fantasy football team.

In some embodiments, operation 530 includes receiving broadcast content 116 that includes positional information associated with any of the one or more players selected by the at least one participant 102. In some embodiments, an assembly module 108 receives broadcast content 116 that includes positional information associated with any of one or more players selected by a participant 102. In some embodiments, an assembly module 108 may receive positional information from one or more sensor networks that report the position of one or more players. For example, in some embodiments, each player on a football team may be linked to a tag that can be used to determine the position of the player through use of a sensor network. Such positional information may be included within broadcast content 116 associated with broadcast of a football game in which the players who are linked to tags are participating. Accordingly, in some embodiments, an assembly module 108 may receive such positional information that is included within the broadcast content 116. In some embodiments, such positional information may be used to position an overlay of non-broadcast information 114 onto broadcast content 116 in a position dependent manner. In some embodiments, broadcast content 116 may include positional information that is determined through use of numerous methods and technologies. For example, in some embodiments, broadcast content 116 may include positional information obtained through use of digital analysis (e.g., pixel analysis, optical character recognition, etc.).

In some embodiments, operation 530 includes receiving broadcast content 116 that includes information associated with one or more players selected by the at least one participant 102 and then doing pixel analysis to obtain positional information associated with any of the one or more players selected by the at least one participant 102 that are included in the broadcast content 116. In some embodiments, an assembly module 108 may receive broadcast content 116 that includes information associated with one or more players selected by a participant 102 and do pixel analysis to obtain positional information associated with any of the one or more players selected by the participant 102 that are included in the broadcast content 116 (see e.g., Lei et al., An adaptive search window algorithm for player tracking in broadcast tennis videos, International Journal of Innovative Computing, Information and Control, 8:10(A), October 2012; Zhu et al., Player action recognition in broadcast tennis video with applications to semantic analysis of sports game, Proceedings of the 14^{th} annual ACM international conference on Multimedia, Pages 431-440, ACM, New York, USA, 2006; Choi and Seo, Tracking soccer ball in TV broadcast video, Image Analysis and Processing—ICIAP 2005, Lecture Notes in Computer Science, Vol. 3617, pp. 661-668, 2005; Zhang et al., Robust multi-object tracking via cross-domain contextual information for sports video analysis, In Acoustics, Speech and Signal Processing (ICASSP), 2012 IEEE International Conference on (pp. 985-988). IEEE, March, 2012).

In some embodiments, operation 530 includes receiving broadcast content 116 that includes information associated with one or more players selected by the at least one participant 102 and then doing optical character recognition analysis to obtain positional information associated with any of the one or more players selected by the at least one participant 102 that are included in the broadcast content 116. In some embodiments, an assembly module 108 may receive broadcast content 116 that includes information associated with one or more players selected by a participant 102 and then do optical character recognition analysis to obtain positional information associated with any of the one or more players selected by the participant 102 that are included in the broadcast content 116. For example, in some embodiments, optical character recognition may be used to determine the position of a displayed image of a football player based on the player's number (e.g., number on the player's jersey and/or helmet) (see e.g., U.S. Pat. No. 8,102,405: TV Screen Text Capture; U.S. Pat. No. 8,683,031: Methods and systems for scanning and monitoring content on a network; U.S. Pat. No. 8,682,077: Method for omnidirectional processing of 2D images including recognizable characters; U.S. Pat. No. 7,689,613: OCR input to search engine; U.S. Pat. No. 7,506,356: Skimming continuous multimedia content; U.S. Published Patent Application Number 20100192178: Capture of stylized TV table data via OCR; U.S. Published Patent Application Number 20080226119: Content image search; Borse and Rangdale, Online and offline extraction of text from television program, International Journal of Advanced Research in Computer Science and Software Engineering, Vol. 4(1), January 2014).

In some embodiments, operation 540 includes receiving one or more signals that include the non-broadcast information 114. In some embodiments, an assembly module 108 receives one or more signals that include non-broadcast information 114. Examples of such signals include, but are not limited to, wireless signals, acoustic signals, optical signals, magnetic signals, digital signals, analog signals, encrypted signals, and the like. Numerous types of non-broadcast information 114 may be received. Example of such non-broadcast information 114 include, but are not limited to, internet-based information, subscription-based information, private network information, participant provided information, and the like.

In some embodiments, operation 540 includes retrieving non-broadcast information 114 through a network 110. In some embodiments, an assembly module 108 receives non-broadcast information 114 through a network 110. Examples of networks 110 include, but are not limited to, telecommunications networks 110, cable networks 110, wireless networks 110, wired networks 110, the internet 110, television networks 110, radio networks 110, local area networks 110, and the like.

In some embodiments, operation 540 includes retrieving non-broadcast information 114 through an internet-based network 110. In some embodiments, an assembly module 108 receives non-broadcast information 114 through an internet-based network 110.

In some embodiments, operation 540 includes querying one or more networks 110 for non-broadcast information 114 that is associated with at least one of the one or more players that were selected by the at least one participant 102 and then receiving the non-broadcast information 114 that is associated with the at least one of the one or more players that were selected by the at least one participant 102. In some embodiments, an assembly module 108 may query one or more networks 110 for non-broadcast information 114 that is associated with at least one of one or more players that were selected by a participant 102 and then receiving the non-broadcast information 114 that is associated with at least one of the one or more players that were selected by the participant 102. Numerous types of non-broadcast information 114 may be received. Examples of such non-broadcast information 114 include, but are not limited to, statistics, pictures, graphics, logos, sounds, colors, and the like.

In some embodiments, operation 540 includes retrieving one or more statistics associated with at least one of the one or more players that were selected by the at least one participant 102. In some embodiments, an assembly module 108 receives one or more statistics associated with at least one of the one or more players that were selected by a participant 102. In some embodiments, statistics may be associated with an individual player. In some embodiments, statistics may be associated with one or more players on a participant's fantasy team. In some embodiments, statistics may be associated with one or more players on another participant's fantasy team. In some embodiments, statistics may be associated with one or more fantasy teams that were selected by more than one participant 102.

In some embodiments, operation 540 includes retrieving information associated with one or more events associated with at least one of the one or more players that were selected by the at least one participant 102. In some embodiments, an assembly module 108 receives information associated with one or more events associated with at least one of one or more players that were selected by a participant 102. Numerous events that are associated with a player may be received. Examples of such events include, but are not limited to, a penalty, a tackle, a touchdown, a field goal, and the like.

In some embodiments, operation 540 includes retrieving positional information associated with any of the one or more players selected by the at least one participant 102. In some embodiments, an assembly module 108 retrieves positional information associated with any of one or more players selected by a participant 102. In some embodiments, positional information may be obtained through use of digital analysis (e.g., pixel analysis, optical character recognition, etc.). In some embodiments, an assembly module 108 may obtain positional information from one or more sensor networks. For example, in some embodiments, a player or object that is associated with an activity may be associated with a tag (e.g., radio frequency identification tag, magnetic tag, transmitter, etc.) that allows the identity and/or position of the player or object to be determined. For example, in some embodiments, a player on a football team may be associated with an identification tag that allows the identity and position of the player to be determined. In some embodiments, a race car may be associated with a tag that allows the position of the race car to be determined. In some embodiments, a hockey puck may be associated with a tag that allows the position of the hockey puck to be determined. In some embodiments, a soccer ball may be associated with a tag that allows the position of the soccer ball to be determined. In some embodiments, positional information may include one or more characteristics associated with position and/or movement. For example, in some embodiments, positional information may include the velocity at which a player and/or object is moving. In some embodiments, positional information may include acceleration and/or deceleration associated with a player and/or object. Accordingly, in some embodiments, such positional information may be used to determine force applied to a player and/or object. For example, in some embodiments, positional information may include how quickly a football player decelerates upon being tackled. In some embodiments, such information may be used to calculate the force with which a football player is tackled. In some embodiments, positional information may include how quickly a football player is running. In some embodiments, positional information may be associated with an object. Examples of objects include, but are not limited to, a hockey puck, a tennis ball, a golf ball, a football, a rugby ball, a Frisbee, a race car, a motorcycle, a baseball, and the like. In some embodiments, positional information may include acceleration and/or deceleration and/or velocity associated with an object. For example, in some embodiments, positional information may include acceleration and/or velocity associated with a tennis ball. In some embodiments, positional information may include acceleration and/or velocity associated with a football. In some embodiments, positional information may include acceleration and/or velocity associated with a hockey puck. In some embodiments, positional information may be associated with an activity in which a player is involved. For example, in some embodiments, positional information may be associated with players and/or objects that are associated with a fantasy league. Accordingly, in some embodiments, positional information may be associated with players and/or objects associated with the fantasy league. In some embodiments, positional information may be displayed as on overlay on broadcast content 116. In some embodiments, the position of a player and/or object may be determined and/or tracked.

In some embodiments, operation 550 includes transmitting one or more signals that include the one or more instructions to display the descriptor associated with the one or more players selected by the at least one participant 102. In some embodiments, an assembly module 108 transmits one or more signals that include one or more instructions to display a descriptor associated with one or more players selected by a participant 102. Examples of such signals include, but are not limited to, wireless signals, acoustic signals, optical signals, magnetic signals, digital signals, analog signals, encrypted signals, and the like. Examples of such descriptors include, but are not limited to, a player name, a player team logo, a player team color, a player team song, a player team sound, a player position on a fantasy team (e.g., wide receiver, quarterback, running back, forward, guard, etc.) and the like.

In some embodiments, operation 550 includes transmitting one or more instructions to display a name associated with at least one of the one or more players selected by the at least one participant 102. In some embodiments, an assembly module 108 transmits one or more instructions to display a name associated with at least one of the one or more players selected by the at least one participant 102. Numerous names may be associated with one or more players. In some embodiments, a name may be a real name associated with a player. In some embodiments, a name may be a nickname name associated with a player. In some embodiments, a name may be a participant provided name associated with a player. In some embodiments, a name may be a participant selected name associated with a player. In some embodiments, a name may be a name associated with a fantasy team on which the player is a member. In some embodiments, a name may be a name associated with a fantasy league in which the player is a member. Accordingly, numerous types of names may be associated with a player.

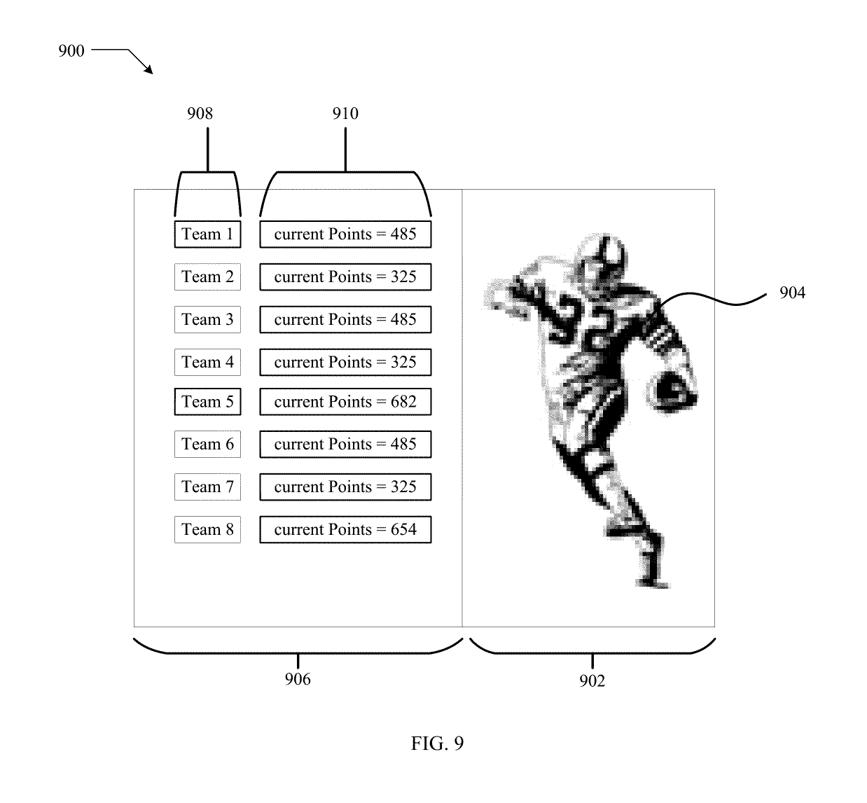

In some embodiments, operation 550 includes transmitting one or more instructions to display a name associated with each of the one or more players selected by the at least one participant 102 to form the fantasy team. In some embodiments, an assembly module 108 transmits one or more instructions to display a name associated with each of one or more players selected by a participant 102 to form a fantasy team. For example, in some embodiments, instructions to display a roster of names associated with a fantasy team may be transmitted (e.g., FIGS. 9-13). In some embodiments, instructions to display rosters of names associated with one or more fantasy teams may be transmitted (e.g., FIGS. 9-13). In some embodiments, instructions to display rosters of names associated with one or more fantasy teams that are associated with more than one participant 102 may be transmitted (e.g., FIGS. 9-13).

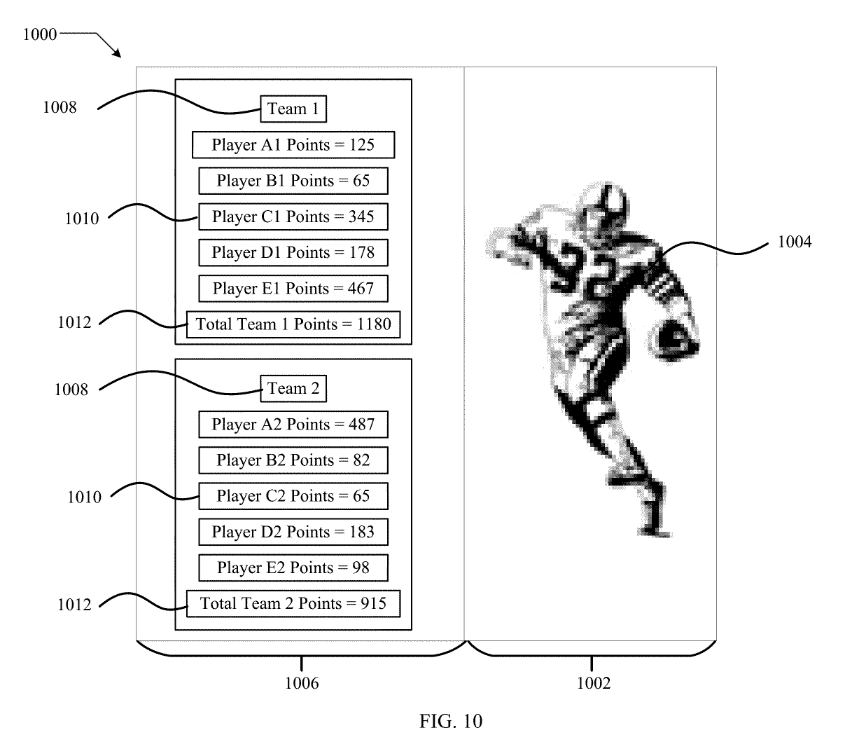

In some embodiments, operation 550 includes transmitting one or more instructions to display a name associated with each of the one or more players selected by the at least one participant 102 to form the fantasy team and a participant 102 selected name associated with the fantasy team. In some embodiments, an assembly module 108 transmits one or more instructions to display a name associated with each of one or more players selected by a participant 102 to form a fantasy team and a participant 102 selected name associated with the fantasy team. For example, in some embodiments, instructions to display a roster of names associated with players included within a fantasy team and a name associated with the fantasy team may be transmitted. In some embodiments, instructions to display more than one roster of names associated with players included within more than one fantasy team and names associated with the fantasy teams may be transmitted. In some embodiments, instructions to display rosters of names associated with players included within fantasy teams associated with different participants 102 and names associated with each of the fantasy teams associated with the different participants 102 may be transmitted (e.g., FIGS. 10, 12, and 13).

In some embodiments, operation 550 includes transmitting one or more instructions to display a position on the fantasy team occupied by at least one of the one or more players selected by the at least one participant 102. In some embodiments, an assembly module 108 transmits one or more instructions to display a position on a fantasy team occupied by a player selected by a participant 102. Examples of a player position on a fantasy league include, but are not limited to, a wide receiver, a quarterback, a running back, a forward, a guard, a catcher, a pitcher, a goalie, and the like.

In some embodiments, operation 550 includes transmitting one or more instructions to display a status associated with at least one of the one or more players selected by the at least one participant 102. In some embodiments, an assembly module 108 transmits one or more instructions to display a status associated with a player selected by a participant 102. Examples of such statuses include, but are not limited to, an injured status, a most valuable player status, a penalty status, a suspended status, and the like.

In some embodiments, operation 560 includes transmitting one or more signals that include the one or more instructions to display the non-broadcast information 114 associated with the one or more players selected by the at least one participant 102. In some embodiments, an assembly module 108 transmits one or more signals that include one or more instructions to display non-broadcast information 114 associated with a player selected by a participant 102. Examples of such signals include, but are not limited to, wireless signals, acoustic signals, optical signals, magnetic signals, digital signals, analog signals, encrypted signals, and the like. Examples of such non-broadcast information 114 include, but are not limited to, statistics associated with a player and/or fantasy team on which the player is included, participant 102 selected attributes associated with a player and/or fantasy team on which the player is included, a status associated with a player and/or fantasy team on which the player is included, and the like.

In some embodiments, operation 560 includes transmitting one or more instructions to display at least one statistic associated with at least one of the one or more players selected by the at least one participant 102. In some embodiments, an assembly module 108 transmits one or more instructions to display a statistic associated with a players selected by a participant 102. Instructions to display numerous types of statistics may be transmitted. Examples of such statistics include, but are not limited to, player performance statistics (e.g., running yards, tackles, catches, pass completions, pass interceptions, goals, field goals completed, field goals failed, etc.), penalty statistics, (e.g., time in penalty box, number of penalties, penalties received, penalties caused, etc.), statistics related to injuries, statistics related to salary, personal statistics (e.g., number of children, age of children, number of marriages, etc.), and the like.

In some embodiments, operation 560 includes transmitting one or more instructions to display at least one event associated with at least one of the one or more players selected by the at least one participant 102. In some embodiments, an assembly module 108 transmits one or more instructions to display an event associated with a player selected by a participant 102. In some embodiments, an indicator of an event associated with a player may be displayed. In some embodiments, an indicator may be displayed next to a descriptor for a player. For example, in some embodiments, a “TD” may be displayed next to the displayed name of a player who makes a touchdown in a football game. In some embodiments, an “FG” may be displayed next to the displayed name of a player who makes a field goal in a football game. In some embodiments, a “G” may be displayed next to the displayed name of a player who makes a goal in a soccer game. Accordingly, in some embodiments, numerous types of indicators may be displayed in response to numerous types of events associated with a player on a fantasy team. In some embodiments, numerous types of indicators may be displayed in response to numerous types of events associated with a fantasy team on which a player is included that is associated with the occurrence of an event.

In some embodiments, operation 570 includes transmitting one or more signals that include the one or more instructions to display the fantasy team attribute selected by the at least one participant 102. In some embodiments, an assembly module 108 transmits one or more signals that include one or more instructions to display a fantasy team attribute selected by a participant 102. Examples of such signals include, but are not limited to, wireless signals, acoustic signals, optical signals, magnetic signals, digital signals, analog signals, encrypted signals, and the like. Examples of such fantasy team attributes include, but are not limited to, a fantasy team logo, a fantasy team sound, a fantasy team color, a fantasy team song, a fantasy team symbol, a fantasy team, and the like. In some embodiments, instructions may include instructions associated with where on a display a fantasy team attribute is displayed. For example, in some embodiments, instruction may include instructions to display a fantasy team attribute as an overlay on a displayed image of a player that is included within a fantasy team (e.g., overlay an image of a star on a displayed image of a player's helmet) (e.g., FIG. 13).

In some embodiments, operation 570 includes transmitting one or more instructions to display at least one participant selected name associated with the at least one fantasy team. In some embodiments, an assembly module 108 transmits one or more instructions to display a participant selected name associated with a fantasy team. In some embodiments, a participant selected name for a fantasy team may be displayed as an overlay on broadcast content 116. For example, in some embodiments, instructions to display a participant selected fantasy team name as an overlay on one or more displayed images of one or more players included within the participant's fantasy team may be transmitted. Numerous names may be selected by a participant 102 for association with a fantasy team.

In some embodiments, operation 570 includes transmitting one or more instructions to display at least one participant selected sound associated with the at least one fantasy team. In some embodiments, an assembly module 108 transmits one or more instructions to display a participant selected sound associated with a fantasy team. Instructions to display numerous types of sounds may be transmitted. Examples of such sounds include, but are not limited to, a lion's roar, a jet engine sound, a cheering crowd, a fight song, and the like.

In some embodiments, operation 570 includes transmitting one or more instructions to display at least one participant selected color associated with the at least one fantasy team. In some embodiments, an assembly module 108 transmits one or more instructions to display a participant selected color associated with a fantasy team. Instructions to display numerous colors and combinations of colors may be transmitted. Examples of such colors and combinations of colors include, but are not limited to, green, blue, red, yellow, green and blue, red and white, purple and white, and the like.

In some embodiments, operation 570 includes transmitting one or more instructions to display at least one participant selected symbol associated with the at least one fantasy team. In some embodiments, an assembly module 108 transmits one or more instructions to display a participant selected symbol associated with a fantasy team. Instructions to display numerous types of symbols may be transmitted. Examples of such symbols include, but are not limited to, a lion, a tiger, a leopard, a bear, a star, a lightning bolt, and the like. In some embodiments, a participant selected symbol associated with a fantasy team may be displayed as an overlay on broadcast content 116. For example, in some embodiments, instructions to display a participant selected symbol as an overlay on one or more displayed images of one or more players included within the participant's fantasy team may be transmitted (e.g., FIG. 13).

In some embodiments, operation 580 includes transmitting one or more signals that include the one or more instructions to display the broadcast content 116 as an overlay display. In some embodiments, an assembly module 108 transmits one or more signals that include one or more instructions to display broadcast content 116 as an overlay display. In some embodiments, an assembly module 108 transmits one or more signals that include one or more instructions to display content and/or information as on overlay on broadcast content 116. Examples of such signals include, but are not limited to, wireless signals, acoustic signals, optical signals, magnetic signals, digital signals, analog signals, encrypted signals, and the like. In some embodiments, instructions may include instruction to display numerous types of content and/or information as an overlay on broadcast content 116. In some embodiments, information may include non-broadcast information 114 (e.g., user provided information, statistics, etc.). In some embodiments, content may include user provided content.

In some embodiments, operation 580 includes transmitting one or more instructions to display the broadcast content 116 as an overlay display with a descriptor associated with the one or more players selected by the at least one participant 102 to form the at least one fantasy team. In some embodiments, an assembly module 108 transmits one or more instructions to display broadcast content 116 as an overlay display with a descriptor associated with one or more players selected by a participant 102 to form a fantasy team. In some embodiments, instructions may include instruction to display numerous types of descriptors as an overlay on broadcast content 116. Examples of such descriptors include, but are not limited to, a player name, a player team logo, a player team color, a player team song, a player team sound, a player position on a fantasy team (e.g., wide receiver, quarterback, running back, forward, guard, etc.) and the like. In some embodiments, instructions may include instructions associated with a position where one or more descriptors will be displayed as an overlay on broadcast content 116. In some embodiments, a descriptor may be displayed as an overlay on a displayed image of a player that is included on a fantasy team. For example, in some embodiments, a team logo associated with a fantasy team may be displayed as an overlay on a displayed image of a player that is included on the fantasy team (e.g., FIG. 13).

In some embodiments, operation 580 includes transmitting one or more instructions to display the broadcast content 116 as an overlay display with a name associated with each of the one or more players selected by the at least one participant 102. In some embodiments, an assembly module 108 transmits one or more instructions to display broadcast content 116 as an overlay display with a name associated with a player selected by a participant 102. For example, in some embodiments, one or more names associated with one or more players included within a fantasy team may be displayed as an overlay on broadcast content 116. In some embodiments, a roster of names associated with players included within a fantasy team may be displayed as an overlay on broadcast content 116. In some embodiments, a name associated a player included within a fantasy team may be displayed as an overlay on a displayed image of the player.

In some embodiments, operation 580 includes transmitting one or more instructions to display the broadcast content 116 as an overlay display with a name associated with each of the one or more players selected by the at least one participant, the non-broadcast information 114 associated with the one or more players, and the at least one fantasy team attribute. In some embodiments, an assembly module 108 transmits one or more instructions to display broadcast content 116 as an overlay display with a name associated with each of one or more players selected by a participant, non-broadcast information 114 associated with the one or more players, and at least one fantasy team attribute associated with the fantasy team (e.g., FIG. 13). For example, in some embodiments, one or more names associated with one or more players that that are included on one or more fantasy teams, one or more statistics associated with the one or more players and/or fantasy teams, and one or more fantasy team attributes associated with the one or more fantasy teams may be displayed as an overlay on broadcast content 116. Accordingly, numerous names, types of non-broadcast content 116, and numerous types of fantasy team attributes may be displayed as an overlay on broadcast content 116.

In some embodiments, operation 580 includes transmitting one or more instructions to display the broadcast content 116 as an overlay display with at least one fantasy team attribute being associated with at least one of the one or more players selected by the at least one participant 102. In some embodiments, an assembly module 108 transmits one or more instructions to display broadcast content 116 as an overlay display with at least one fantasy team attribute being associated with at least one of one or more players selected by a participant 102. For example, in some embodiments, one or more fantasy team attributes may be displayed as an overlay on broadcast content 116 containing one or more displayed images of one or more players selected by a participant 102 for inclusion on their fantasy team. In some embodiments, one or more instructions to display a fantasy team logo as an overlay on one or more displayed images of one or more players selected by a participant 102 that are included within broadcast content 116 may be transmitted. In some embodiments, one or more instructions to display a fantasy team color as an overlay on one or more displayed images of one or more players selected by a participant 102 that are included within broadcast content 116 may be transmitted. In some embodiments, one or more instructions to display a fantasy team sound when one or more images of one or more players selected by a participant 102 are displayed within broadcast content 116 may be transmitted.

In some embodiments, operation 580 includes transmitting one or more instructions to display at least one fantasy team attribute selected by the at least one participant 102 mapped onto at least one displayed image of at least one player selected by the at least one participant 102 through use of positional information associated with the at least one player. In some embodiments, an assembly module 108 transmits one or more instructions to display a fantasy team attribute selected by a participant 102 mapped onto at least one displayed image of a player selected by a participant 102 through use of positional information associated with the player. For example, in some embodiments, an assembly module 108 may transmit one or more instructions to display a fantasy team logo (e.g., star) as an overlay on broadcast content 116 and mapped onto a displayed image of a helmet worn by a player selected by the participant 102 for inclusion on their fantasy team (e.g., FIG. 13). In some embodiments, an assembly module 108 may transmit one or more instructions to display team color (e.g., green) as an overlay on broadcast content 116 and mapped onto a displayed image of a uniform worn by a player selected by the participant 102 for inclusion on their fantasy team. Accordingly, an assembly module 108 may transmit numerous instructions to display numerous types of fantasy team attributes that are to be mapped onto a displayed image of a player selected by the participant 102. In some embodiments, positional information may be obtained from a sensor network. The positional information may then be used to map one or more displayed fantasy team attributes onto broadcast content 116 in a position dependent manner. In some embodiments, positional information may be obtained through use of digital analysis (e.g., pixel analysis, optical character recognition, etc.) (see e.g., U.S. Pat. No. 8,102,405: TV Screen Text Capture; U.S. Pat. No. 8,683,031: Methods and systems for scanning and monitoring content on a network; U.S. Pat. No. 8,682,077: Method for omnidirectional processing of 2D images including recognizable characters; U.S. Pat. No. 7,689,613: OCR input to search engine; U.S. Pat. No. 7,506,356: Skimming continuous multimedia content; U.S. Published Patent Application Number 20100192178: Capture of stylized TV table data via OCR; U.S. Published Patent Application Number 20080226119: Content image search; Borse and Rangdale, Online and offline extraction of text from television program, International Journal of Advanced Research in Computer Science and Software Engineering, Vol. 4(1), January 2014). The positional information may then be used to map one or more displayed fantasy team attributes onto broadcast content 116 in a position dependent manner. In some embodiments, positional information may be used in combination with tracking analysis (e.g., pixel analysis, optical character recognition, etc.) (see e.g., Lei et al., An adaptive search window algorithm for player tracking in broadcast tennis videos, International Journal of Innovative Computing, Information and Control, 8:10(A), October 2012; Zhu et al., Player action recognition in broadcast tennis video with applications to semantic analysis of sports game, Proceedings of the 14^{th} annual ACM international conference on Multimedia, Pages 431-440, ACM, New York, USA, 2006; Choi and Seo, Tracking soccer ball in TV broadcast video, Image Analysis and Processing—ICIAP 2005, Lecture Notes in Computer Science, Vol. 3617, pp. 661-668, 2005; Zhang et al., Robust multi-object tracking via cross-domain contextual information for sports video analysis, In Acoustics, Speech and Signal Processing (ICASSP), 2012 IEEE International Conference on (pp. 985-988). IEEE, March, 2012). The positional information and the tracking information may be used in combination to map one or more displayed fantasy team attributes onto broadcast content 116 in a position dependent manner.

In some embodiments, operation 580 includes transmitting one or more instructions to display at least one fantasy team name selected by the at least one participant 102 mapped onto at least one displayed image of at least one player selected by the at least one participant 102 through use of positional information associated with the at least one player. In some embodiments, an assembly module 108 transmits one or more instructions to display a fantasy team name selected by a participant 102 mapped onto a displayed image of a player selected by the participant 102 through use of positional information associated with the player. In some embodiments, instructions to display a fantasy team name as an overlay on one or more players selected by one participant 102 may be transmitted. In some embodiments, instructions to display one or more fantasy team names as an overlay on one or more players selected by one or more participants 102 may be transmitted. For example, in some embodiments, one or more instructions may be transmitted to display a first name associated with a first fantasy team as an overlay onto displayed images of players included within the first fantasy team and to display a second name associated with a second fantasy team as an overlay onto displayed images of players included within the second fantasy team.

In some embodiments, operation 580 includes transmitting one or more instructions to display at least one fantasy team color selected by the at least one participant 102 mapped onto at least one displayed image of at least one player selected by the at least one participant 102 through use of positional information associated with the at least one player. In some embodiments, an assembly module 108 transmits one or more instructions to display a fantasy team color selected by a participant 102 mapped onto a displayed image of a player selected by the participant 102 through use of positional information associated with the player. In some embodiments, instructions to display a fantasy team color as an overlay on one or more players selected by one participant 102 may be transmitted. In some embodiments, instructions to display one or more fantasy team colors as an overlay on one or more players selected by one or more participants 102 may be transmitted. For example, in some embodiments, one or more instructions may be transmitted to display a first fantasy team color associated with a first fantasy team as an overlay onto displayed images of players included within the first fantasy team and to display a second fantasy team color associated with a second fantasy team as an overlay onto displayed images of players included within the second fantasy team.

In some embodiments, operation 580 includes transmitting one or more instructions to display at least one fantasy team symbol selected by the at least one participant 102 mapped onto at least one displayed image of at least one player selected by the at least one participant 102 through use of positional information associated with the at least one player. In some embodiments, an assembly module 108 transmits one or more instructions to display a fantasy team symbol selected by a participant 102 mapped onto a displayed image of a player selected by the participant 102 through use of positional information associated with the player. In some embodiments, instructions to display a fantasy team symbol as an overlay on one or more players selected by one participant 102 may be transmitted. In some embodiments, instructions to display one or more fantasy team symbols as an overlay on one or more players selected by one or more participants 102 may be transmitted. For example, in some embodiments, one or more instructions may be transmitted to display a first fantasy team symbol associated with a first fantasy team as an overlay onto displayed images of players included within the first fantasy team and to display a second fantasy team symbol associated with a second fantasy team as an overlay onto displayed images of players included within the second fantasy team.

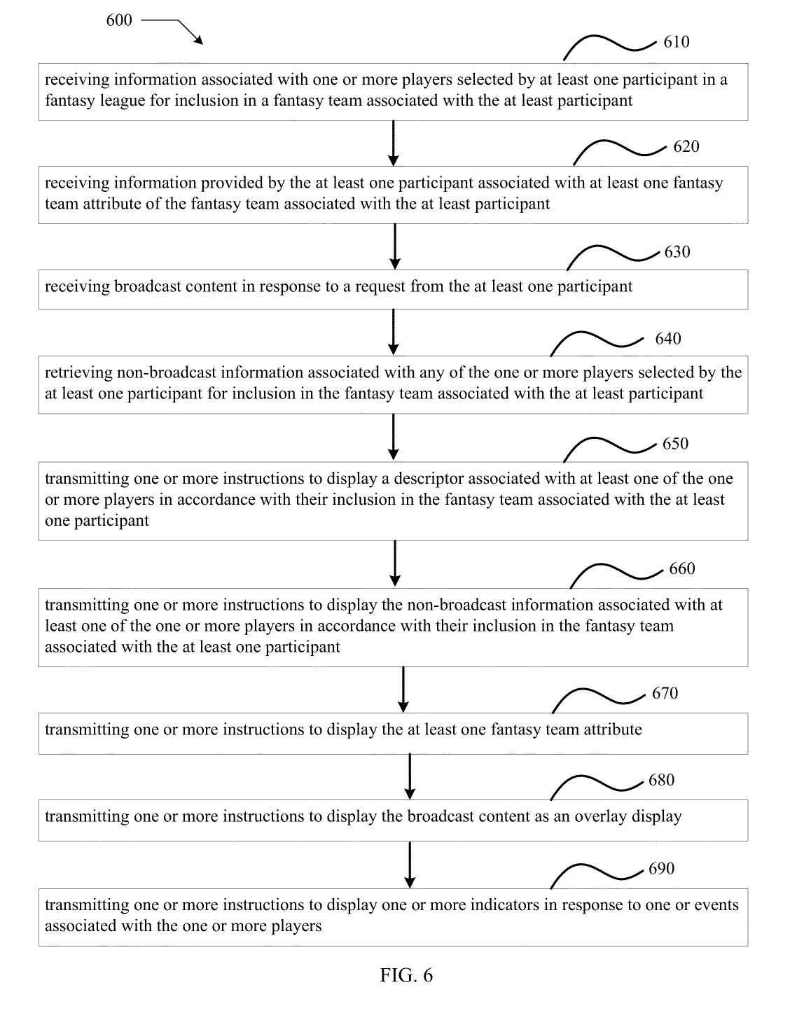

FIG. 6 illustrates an operational flow 600 representing examples of operations that are related to the performance of a method for receiving and transmitting information. In FIG. 6 and in following description that includes various examples of operations used during performance of the method, discussion and explanation may be provided with respect to the above-described example of FIG. 6, and/or with respect to other examples and contexts. However, it should be understood that the operations may be executed in a number of other environments and contexts, and/or modified versions of FIG. 6. Also, although the various operations are presented in the sequence(s) illustrated, it should be understood that the various operations may be performed in other orders than those which are illustrated, or may be performed concurrently. In some embodiments, the operations that are illustrated in FIG. 6 may be carried out in the context of system 100 as illustrated in FIG. 1. In some embodiments, operations 610, 620, 630, 640, 650, 660, 670, and 680 as illustrated in FIG. 6, correspond to operations 510, 520, 530, 540, 550, 560, 570, and 580 as illustrated and described with respect to FIG. 5.

Operation 690 includes transmitting one or more instructions to display one or more indicators in response to one or more events associated with the one or more players. In some embodiments, an assembly module 108 transmits one or more instructions to display one or more indicators in response to one or more events associated with one or more players. In some embodiments, one or more indicators may be displayed in response to one or more events associated with one or more fantasy teams which include the one or more players. In some embodiments, one or more indicators may be displayed in response to one or more events associated with one or more fantasy leagues which include the one or more players. In some embodiments, a participant 102 may preselect one or more events that trigger display of one or more indicators. Numerous types of indicators may be displayed in response to numerous types of events. Examples of indicators include, but are not limited to: sounds (e.g., cheers, booing sounds, hissing sounds, sounds associated with firework, sounds associated with explosions, sounds associated with crashes, etc.), colors (e.g., red, green, yellow, etc.), pictures (e.g., starburst picture, fireworks picture, etc.), symbols (e.g., no entry symbol, no exit symbol, no symbol, yes symbol, checkmark, etc.), and the like. Indicators may be displayed in response to numerous types of events. Examples of events include, but are not limited to: a touchdown, a field goal, a penalty, a crash, an injury, a homerun, a catch, a pass, a goal, a basket, and the like. In some embodiments, an event may include a positive event. A positive event may include an event that confers a benefit to a player included on a fantasy team and/or a fantasy team. In some embodiments, an event may include a negative event. A negative event may include an event that is detrimental to a player included on a fantasy team and/or a fantasy team. In some embodiments, a participant 102 may select one or more indicators that are to be displayed in response to one or more events. In some embodiments, a participant 102 may select one or more events that trigger display of one or more indicators. In some embodiments, a participant 102 may select one or more indicators that are to be displayed in response to one or more participant 102 selected events. Accordingly, in some embodiments, a participant 102 may select indicators and events that are coupled together.

In some embodiments, operation 690 includes transmitting one or more signals that include the one or more instructions to display the one or more indicators in response to the one or events associated with the one or more players selected by the at least one participant 102. In some embodiments, an assembly module 108 transmits one or more signals that include one or more instructions to display one or more indicators in response to one or events associated with one or more players selected by a participant 102. Examples of such signals include, but are not limited to, wireless signals, acoustic signals, optical signals, magnetic signals, digital signals, analog signals, encrypted signals, and the like.

In some embodiments, operation 690 includes transmitting one or more instructions to display one or more indicators in response to one or events associated with a positive event. In some embodiments, an assembly module 108 transmits one or more instructions to display one or more indicators in response to one or events associated with a positive event. In some embodiments, an indicator may be displayed in response to numerous types of positive events. Examples of such positive events include, but are not limited to, a tackle made by a player on a participant's fantasy team, an interception caught by a player on a participant's fantasy team, a goal made by a player on a participant's fantasy team, a catch made by a player on a participant's fantasy team, a penalty made by a player on an opposing fantasy team, an interception thrown by a player on an opposing fantasy team, and the like.

In some embodiments, operation 690 includes transmitting one or more instructions to display one or more indicators in response to one or positive events selected from at least one of a touchdown, a field goal, a safety, a goal, a tackle, a checkered flag, a win, or a hole-in-one. In some embodiments, an assembly module 108 transmits one or more instructions to display one or more indicators in response to one or positive events selected from at least one of a touchdown, a field goal, a safety, a goal, a tackle, a checkered flag, a win, or a hole-in-one.

In some embodiments, operation 690 includes transmitting one or more instructions to display one or more indicators in response to one or events associated with a negative event. In some embodiments, an assembly module 108 transmits one or more instructions to display one or more indicators in response to one or events associated with a negative event. In some embodiments, an indicator may be displayed in response to numerous types of negative events. Examples of such negative events include, but are not limited to, a tackle made by a player on an opponent's fantasy team, an interception caught by a player on an opponent's fantasy team, a goal made by a player on an opponent's fantasy team, a catch made by a player on an opponent's fantasy team, a penalty made by a player on a participant's fantasy team, an interception thrown by a player on a participant's fantasy team, and the like.

In some embodiments, operation 690 includes transmitting one or more instructions to display one or more indicators in response to one or negative events selected from at least one of a penalty, a fumble, a tackle, an interception, a crash, a goal, or a loss. In some embodiments, an assembly module 108 transmits one or more instructions to display one or more indicators in response to one or negative events selected from at least one of a penalty, a fumble, a tackle, an interception, a crash, a goal, or a loss.

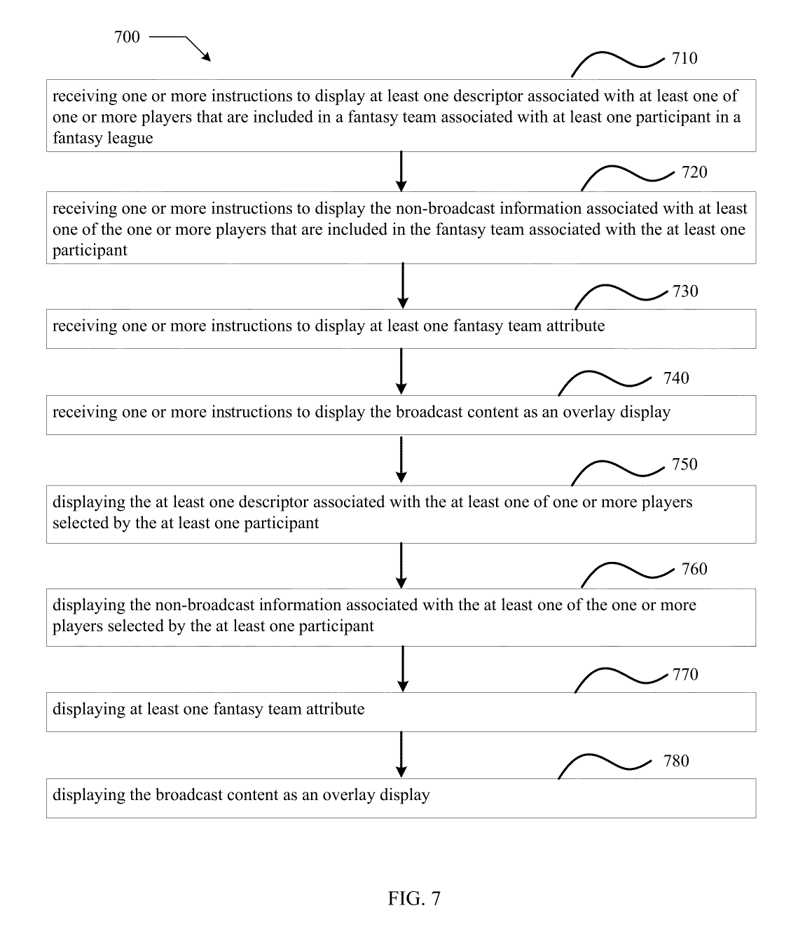

FIG. 7 illustrates an operational flow 700 representing examples of operations that are related to the performance of a method for receiving and transmitting information. In FIG. 7 and in following description that includes various examples of operations used during performance of the method, discussion and explanation may be provided with respect to the above-described example of FIG. 7, and/or with respect to other examples and contexts. However, it should be understood that the operations may be executed in a number of other environments and contexts, and/or modified versions of FIG. 7. Also, although the various operations are presented in the sequence(s) illustrated, it should be understood that the various operations may be performed in other orders than those which are illustrated, or may be performed concurrently. In some embodiments, the operations that are illustrated in FIG. 7 may be carried out in the context of system 100 as illustrated in FIG. 1.

Operation 710 includes receiving one or more instructions to display at least one descriptor associated with at least one of one or more players that are included in a fantasy team associated with at least one participant 102 in a fantasy league. In some embodiments, a display device 106 may receive one or more instructions to display at least one descriptor associated with at least one of one or more players that are included in a fantasy team associated with at least one participant 102 in a fantasy league. Instructions associated with displaying numerous types of descriptors may be received. Examples of such descriptors include, but are not limited to, a player name, a player team logo, a player team color, a player team song, a player team sound, a player position on a fantasy team (e.g., wide receiver, quarterback, running back, forward, guard, etc.) and the like.

Operation 720 includes receiving one or more instructions to display the non-broadcast information 114 associated with at least one of the one or more players that are included in the fantasy team associated with the at least one participant 102. In some embodiments, a display device 106 may receive one or more instructions to display the non-broadcast information 114 associated with at least one of the one or more players that are included in the fantasy team associated with the at least one participant 102. Numerous types of non-broadcast information 114 may be displayed. Examples of such non-broadcast information 114 include, but are not limited to, statistics associated with one or more players, statistics associated with one or more teams on which the one or more players are members, events associated with one or more players, events associated with one or more teams on which the one or more players are members, positional information associated with one or more players, and the like.

Operation 730 includes receiving one or more instructions to display at least one fantasy team attribute. In some embodiments, a display device 106 may receive one or more instructions to display at least one fantasy team attribute. Instructions to display numerous types of fantasy team attributes may be received. Examples of such fantasy team attributes include, but are not limited to, a fantasy team logo, a fantasy team sound, a fantasy team color, a fantasy team song, a fantasy team symbol, a fantasy team, and the like. In some embodiments, a display device 106 may receive one or more instructions that include the position in which one or more fantasy team attributes are to be displayed. For example, in some embodiments, a display device 106 may receive one or more instructions to have a fantasy team logo displayed on an image of a helmet worn by a player on a fantasy team that is part of broadcast content 116. Accordingly, in some embodiments, a display device 106 may be configured to utilize information associated with the position of an image that is broadcast to overlay non-broadcast information 114 (e.g., a fantasy team attribute) on the broadcast image in a position dependent manner. Positional information may be obtained through use of numerous methods and technologies. Examples of such methods and technologies include, but are not limited to, digital analysis (e.g., pixel analysis, optical character recognition), sensor networks, and the like. In some embodiments, a display device 106 may be configured to apply a grid to a displayed image of broadcast content 116 to assign coordinates to the displayed broadcast content 116 and then display non-broadcast information 114 (e.g., one or more fantasy team attributes) according to grid coordinates.

Operation 740 includes receiving one or more instructions to display the broadcast content 116 as an overlay display. In some embodiments, a display device 106 may receive one or more instructions to display broadcast content 116 as an overlay display. In some embodiments, a display device 106 may receive one or more instructions to display non-broadcast information 114 as an overlay on the broadcast content 116. For example, in some embodiments, a display device 106 may receive one or more instructions to display statistics associated with one or more players on a fantasy football team and/or statistics associated with a fantasy football team as an overlay on broadcast content 116 associated with a broadcast football game. In some embodiments, a display device 106 may receive one or more instructions that include the position in which information is to be displayed as an overlay on broadcast content 116. For example, in some embodiments, a display device 106 may receive one or more instructions to display a fantasy team logo on a displayed image of a soccer ball that is part of broadcast content 116. Accordingly, in some embodiments, a display device 106 may utilize information associated with the position of a displayed image that is broadcast (e.g., soccer ball) to overlay non-broadcast information 114 (e.g., a fantasy team logo) on the broadcast image in a position dependent manner.

Operation 750 includes displaying the at least one descriptor associated with the at least one of one or more players selected by the at least one participant 102. In some embodiments, a display device 106 displays at least one descriptor associated with at least one of one or more players selected by a participant 102. Numerous types of descriptors may be displayed. Examples of such descriptors include, but are not limited to, a player name, a player logo, a player color, a player song, a player sound, a player position on a fantasy team (e.g., wide receiver, quarterback, running back, forward, guard, etc.) and the like.

Operation 760 includes displaying the non-broadcast information 114 associated with the at least one of the one or more players selected by the at least one participant 102. In some embodiments, a display device 106 displays non-broadcast information 114 associated with at least one of one or more players selected by a participant 102. Numerous types of non-broadcast information 114 may be displayed. Examples of such non-broadcast information 114 include, but are not limited to, statistics associated with one or more players, statistics associated with one or more teams on which the one or more players are members, events associated with one or more players, events associated with one or more teams on which the one or more players are members, positional information associated with one or more players, and the like.

Operation 770 includes displaying at least one fantasy team attribute. In some embodiments, a display device 106 displays at least one fantasy team attribute. Numerous types of fantasy team attributes may be displayed. Examples of such fantasy team attributes include, but are not limited to, a fantasy team logo, a fantasy team sound, a fantasy team color, a fantasy team song, a fantasy team symbol, a fantasy team, and the like. In some embodiments, a display device 106 may display a fantasy team logo on a displayed image of a helmet worn by a player on a fantasy team that is part of broadcast content 116 (e.g., FIG. 13). Accordingly, in some embodiments, a display device 106 may utilize information associated with the position of a displayed image that is broadcast to overlay non-broadcast information 114 (e.g., a fantasy team attribute) on the broadcast image in a position dependent manner. Positional information may be obtained through use of numerous methods and technologies. Examples of such methods and technologies include, but are not limited to, digital analysis (e.g., pixel analysis, optical character recognition), sensor networks, and the like. In some embodiments, a display device 106 may be configured to apply a grid to a displayed image of broadcast content 116 to assign coordinates to the displayed broadcast content 116 and then display non-broadcast information 114 (e.g., one or more fantasy team attributes) according to grid coordinates.

Operation 780 includes displaying the broadcast content 116 as an overlay display. In some embodiments, a display device 106 displays broadcast content 116 as an overlay display. In some embodiments, a display device 106 may display non-broadcast information 114 as an overlay on broadcast content 116. For example, in some embodiments, a display device 106 may display statistics associated with one or more players on a fantasy football team and/or statistics associated with a fantasy football team as an overlay on broadcast content 116 associated with a broadcast football game. In some embodiments, a display device 106 may utilize positional information to display non-broadcast information 114 as an overlay on broadcast content 116. For example, in some embodiments, a display device 106 may display a fantasy team logo on a displayed image of a soccer ball that is part of broadcast content 116. Accordingly, in some embodiments, a display device 106 may utilize information associated with the position of a displayed image that is broadcast (e.g., soccer ball) to overlay non-broadcast information 114 (e.g., a fantasy team logo) on the broadcast image in a position dependent manner.

In some embodiments, operation 710 includes receiving one or more signals that include the one or more instructions to display the descriptor associated with the one or more players selected by the at least one participant 102. In some embodiments, a display device 106 may receive one or more signals that include one or more instructions to display a descriptor associated with one or more players selected by a participant 102. Examples of such signals include, but are not limited to, wireless signals, acoustic signals, optical signals, magnetic signals, digital signals, analog signals, encrypted signals, and the like. Examples of such descriptors include, but are not limited to, a player name, a player logo, a player color, a player song, a player sound, a player position on a fantasy team (e.g., wide receiver, quarterback, running back, forward, guard, etc.) and the like.

In some embodiments, operation 710 includes receiving one or more instructions to display a name associated with at least one of the one or more players selected by the at least one participant 102. In some embodiments, a display device 106 may receive one or more instructions to display a name associated with at least one of one or more players selected by the at least one participant 102. Numerous names may be associated with one or more players. In some embodiments, a name may be a real name associated with a player. In some embodiments, a name may be a nickname name associated with a player. In some embodiments, a name may be a participant provided name associated with a player. In some embodiments, a name may be a participant selected name associated with a player. In some embodiments, a name may be a name associated with a fantasy team on which the player is a member. In some embodiments, a name may be a name associated with a fantasy league in which the player is a member. Accordingly, numerous types of names may be associated with a player.

In some embodiments, operation 710 includes receiving one or more instructions to display a name associated with each of the one or more players selected by the at least one participant 102 to form the fantasy team. In some embodiments, a display device 106 may receive one or more instructions to display a name associated with each of one or more players selected by a participant 102 to form a fantasy team. For example, in some embodiments, instructions to display a roster of names associated with a fantasy team may be received (e.g., FIGS. 10, 12, and 13). In some embodiments, instructions to display rosters of names associated with one or more fantasy teams may be received (e.g., FIGS. 9-13). In some embodiments, instructions to display rosters of names associated with one or more fantasy teams that are associated with more than one participant 102 may be received (e.g., FIGS. 9-13).

In some embodiments, operation 710 includes receiving one or more instructions to display a participant 102 selected name associated with the fantasy team. In some embodiments, a display device 106 may receive one or more instructions to display a participant 102 selected name associated with a fantasy team. Instructions to display numerous types of participant 102 selected names may be received. Examples of such names include, but are not limited to, sharks, demons, dozers, bluegills, hawks, tigers, bears, and the like.

In some embodiments, operation 710 includes receiving one or more instructions to display a position on the fantasy team occupied by at least one of the one or more players selected by the at least one participant 102. In some embodiments, a display device 106 may receive one or more instructions to display a position on a fantasy team occupied by one or more players selected by a participant 102. Examples of a player position on a fantasy league include, but are not limited to, a wide receiver, a quarterback, a running back, a forward, a guard, a catcher, a pitcher, a goalie, and the like.

In some embodiments, operation 710 includes receiving one or more instructions to display a status associated with at least one of the one or more players selected by the at least one participant 102. In some embodiments, a display device 106 may receive one or more instructions to display a status associated with one or more players selected by a participant 102. Examples of such statuses include, but are not limited to, an injured status, a most valuable player status, a penalty status, a suspended status, and the like.

In some embodiments, operation 720 includes receiving one or more signals that include the one or more instructions to display the non-broadcast information 114 associated with the one or more players selected by the at least one participant 102. In some embodiments, a display device 106 may receive one or more signals that include one or more instructions to display non-broadcast information 114 associated with one or more players selected by a participant 102. Examples of such signals include, but are not limited to, wireless signals, acoustic signals, optical signals, magnetic signals, digital signals, analog signals, encrypted signals, and the like. Examples of such non-broadcast information 114 include, but are not limited to, statistics associated with a player and/or fantasy team on which the player is included, participant 102 selected attributes associated with a player and/or fantasy team on which the player is included, a status associated with a player and/or fantasy team on which the player is included, and the like.

In some embodiments, operation 720 includes receiving one or more instructions to display at least one statistic associated with at least one of the one or more players selected by the at least one participant 102. In some embodiments, a display device 106 may receive one or more instructions to display at least one statistic associated with one or more players selected by a participant 102. Instructions to display numerous types of statistics may be received. Examples of such statistics include, but are not limited to, player performance statistics (e.g., running yards, tackles, catches, pass completions, pass interceptions, goals, field goals completed, field goals failed, etc.), penalty statistics, (e.g., time in penalty box, number of penalties, penalties received, penalties caused, etc.), statistics related to injuries, statistics related to salary, personal statistics (e.g., number of children, age of children, number of marriages, etc.), and the like.

In some embodiments, operation 720 includes receiving one or more instructions to display at least one event associated with at least one of the one or more players selected by the at least one participant 102. In some embodiments, a display device 106 may receive one or more instructions to display an event associated with one or more players selected by a participant 102. In some embodiments, instruction to display an indicator of an event associated with a player may be received. In some embodiments, instructions to display an indicator next to a descriptor for a player may be received. For example, in some embodiments, a “TD” may be displayed next to the displayed name of a player who makes a touchdown in a football game. In some embodiments, an “FG” may be displayed next to the displayed name of a player who makes a field goal in a football game. In some embodiments, a “G” may be displayed next to the displayed name of a player who makes a goal in a soccer game. Accordingly, in some embodiments, instructions to display numerous types of indicators in response to numerous types of events associated with a player on a fantasy team may be received. Accordingly, in some embodiments, instructions to display numerous types of indicators in response to numerous types of events associated with a fantasy team on which a player is included may be received.

In some embodiments, operation 730 includes receiving one or more signals that include the one or more instructions to display the fantasy team attribute selected by the at least one participant 102. In some embodiments, a display device 106 may receive one or more signals that include one or more instructions to display a fantasy team attribute selected by a participant 102. Examples of such signals include, but are not limited to, wireless signals, acoustic signals, optical signals, magnetic signals, digital signals, analog signals, encrypted signals, and the like. Examples of such fantasy team attributes include, but are not limited to, a fantasy team logo, a fantasy team sound, a fantasy team color, a fantasy team song, a fantasy team symbol, a fantasy team, and the like. In some embodiments, instructions may include instructions associated with where on a display a fantasy team attribute is displayed. For example, in some embodiments, instruction may include instructions to display a fantasy team attribute as an overlay on a displayed image of a player that is included within a fantasy team (e.g., overlay an image of a star on a displayed image of a player's helmet) (e.g., FIG. 13).

In some embodiments, operation 730 includes receiving one or more instructions to display at least one participant 102 selected name associated with the at least one fantasy team. In some embodiments, a display device 106 may receive one or more instructions to display a participant selected name associated with a fantasy team. In some embodiments, one or more instructions to display a participant selected name for a fantasy team as an overlay on broadcast content 116 may be received. For example, in some embodiments, instructions to display a participant selected fantasy team name as an overlay on one or more displayed images of one or more players included within the participant's fantasy team may be received. Numerous names may be selected by a participant 102 for association with a fantasy team.

In some embodiments, operation 730 includes receiving one or more instructions to display at least one participant selected sound associated with the at least one fantasy team. In some embodiments, a display device 106 may receive one or more instructions to display a participant selected sound associated with a fantasy team. Instructions to display numerous types of sounds may be received. Examples of such sounds include, but are not limited to, a lion's roar, a jet engine sound, a cheering crowd, a fight song, and the like.

In some embodiments, operation 730 includes receiving one or more instructions to display at least one participant selected color associated with the at least one fantasy team. In some embodiments, a display device 106 may receive one or more instructions to display a participant selected color associated with a fantasy team. Instructions to display numerous colors and combinations of colors may be received. Examples of such colors and combinations of colors include, but are not limited to, green, blue, red, yellow, green and blue, red and white, purple and white, and the like.

In some embodiments, operation 730 includes receiving one or more instructions to display at least one participant selected symbol associated with the at least one fantasy team. In some embodiments, a display device 106 may receive one or more instructions to display at least one participant selected symbol associated with a fantasy team. Instructions to display numerous types of symbols may be received. Examples of such symbols include, but are not limited to, a lion, a tiger, a leopard, a bear, a star, a lightning bolt, and the like. In some embodiments, a participant selected symbol associated with a fantasy team may be displayed as an overlay on broadcast content 116. For example, in some embodiments, instructions to display a participant selected symbol as an overlay on one or more displayed images of one or more players included within the participant's fantasy team may be received.

In some embodiments, operation 740 includes receiving one or more signals that include the one or more instructions to display the broadcast content 116 as an overlay display. In some embodiments, a display device 106 may receive one or more signals that include one or more instructions to display broadcast content 116 as an overlay display. Examples of such signals include, but are not limited to, wireless signals, acoustic signals, optical signals, magnetic signals, digital signals, analog signals, encrypted signals, and the like. In some embodiments, instructions may include instruction to display numerous types of content and/or information as an overlay on broadcast content 116. In some embodiments, information may include non-broadcast information 114 (e.g., user provided information, statistics, etc.). In some embodiments, content may include participant provided content.

In some embodiments, operation 740 includes receiving one or more instructions to display the broadcast content 116 as an overlay display with a descriptor associated with the one or more players selected by the at least one participant 102 to form the at least one fantasy team. In some embodiments, a display device 106 may receive one or more instructions to display broadcast content 116 as an overlay display with a descriptor associated with one or more players selected by a participant 102 to form a fantasy team. In some embodiments, instructions may include instruction to display numerous types of descriptors as an overlay on broadcast content 116. Examples of such descriptors include, but are not limited to, a player name, a player logo, a player color, a player song, a player sound, a player position on a fantasy team (e.g., wide receiver, quarterback, running back, forward, guard, etc.) and the like. In some embodiments, instructions may include instructions associated with a position where one or more descriptors are to be displayed as an overlay on broadcast content 116. In some embodiments, a descriptor may be displayed as an overlay on a displayed image of a player that is included on a fantasy team. For example, in some embodiments, a position played by a player associated with a fantasy team may be displayed as an overlay on a displayed image of a player that is included on the fantasy team.

In some embodiments, operation 740 includes receiving one or more instructions to display the broadcast content 116 as an overlay display with a name associated with each of the one or more players selected by the at least one participant 102. In some embodiments, a display device 106 may receive one or more instructions to display broadcast content 116 as an overlay display with a name associated with each of one or more players selected by a participant 102. For example, in some embodiments, one or more names associated with one or more players included within a fantasy team may be displayed as an overlay on broadcast content 116. In some embodiments, a roster of names associated with players included within a fantasy team may be displayed as an overlay on broadcast content 116. In some embodiments, a name associated a player included within a fantasy team may be displayed as an overlay on a displayed image of the player.

In some embodiments, operation 740 includes receiving one or more instructions to display the broadcast content 116 as an overlay display with a name associated with each of the one or more players selected by the at least one participant, the non-broadcast information 114 associated with the one or more players, and the at least one fantasy team attribute. In some embodiments, a display device 106 may receive one or more instructions to display broadcast content 116 as an overlay display with a name associated with each of one or more players selected by a participant, the non-broadcast information 114 associated with one or more players, and at least one fantasy team attribute. For example, in some embodiments, one or more names associated with one or more players that that are included on one or more fantasy teams, one or more statistics associated with the one or more players and/or fantasy teams, and one or more fantasy team attributes associated with the one or more fantasy teams may be displayed as an overlay on broadcast content 116. Accordingly, numerous names, types of non-broadcast information 114, and numerous types of fantasy team attributes may be displayed as an overlay on broadcast content 116.

In some embodiments, operation 740 includes receiving one or more instructions to display the broadcast content 116 as an overlay display with at least one fantasy team attribute being associated with at least one of the one or more players selected by the at least one participant 102. In some embodiments, a display device 106 may receive one or more instructions to display broadcast content 116 as an overlay display with at least one fantasy team attribute being associated with at least one of one or more players selected by a participant 102. For example, in some embodiments, one or more fantasy team attributes may be displayed as an overlay on broadcast content 116 containing one or more displayed images of one or more players selected by a participant 102 for inclusion on their fantasy team. In some embodiments, one or more instructions to display a fantasy team logo as an overlay on one or more displayed images of one or more players selected by a participant 102 that are included within broadcast content 116 may be received. In some embodiments, one or more instructions to display a fantasy team color as an overlay on one or more displayed images of one or more players selected by a participant 102 that are included within broadcast content 116 may be received. In some embodiments, one or more instructions to display a fantasy team sound when one or more images of one or more players selected by a participant 102 are displayed within broadcast content 116 may be received.

In some embodiments, operation 740 includes receiving one or more instructions to display at least one fantasy team attribute selected by the at least one participant 102 mapped onto at least one displayed image of at least one player selected by the at least one participant 102 through use of positional information associated with the at least one player. In some embodiments, a display device 106 may receive one or more instructions to display at least one fantasy team attribute selected by a participant 102 mapped onto at least one displayed image of at least one player selected by a participant 102 through use of positional information associated with the at least one player. For example, in some embodiments, a display device 106 may receive one or more instructions to display a fantasy team logo (e.g., star) as an overlay on broadcast content 116 and mapped onto a displayed image of a helmet worn by a player selected by a participant 102 for inclusion on their fantasy team (e.g., FIG. 13). In some embodiments, an assembly module 108 may transmit one or more instructions to display team color (e.g., green) as an overlay on broadcast content 116 and mapped onto a displayed image of a uniform worn by a player selected by a participant 102 for inclusion on their fantasy team. Accordingly, a display device 106 may receive numerous instructions to display numerous types of fantasy team attributes that are to be mapped onto a displayed image of a player selected by a participant 102. In some embodiments, positional information may be obtained from a sensor network. The positional information may then be used to map one or more displayed fantasy team attributes onto broadcast content 116 in a position dependent manner. In some embodiments, positional information may be obtained through use of digital analysis (e.g., pixel analysis, optical character recognition, etc.) (see e.g., U.S. Pat. No. 8,102,405: TV Screen Text Capture; U.S. Pat. No. 8,683,031: Methods and systems for scanning and monitoring content on a network; U.S. Pat. No. 8,682,077: Method for omnidirectional processing of 2D images including recognizable characters; U.S. Pat. No. 7,689,613: OCR input to search engine; U.S. Pat. No. 7,506,356: Skimming continuous multimedia content; U.S. Published Patent Application Number 20100192178: Capture of stylized TV table data via OCR; U.S. Published Patent Application Number 20080226119: Content image search; Borse and Rangdale, Online and offline extraction of text from television program, International Journal of Advanced Research in Computer Science and Software Engineering, Vol. 4(1), January 2014). The positional information may then be used to map one or more displayed fantasy team attributes onto broadcast content 116 in a position dependent manner. In some embodiments, positional information may be used in combination with tracking analysis (e.g., pixel analysis, optical character recognition, etc.) (see e.g., Lei et al., An adaptive search window algorithm for player tracking in broadcast tennis videos, International Journal of Innovative Computing, Information and Control, 8:10(A), October 2012; Zhu et al., Player action recognition in broadcast tennis video with applications to semantic analysis of sports game, Proceedings of the 14^{th} annual ACM international conference on Multimedia, Pages 431-440, ACM, New York, USA, 2006; Choi and Seo, Tracking soccer ball in TV broadcast video, Image Analysis and Processing—ICIAP 2005, Lecture Notes in Computer Science, Vol. 3617, pp. 661-668, 2005; Zhang et al., Robust multi-object tracking via cross-domain contextual information for sports video analysis, In Acoustics, Speech and Signal Processing (ICASSP), 2012 IEEE International Conference on (pp. 985-988). IEEE, March, 2012). The positional information and the tracking information may be used in combination to map one or more displayed fantasy team attributes onto broadcast content 116 in a position dependent manner.

In some embodiments, operation 740 includes receiving one or more instructions to display at least one fantasy team name selected by the at least one participant 102 mapped onto at least one displayed image of at least one player selected by the at least one participant 102 through use of positional information associated with the at least one player. In some embodiments, a display device 106 may receive one or more instructions to display at least one fantasy team name selected by a participant 102 mapped onto at least one displayed image of at least one player selected by the participant 102 through use of positional information associated with at least one player. In some embodiments, instructions to display a fantasy team name as an overlay on one or more players selected by one participant 102 may be received. In some embodiments, instructions to display one or more fantasy team names as an overlay on one or more players selected by one or more participants 102 may be received. For example, in some embodiments, one or more instructions may be received to display a first name associated with a first fantasy team as an overlay onto displayed images of players included within the first fantasy team and to display a second name associated with a second fantasy team as an overlay onto displayed images of players included within the second fantasy team.

In some embodiments, operation 740 includes receiving one or more instructions to display at least one fantasy team color selected by the at least one participant 102 mapped onto at least one displayed image of at least one player selected by the at least one participant 102 through use of positional information associated with the at least one player. In some embodiments, a display device 106 may receive one or more instructions to display at least one fantasy team color selected by a participant 102 mapped onto at least one displayed image of a player selected by the participant 102 through use of positional information associated with the player. In some embodiments, instructions to display a fantasy team color as an overlay on one or more players selected by one participant 102 may be received. In some embodiments, instructions to display one or more fantasy team colors as an overlay on one or more players selected by one or more participants 102 may be received. For example, in some embodiments, one or more instructions may be received to display a first fantasy team color associated with a first fantasy team as an overlay onto displayed images of players included within the first fantasy team and to display a second fantasy team color associated with a second fantasy team as an overlay onto displayed images of players included within the second fantasy team.

In some embodiments, operation 740 includes receiving one or more instructions to display at least one fantasy team symbol selected by the at least one participant 102 mapped onto at least one displayed image of at least one player selected by the at least one participant 102 through use of positional information associated with the at least one player. In some embodiments, a display device 106 may receive one or more instructions to display at least one fantasy team symbol selected by a participant 102 mapped onto at least one displayed image of a player selected by the participant 102 through use of positional information associated with the player. In some embodiments, instructions to display a fantasy team symbol as an overlay on one or more players selected by one participant 102 may be received. In some embodiments, instructions to display one or more fantasy team symbols as an overlay on one or more players selected by one or more participants 102 may be received. For example, in some embodiments, one or more instructions may be received to display a first fantasy team symbol associated with a first fantasy team as an overlay on displayed images of players included within the first fantasy team and to display a second fantasy team symbol associated with a second fantasy team as an overlay on displayed images of players included within the second fantasy team.

In some embodiments, operation 750 includes displaying a name associated with at least one of the one or more players selected by the at least one participant 102. In some embodiments, a display device 106 displays a name associated with one or more players selected by a participant 102. Numerous names may be displayed that are associated with one or more players. In some embodiments, a name may be a real name associated with a player. In some embodiments, a name may be a nickname name associated with a player. In some embodiments, a name may be a participant 102 provided name associated with a player. In some embodiments, a name may be a participant 102 selected name associated with a player. In some embodiments, a name may be a name associated with a fantasy team on which the player is a member. In some embodiments, a name may be a name associated with a fantasy league in which the player is a member. Accordingly, numerous types of names may be displayed.

In some embodiments, operation 750 includes displaying a name associated with each of the one or more players selected by the at least one participant 102 to form the fantasy team. In some embodiments, a display device 106 displays a name associated with each of one or more players selected by a participant 102 to form a fantasy team. For example, in some embodiments, a display device 106 may display a roster of names associated with a fantasy team (e.g., FIGS. 10, 12, and 13). In some embodiments, a display device 106 may display rosters of names associated with one or more fantasy teams (e.g., FIGS. 9-13). In some embodiments, a display device 106 may display rosters of names associated with one or more fantasy teams that are associated with more than one participant 102 (e.g., FIGS. 9-13).

In some embodiments, operation 750 includes displaying a participant selected name associated with the fantasy team. In some embodiments, a display device 106 displays a participant selected name associated with a fantasy team. A display device 106 may display numerous types of participant selected names. Examples of such names include, but are not limited to, sharks, demons, dozers, bluegills, hawks, tigers, bears, and the like.

In some embodiments, operation 750 includes displaying a position on the fantasy team occupied by at least one of the one or more players selected by the at least one participant 102. In some embodiments, a display device 106 displays a position on a fantasy team occupied by at least one of one or more players selected by the participant 102. Examples of a player position on a fantasy league include, but are not limited to, a wide receiver, a quarterback, a running back, a forward, a guard, a catcher, a pitcher, a goalie, and the like.

In some embodiments, operation 750 includes displaying a status associated with at least one of the one or more players selected by the at least one participant 102. In some embodiments, a display device 106 displays a status associated with at least one of one or more players selected by a participant 102. Examples of such statuses include, but are not limited to, an injured status, a most valuable player status, a penalty status, a suspended status, and the like.

In some embodiments, operation 760 includes displaying at least one statistic associated with at least one of the one or more players selected by the at least one participant 102. In some embodiments, a display device 106 displays a statistic associated with one or more players selected by a participant 102. Examples of such statistics include, but are not limited to, player performance statistics (e.g., running yards, tackles, catches, pass completions, pass interceptions, goals, field goals completed, field goals failed, etc.), penalty statistics, (e.g., time in penalty box, number of penalties, penalties received, penalties caused, etc.), statistics related to injuries, statistics related to salary, personal statistics (e.g., number of children, age of children, number of marriages, etc.), and the like.

In some embodiments, operation 760 includes displaying at least one event associated with at least one of the one or more players selected by the at least one participant 102. In some embodiments, a display device 106 displays an event associated with one or more players selected by a participant 102. In some embodiments, a display device 106 may display an indicator of an event associated with a player. In some embodiments, a display device 106 may display an indicator next to a descriptor for a player. For example, in some embodiments, a “TD” may be displayed next to the displayed name of a player who makes a touchdown in a football game. In some embodiments, an “FG” may be displayed next to the displayed name of a player who makes a field goal in a football game. In some embodiments, a “G” may be displayed next to the displayed name of a player who makes a goal in a soccer game. Accordingly, in some embodiments, a display device 106 may display numerous types of indicators in response to numerous types of events associated with a player on a fantasy team.

In some embodiments, operation 770 includes displaying the fantasy team attribute selected by the at least one participant 102. In some embodiments, a display device 106 may display a fantasy team attribute selected by a participant 102. Examples of such fantasy team attributes include, but are not limited to, a fantasy team logo, a fantasy team sound, a fantasy team color, a fantasy team song, a fantasy team symbol, a fantasy team, and the like. In some embodiments, a display device 106 may display a fantasy team attribute as an overlay on a displayed image of a player that is included within a fantasy team (e.g., overlay an image of a star on a displayed image of a player's helmet) (e.g., FIG. 13).

In some embodiments, operation 770 includes displaying at least one participant selected name associated with the at least one fantasy team. In some embodiments, a display device 106 displays a participant selected name associated with a fantasy team. In some embodiments, a display device 106 may display a participant selected name for a fantasy team as an overlay on broadcast content 116. For example, in some embodiments, a display device 106 may display a participant selected fantasy team name as an overlay on one or more displayed images of one or more players included within the participant's fantasy team. Numerous names may be displayed that are selected by a participant 102 for association with a fantasy team.

In some embodiments, operation 770 includes displaying at least one participant selected sound associated with the at least one fantasy team. In some embodiments, a display device 106 displays a participant selected sound associated with a fantasy team. Numerous types of sounds may be displayed. Examples of such sounds include, but are not limited to, a lion's roar, a jet engine sound, a cheering crowd, a fight song, and the like.

In some embodiments, operation 770 includes displaying at least one participant selected color associated with the at least one fantasy team. In some embodiments, a display device 106 displays a participant selected color associated with a fantasy team. Numerous colors and combinations of colors may be displayed. Examples of such colors and combinations of colors include, but are not limited to, green, blue, red, yellow, green and blue, red and white, purple and white, and the like.

In some embodiments, operation 770 includes displaying at least one participant selected symbol associated with the at least one fantasy team. In some embodiments, a display device 106 displays a participant selected symbol associated with a fantasy team. Numerous types of symbols may be displayed. Examples of such symbols include, but are not limited to, a lion, a tiger, a leopard, a bear, a star, a lightning bolt, and the like. In some embodiments, a participant selected symbol associated with a fantasy team may be displayed as an overlay on broadcast content 116. For example, in some embodiments, a display device 106 may display a participant selected symbol as an overlay on one or more displayed images of one or more players included within the participant's fantasy team.

In some embodiments, operation 780 includes displaying the broadcast content 116 as an overlay display with a descriptor associated with the one or more players selected by the at least one participant 102 to form the at least one fantasy team. In some embodiments, a display device 106 displays broadcast content 116 as an overlay display with a descriptor associated with one or more players selected by a participant 102 to form a fantasy team. In some embodiments, a display device 106 may display numerous types of descriptors as an overlay on broadcast content 116. Examples of such descriptors include, but are not limited to, a player name, a player team logo, a player team color, a player team song, a player team sound, a player position on a fantasy team (e.g., wide receiver, quarterback, running back, forward, guard, etc.) and the like. In some embodiments, a display device 106 may display a descriptor as an overlay on a displayed image of a player that is included on a fantasy team. For example, in some embodiments, a team logo associated with a fantasy team may be displayed as an overlay on a displayed image of a player that is included on the fantasy team.

In some embodiments, operation 780 includes displaying the broadcast content 116 as an overlay display with a name associated with each of the one or more players selected by the at least one participant 102. In some embodiments, a display device 106 displays broadcast content 116 as an overlay display with a name associated with each of one or more players selected by a participant 102. For example, in some embodiments, a display device 106 may display one or more names associated with one or more players included within a fantasy team as an overlay on broadcast content 116. In some embodiments, a display device 106 may display a roster of names associated with players included within a fantasy team as an overlay on broadcast content 116. In some embodiments, a display device 106 may display a name associated a player included within a fantasy team as an overlay on a displayed image of the player.

In some embodiments, operation 780 includes displaying the broadcast content 116 as an overlay display with a name associated with each of the one or more players selected by the at least one participant, the non-broadcast information 114 associated with the one or more players, and the at least one fantasy team attribute. In some embodiments, a display device 106 displays broadcast content 116 as an overlay display with a name associated with each of one or more players selected by a participant, non-broadcast information 114 associated with one or more players, and a fantasy team attribute. For example, in some embodiments, a display device 106 may display one or more names associated with one or more players that that are included on one or more fantasy teams, one or more statistics associated with the one or more players and/or fantasy teams, and one or more fantasy team attributes associated with the one or more fantasy teams as an overlay on broadcast content 116. Accordingly, a display device 106 may display numerous names, types of non-broadcast content 116, and numerous types of fantasy team attributes as an overlay on broadcast content 116.

In some embodiments, operation 780 includes displaying the broadcast content 116 as an overlay display with at least one fantasy team attribute being associated with at least one of the one or more players selected by the at least one participant 102. In some embodiments, a display device 106 displays broadcast content 116 as an overlay display with a fantasy team attribute being associated with one or more players selected by a participant 102. For example, in some embodiments, a display device 106 may display one or more fantasy team attributes as an overlay on broadcast content 116 containing one or more displayed images of one or more players selected by a participant 102 for inclusion on their fantasy team. In some embodiments, a display device 106 may display a fantasy team logo as an overlay on one or more displayed images of one or more players selected by a participant 102 that are included within broadcast content 116. In some embodiments, a display device 106 may display a fantasy team color as an overlay on one or more displayed images of one or more players selected by a participant 102 that are included within broadcast content 116. In some embodiments, a display device 106 may display a fantasy team sound when one or more images of one or more players selected by a participant 102 are displayed within broadcast content 116.

In some embodiments, operation 780 includes displaying at least one fantasy team attribute selected by the at least one participant 102 mapped onto at least one displayed image of at least one player selected by the at least one participant 102 through use of positional information associated with the at least one player. In some embodiments, a display device 106 displays at least one fantasy team attribute selected by a participant 102 mapped onto at least one displayed image of a player selected by the participant 102 through use of positional information associated with the player. For example, in some embodiments, a display device 106 may display a fantasy team logo (e.g., star) as an overlay on broadcast content 116 and mapped onto a displayed image of a helmet worn by a player selected by a participant 102 for inclusion on their fantasy team (e.g., FIG. 13). In some embodiments, a display device 106 may display one or more team colors (e.g., green) as an overlay on broadcast content 116 and mapped onto a displayed image of a uniform worn by a player selected by a participant 102 for inclusion on their fantasy team. Accordingly, a display device 106 may display numerous types of fantasy team attributes that are to be mapped onto a displayed image of a player selected by a participant 102. In some embodiments, positional information may be obtained from a sensor network. The positional information may then be used to map one or more displayed fantasy team attributes onto broadcast content 116 in a position dependent manner. In some embodiments, positional information may be obtained through use of digital analysis (e.g., pixel analysis, optical character recognition, etc.) (see e.g., U.S. Pat. No. 8,102,405: TV Screen Text Capture; U.S. Pat. No. 8,683,031: Methods and systems for scanning and monitoring content on a network; U.S. Pat. No. 8,682,077: Method for omnidirectional processing of 2D images including recognizable characters; U.S. Pat. No. 7,689,613: OCR input to search engine; U.S. Pat. No. 7,506,356: Skimming continuous multimedia content; U.S. Published Patent Application Number 20100192178: Capture of stylized TV table data via OCR; U.S. Published Patent Application Number 20080226119: Content image search; Borse and Rangdale, Online and offline extraction of text from television program, International Journal of Advanced Research in Computer Science and Software Engineering, Vol. 4(1), January 2014). The positional information may then be used to map one or more displayed fantasy team attributes onto broadcast content 116 in a position dependent manner. In some embodiments, positional information may be used in combination with tracking analysis (e.g., pixel analysis, optical character recognition, etc.) (see e.g., Lei et al., An adaptive search window algorithm for player tracking in broadcast tennis videos, International Journal of Innovative Computing, Information and Control, 8:10(A), October 2012; Zhu et al., Player action recognition in broadcast tennis video with applications to semantic analysis of sports game, Proceedings of the 14^{th} annual ACM international conference on Multimedia, Pages 431-440, ACM, New York, USA, 2006; Choi and Seo, Tracking soccer ball in TV broadcast video, Image Analysis and Processing—ICIAP 2005, Lecture Notes in Computer Science, Vol. 3617, pp. 661-668, 2005; Zhang et al., Robust multi-object tracking via cross-domain contextual information for sports video analysis, In Acoustics, Speech and Signal Processing (ICASSP), 2012 IEEE International Conference on (pp. 985-988). IEEE, March, 2012). The positional information and the tracking information may be used in combination to map one or more displayed fantasy team attributes onto broadcast content 116 in a position dependent manner.

In some embodiments, operation 780 includes displaying at least one fantasy team name selected by the at least one participant 102 mapped onto at least one displayed image of at least one player selected by the at least one participant 102 through use of positional information associated with the at least one player. In some embodiments, a display device 106 may display a fantasy team name selected by a participant 102 mapped onto a displayed image of a player selected by the participant 102 through use of positional information associated with the player. In some embodiments, a display device 106 may display a fantasy team name as an overlay on one or more players selected by one participant 102. In some embodiments, a display device 106 may display one or more fantasy team names as an overlay on one or more players selected by one or more participants 102. For example, in some embodiments, a display device 106 may display a first name associated with a first fantasy team as an overlay onto displayed images of players included within the first fantasy team and the display device 106 may display a second name associated with a second fantasy team as an overlay onto displayed images of players included within the second fantasy team.

In some embodiments, operation 780 includes displaying at least one fantasy team color selected by the at least one participant 102 mapped onto at least one displayed image of at least one player selected by the at least one participant 102 through use of positional information associated with the at least one player. In some embodiments, a display device 106 displays a fantasy team color selected by a participant 102 mapped onto at least one displayed image of one or more players selected by the participant 102 through use of positional information associated with the one or more players. In some embodiments, a display device 106 may display a fantasy team color as an overlay on one or more players selected by one participant 102. In some embodiments, a display device 106 may display one or more fantasy team colors as an overlay on one or more players selected by one or more participants 102. For example, in some embodiments, a display device 106 may display a first fantasy team color associated with a first fantasy team as an overlay onto displayed images of players included within the first fantasy team and the display device 106 may display a second fantasy team color associated with a second fantasy team as an overlay onto displayed images of players included within the second fantasy team.

In some embodiments, operation 780 includes displaying at least one fantasy team symbol selected by the at least one participant 102 mapped onto at least one displayed image of at least one player selected by the at least one participant 102 through use of positional information associated with the at least one player. In some embodiments, a display device 106 displays a fantasy team symbol selected by a participant 102 mapped onto a displayed image of one or more players selected by the participant 102 through use of positional information associated with the one or more players. In some embodiments, a display device 106 may display a fantasy team symbol as an overlay on one or more players selected by one participant 102. In some embodiments, a display device 106 may display one or more fantasy team symbols as an overlay on one or more players selected by one or more participants 102. For example, in some embodiments, a display device 106 may display a first fantasy team symbol associated with a first fantasy team as an overlay on displayed images of players included within the first fantasy team and the display device 106 may display a second fantasy team symbol associated with a second fantasy team as an overlay on displayed images of players included within the second fantasy team.

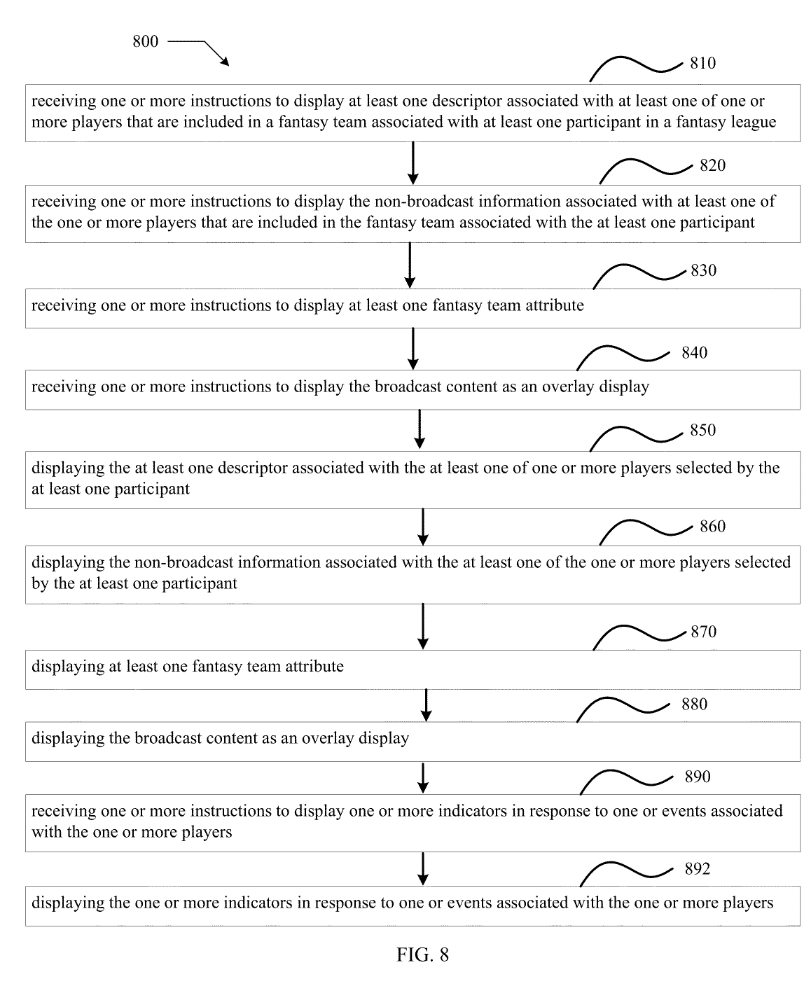

FIG. 8 illustrates an operational flow 800 representing examples of operations that are related to the performance of a method for receiving and transmitting information. In FIG. 8 and in following description that includes various examples of operations used during performance of the method, discussion and explanation may be provided with respect to the above-described example of FIG. 8, and/or with respect to other examples and contexts. However, it should be understood that the operations may be executed in a number of other environments and contexts, and/or modified versions of FIG. 8. Also, although the various operations are presented in the sequence(s) illustrated, it should be understood that the various operations may be performed in other orders than those which are illustrated, or may be performed concurrently. In some embodiments, the operations that are illustrated in FIG. 8 may be carried out in the context of system 100 as illustrated in FIG. 1. In some embodiments, operations 810, 820, 830, 840, 850, 860, 870, and 880 as illustrated in FIG. 8, correspond to operations 710, 720, 730, 740, 750, 760, 770, and 780 as illustrated and described with respect to FIG. 7.

Operation 890 includes receiving one or more instructions to display one or more indicators in response to one or events associated with the one or more players. In some embodiments, a display device 106 receives one or more instructions to display one or more indicators in response to one or events associated with one or more players. In some embodiments, indicators may be provided by a participant 102. For example, in some embodiments, a participant 102 may provide a digital image for use as an indicator. Accordingly, numerous indicators may be selected and/or provided by a participant 102. In some embodiments, an indicator may be a visual indicator. Examples of such visual indicators include, but are not limited to, colors, pictures (e.g., starburst picture), symbols (e.g., Greek symbol, no symbol, yes symbol, check mark symbol, denied symbol, etc.), logos, cartoons (e.g., cartoon thumbs up, cartoon thumbs down), and the like. In some embodiments, an indicator may be an audio indicator. Examples of such audio indicators include, but are not limited to, songs (e.g., team fight song, theme song), cheers, jeers, crying, jet engine sounds, crashing sounds, fireworks, and the like. Indicators may be displayed in response to numerous types of events. Examples of such events include, but are not limited to, a touchdown, a field goal, a goal, a penalty, a catch, a completed pass, a tackle, and the like. In some embodiments, a specific indicator may be displayed in response to a specific event. For example, in some embodiments, a cheering sound may be displayed when a player on a participant's fantasy football team makes a touchdown. In some embodiments, a star burst picture may be displayed when a player on a participant's fantasy football team makes a touchdown. In some embodiments, a booing sound may be displayed when a participant's fantasy football team receives a penalty. Accordingly, numerous types of indicators may be displayed in response to numerous types of events.

Operation 892 includes displaying the one or more indicators in response to one or events associated with the one or more players. In some embodiments, a display device 106 displays one or more indicators in response to one or events associated with one or more players. A display device 106 may display numerous types of indicators. In some embodiments, an indicator may be a visual indicator. Examples of such visual indicators include, but are not limited to, colors, pictures (e.g., starburst picture), symbols (e.g., Greek symbol, no symbol, yes symbol, check mark symbol, denied symbol, etc.), logos, cartoons (e.g., cartoon thumbs up, cartoon thumbs down), and the like. In some embodiments, an indicator may be an audio indicator. Examples of such audio indicators include, but are not limited to, songs (e.g., team fight song, theme song), cheers, jeers, crying, jet engine sounds, crashing sounds, fireworks, and the like. A display device 106 may display one or more indicators in response to numerous types of events. Examples of such events include, but are not limited to, a touchdown, a field goal, a goal, a penalty, a catch, a completed pass, a tackle, and the like. In some embodiments, a display device 106 may display a specific indicator in response to a specific event. For example, in some embodiments, a display device 106 may display a cheering sound when a player on a participant's fantasy football team makes a touchdown. In some embodiments, a display device 106 may display a star burst picture when a player on a participant's fantasy football team makes a touchdown. In some embodiments, a display device 106 may display a booing sound when a participant's fantasy football team receives a penalty. Accordingly, a display device 106 may display numerous types of indicators in response to numerous types of events.

In some embodiments, operation 890 includes receiving one or more signals that include the one or more instructions to display the one or more preselected indicators in response to the one or more preselected events associated with the one or more players selected by the at least one participant 102. In some embodiments, a display device 106 receives one or more signals that include one or more instructions to display one or more preselected indicators in response to one or more preselected events associated with one or more players selected by a participant 102. Numerous types of signals may be received. Examples of such signals include, but are not limited to, wireless signals, acoustic signals, optical signals, magnetic signals, digital signals, analog signals, encrypted signals, and the like.

In some embodiments, operation 890 includes receiving one or more instructions to display one or more indicators in response to one or events associated with a positive event. In some embodiments, a display device 106 may receive one or more instructions to display one or more indicators in response to one or events associated with a positive event. An indicator may be displayed in response to numerous types of positive events. Examples of positive events include, but are not limited to, a touchdown made by a participant's fantasy team, a touchdown made by a player on a participant's fantasy team, a goal made by a participant's fantasy team, a goal made by a player on a participant's fantasy team, a tackle made by a participant's fantasy team, a tackle made by a player on a participant's fantasy team, and the like.

In some embodiments, operation 890 includes receiving one or more instructions to display one or more indicators in response to one or positive events selected from at least one or a touchdown, a field goal, a safety, a goal, a tackle, a checkered flag, a win, or a hole-in-one. In some embodiments, a display device 106 may receive one or more instructions to display one or more indicators in response to one or positive events selected from at least one or a touchdown, a field goal, a safety, a goal, a tackle, a checkered flag, a win, or a hole-in-one.

In some embodiments, operation 890 includes receiving one or more instructions to display one or more indicators in response to one or events associated with a negative event. In some embodiments, a display device 106 may receive one or more instructions to display one or more indicators in response to one or events associated with a negative event. An indicator may be displayed in response to numerous types of negative events. Examples of negative events include, but are not limited to, a player on a participant's fantasy team being tackled, a participant's fantasy team being given a penalty, a participant's fantasy racing team being involved in a crash, and the like.

In some embodiments, operation 890 includes receiving one or more instructions to display one or more indicators in response to one or negative events selected from at least one of a penalty, a fumble, a tackle, an interception, a crash, a goal, or a loss. In some embodiments, a display device 106 may receive one or more instructions to display one or more indicators in response to one or negative events selected from at least one of a penalty, a fumble, a tackle, an interception, a crash, a goal, or a loss.

In some embodiments, operation 892 includes displaying the one or more indicators in response to the one or events associated with the one or more players selected by the at least one participant 102. In some embodiments, a display device 106 displays one or more indicators in response to one or events associated with one or more players selected by a participant 102. A display device 106 may display numerous types of indicators. In some embodiments, an indicator may be a visual indicator. Examples of such visual indicators include, but are not limited to, colors, pictures (e.g., starburst picture), symbols (e.g., Greek symbol, no symbol, yes symbol, check mark symbol, denied symbol, etc.), logos, cartoons (e.g., cartoon thumbs up, cartoon thumbs down), and the like. In some embodiments, an indicator may be an audio indicator. Examples of such audio indicators include, but are not limited to, songs (e.g., team fight song, theme song), cheers, jeers, crying, jet engine sounds, crashing sounds, fireworks, and the like. A display device 106 may display one or more indicators in response to numerous types of events. Examples of such events include, but are not limited to, a touchdown, a field goal, a goal, a penalty, a catch, a completed pass, a tackle, and the like. In some embodiments, a display device 106 may display a specific indicator in response to a specific event. For example, in some embodiments, a display device 106 may display a cheering sound when a player on a participant's fantasy football team makes a touchdown. In some embodiments, a display device 106 may display a star burst picture when a player on a participant's fantasy football team makes a touchdown. In some embodiments, a display device 106 may display a booing sound when a participant's fantasy football team receives a penalty. Accordingly, a display device 106 may display numerous types of indicators in response to numerous types of events.

In some embodiments, operation 892 includes displaying one or more indicators in response to one or events associated with a positive event. In some embodiments, a display device 106 displays one or more indicators in response to one or events associated with a positive event. A display device 106 may display an indicator in response to numerous types of positive events. Examples of positive events include, but are not limited to, a touchdown made by a participant's fantasy team, a touchdown made by a player on a participant's fantasy team, a goal made by a participant's fantasy team, a goal made by a player on a participant's fantasy team, a tackle made by a participant's fantasy team, a tackle made by a player on a participant's fantasy team, and the like.

In some embodiments, operation 892 includes displaying one or more indicators in response to one or positive events selected from at least one or a touchdown, a field goal, a safety, a goal, a tackle, a checkered flag, a win, or a hole-in-one. In some embodiments, a display device 106 displays one or more indicators in response to one or positive events selected from at least one or a touchdown, a field goal, a safety, a goal, a tackle, a checkered flag, a win, or a hole-in-one.

In some embodiments, operation 892 includes displaying one or more indicators in response to one or events associated with a negative event. In some embodiments, a display device 106 displays one or more indicators in response to one or events associated with a negative event. A display device 106 may display an indicator in response to numerous types of negative events. Examples of negative events include, but are not limited to, a player on a participant's fantasy team being tackled, a participant's fantasy team being given a penalty, a participant's fantasy racing team being involved in a crash, and the like.

In some embodiments, operation 892 includes displaying one or more indicators in response to one or negative events selected from at least one of a penalty, a fumble, a tackle, an interception, a crash, a goal, or a loss. In some embodiments, a display device 106 displays one or more indicators in response to one or negative events selected from at least one of a penalty, a fumble, a tackle, an interception, a crash, a goal, or a loss.

FIG. 9 illustrates an embodiment of a display device 900 that includes a portion 902 on which broadcast content 904 is displayed and a portion 906 on which non-broadcast information (908 and 910) is displayed as an overlay display. The portion 902 of the display device 106 900 on which broadcast content is being displayed shows a picture of a football player that is part of the broadcast content 904. The portion 906 of the display device 900 on which non-broadcast information (908 and 910) is being displayed shows fantasy team names 908 and fantasy team statistics 910 that are being displayed as an overlay on the broadcast content 904. In some embodiments, the fantasy team names 908 may be participant 102 selected. In some embodiments, the fantasy team names 908 may be participant 102 provided. In some embodiments, the fantasy team names 908 may be associated with one or more participant 102 selected fantast teams. For example, in some embodiments, fantasy team 1 may be associated with a first participant 102 in a fantasy league and fantasy team 2 may be associated with a second participant 102 in a fantasy league. Accordingly, in some embodiments, multiple fantasy team names and statistics may be displayed that are associated with multiple participants 102 in a fantasy league. In some embodiments, fantasy team statistics 910 may be updated as non-broadcast information is retrieved and displayed.

FIG. 10 illustrates an embodiment of a display device 1000 that includes a portion 1002 on which broadcast content 1004 is displayed and a portion 1006 on which non-broadcast information (1008, 1010, and 1012) is displayed as an overlay display. The portion 1002 of the display device 1000 on which broadcast content 1004 is being displayed shows a picture of a football player that is part of the broadcast content 1004. The portion 1006 of the display device 1000 on which non-broadcast information (1008, 1010, and 1012) is being displayed shows fantasy team names 1008, statistics for players 1010 on the fantasy teams and fantasy team statistics 1012 that are being displayed as an overlay on the broadcast content 1004. In some embodiments, the fantasy team names 1008 may be participant 102 selected. In some embodiments, the fantasy team names 1008 may be participant 102 provided. In some embodiments, the fantasy team names 1008 may be associated with one or more participant 102 selected fantast teams. For example, in some embodiments, fantasy team 1 may be associated with a first participant 102 in a fantasy league and fantasy team 2 may be associated with a second participant 102 in a fantasy league. Accordingly, in some embodiments, multiple fantasy team names and statistics may be displayed that are associated with multiple participants 102 in a fantasy league. In some embodiments, statistics for players 1010 on the fantasy teams and fantasy team statistics 1012 may be updated as non-broadcast information is retrieved and displayed.

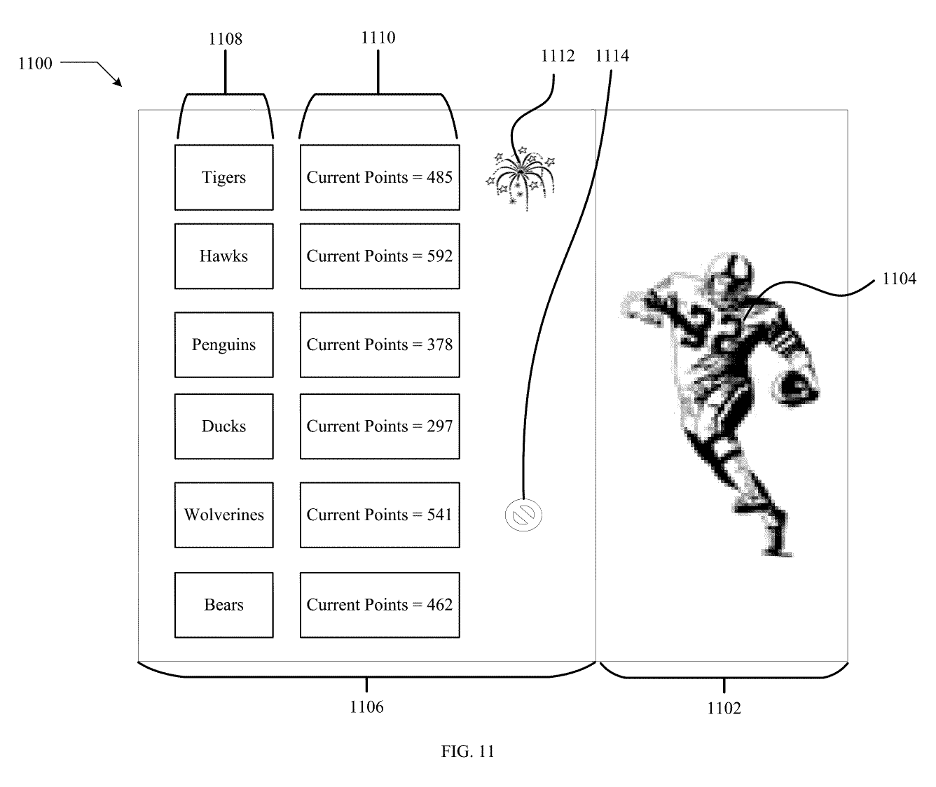

FIG. 11 illustrates an embodiment of a display device 1100 that includes a portion 1102 on which broadcast content 1104 is displayed and a portion 1106 on which non-broadcast information (1108, 1110, 1112, and 1114) is displayed as an overlay display. The portion 1102 of the display device 1100 on which broadcast content 1104 is being displayed shows a picture of a football player that is part of the broadcast content 1104. The portion 1106 of the display device 1100 on which non-broadcast information (1108, 1110, 1112, and 1114) is being displayed shows fantasy team names 1108, fantasy team statistics 1110, an indicator of a positive event 1112 associated with a fantasy team (e.g., a displayed starburst picture), and an indicator of a negative event 1114 associated with a fantasy team (e.g., a no symbol) that are being displayed as an overlay on the broadcast content 1104. In some embodiments, the fantasy team names 1108 may be participant 102 selected. In some embodiments, the fantasy team names 1108 may be participant 102 provided. In some embodiments, the fantasy team names 1108 may be associated with one or more participant 102 selected fantast teams. For example, in some embodiments, the Tigers fantasy team may be associated with a first participant 102 in a fantasy league and the Hawks fantasy team may be associated with a second participant 102 in a fantasy league. Accordingly, in some embodiments, multiple fantasy team names and statistics may be displayed that are associated with multiple participants 102 in a fantasy league. In some embodiments, fantasy team statistics 1110 and indicators of a positive event 1112 and indicators of a negative event 1114 may be updated as non-broadcast information is retrieved and displayed.

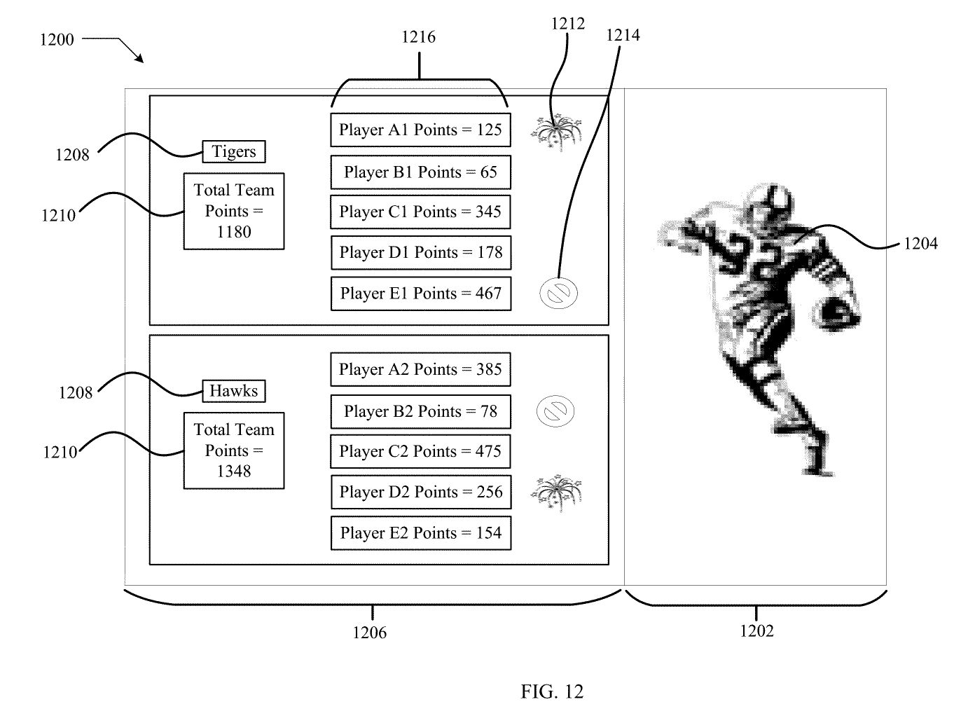

FIG. 12 illustrates an embodiment of a display device 1200 that includes a portion 1202 on which broadcast content 1204 is displayed and a portion 1206 on which non-broadcast information (1208, 1210, 1212, 1214, and 1216) is displayed as an overlay display. The portion 1202 of the display device 1200 on which broadcast content 1204 is being displayed shows a picture of a football player that is part of the broadcast content 1204. The portion 1206 of the display device 1200 on which non-broadcast information (1208, 1210, 1212, 1214, and 1216) is being displayed shows fantasy team names 1208, fantasy team statistics 1210, statistics associated with players on the fantasy teams 1216, an indicator of a positive event 1212 associated with a player on a fantasy team (e.g., a displayed starburst picture), and an indicator of a negative event 1214 associated with a player on a fantasy team (e.g., a no symbol) that are being displayed as an overlay on the broadcast content 1204. In some embodiments, the fantasy team names 1208 may be participant 102 selected. In some embodiments, the fantasy team names 1208 may be participant 102 provided. In some embodiments, the fantasy team names 1208 may be associated with one or more participant 102 selected fantast teams. For example, in some embodiments, the Tigers fantasy team may be associated with a first participant 102 in a fantasy league and the Hawks fantasy team may be associated with a second participant 102 in a fantasy league. Accordingly, in some embodiments, multiple fantasy team names and statistics may be displayed that are associated with multiple participants 102 in a fantasy league. In some embodiments, fantasy team statistics 1210, statistics associated with players on the fantasy teams 1216, indicators of a positive event 1112 and indicators of a negative event 1114 may be updated as non-broadcast information is retrieved and displayed.

FIG. 13 illustrates an embodiment of a display device 1300 that includes a portion 1302 on which broadcast content 1304 is displayed and a portion 1306 on which non-broadcast information (1308, 1310, 1312, 1314, 1316, and 1318) is displayed as an overlay display. The portion 1302 of the display device 1300 on which broadcast content 1304 is being displayed shows a picture of a football player that is part of the broadcast content 1304. The portion 1306 of the display device 1300 on which non-broadcast information (1308, 1310, 1312, 1314, 1316, and 1318) is being displayed shows fantasy team names 1308 (e.g., lightning bolts and stars), fantasy team statistics 1310, statistics associated with players on the fantasy teams 1316, an indicator of a positive event 1312 associated with a player on a fantasy team (e.g., a displayed starburst picture), an indicator of a negative event 1314 associated with a player on a fantasy team (e.g., a no symbol), and fantasy team attributes 1318 (e.g., star symbol and lightning bolt symbol) that are being displayed as an overlay on the broadcast content 1304. Also shown is a fantasy team attribute 1320 (e.g., star) that is displayed as an overlay on a displayed image of a helmet worn by a football player that is broadcast content 1304. In some embodiments, the fantasy team names 1308 may be participant 102 selected. In some embodiments, the fantasy team names 1308 may be participant 102 provided. In some embodiments, the fantasy team names 1308 may be associated with one or more participant 102 selected fantast teams. For example, in some embodiments, the Lightning Bolts fantasy team may be associated with a first participant 102 in a fantasy league and the Stars fantasy team may be associated with a second participant 102 in a fantasy league. Accordingly, in some embodiments, multiple fantasy team names and statistics may be displayed that are associated with multiple participants 102 in a fantasy league. In some embodiments, fantasy team statistics 1310, statistics associated with players on the fantasy teams 1316, indicators of a positive event 1312 and indicators of a negative event 1314 may be updated as non-broadcast information is retrieved and displayed. In some embodiments, fantasy team attributes (1318 and 1320) may be participant 102 selected. In some embodiments, fantasy team attributes (1318 and 1320) may be participant 102 provided. In some embodiments, fantasy team attributes (1318 and 1320) may be associated with one or more participant 102 selected fantasy teams. For example, in some embodiments, the Lightning Bolt team attribute (e.g., lightning bolt symbol) may be associated with a first participant 102 in a fantasy league and the Stars team attribute (e.g., star symbol) may be associated with a second participant 102 in a fantasy league. Accordingly, in some embodiments, multiple fantasy team attributes may be displayed that are associated with multiple participants 102 in a fantasy league.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as operational flow charts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

All publications, patents and patent applications cited herein are incorporated herein by reference. The foregoing specification has been described in relation to certain embodiments thereof, and many details have been set forth for purposes of illustration, however, it will be apparent to those skilled in the art that the invention is susceptible to additional embodiments and that certain of the details described herein may be varied considerably without departing from the basic principles of the invention.

1.-92. (canceled)

93. A method comprising:
receiving information associated with one or more players selected by at least one participant in a fantasy league for inclusion in a fantasy team associated with the at least participant;
receiving information provided by the at least one participant associated with at least one fantasy team attribute of the fantasy team associated with the at least participant;
receiving broadcast content in response to a request from the at least one participant;
retrieving non-broadcast information associated with any of the one or more players selected by the at least one participant for inclusion in the fantasy team associated with the at least participant;
transmitting one or more instructions to display a descriptor associated with at least one of the one or more players in accordance with their inclusion in the fantasy team associated with the at least one participant;
transmitting one or more instructions to display the non-broadcast information associated with at least one of the one or more players in accordance with their inclusion in the fantasy team associated with the at least one participant;
transmitting one or more instructions to display the at least one fantasy team attribute; and
transmitting one or more instructions to display the broadcast content as an overlay display.

94. The method of claim 93, wherein the receiving information associated with one or more players selected by at least one participant in a fantasy league for inclusion in a fantasy team associated with the at least participant comprises:
receiving one or more signals that include the information associated with the one or more players selected by the at least one participant in a fantasy league for inclusion in the fantasy team associated with the at least participant.

95.-97. (canceled)

98. The method of claim 93, wherein the receiving information associated with one or more players selected by at least one participant in a fantasy league for inclusion in a fantasy team associated with the at least participant comprises:
grouping the one or more players selected by the at least one participant into the at least one fantasy team and linking the fantasy team attribute to the fantasy team.

99.-100. (canceled)

101. The method of claim 93, wherein the receiving information provided by the at least one participant associated with at least one fantasy team attribute of the fantasy team associated with the at least participant comprises:
receiving information associated with at least one participant selected name associated with the at least one fantasy team.

102.-103. (canceled)

104. The method of claim 93, wherein the receiving information provided by the at least one participant associated with at least one fantasy team attribute of the fantasy team associated with the at least participant comprises:
receiving information associated with at least one participant selected symbol associated with the at least one fantasy team.

105.-107. (canceled)

108. The method of claim 93, wherein the receiving broadcast content in response to a request from the at least one participant comprises:
querying one or more listings of broadcast content to determine broadcast content that is associated with at least one of the one or more players that were selected by the at least one participant and then receiving the broadcast content that is associated with the one or more players that were selected by the at least one participant.

109.-110. (canceled)

111. The method of claim 93, wherein the receiving broadcast content in response to a request from the at least one participant comprises:
receiving broadcast content that includes information associated with one or more players selected by the at least one participant and then doing optical character recognition analysis to obtain positional information associated with any of the one or more players selected by the at least one participant that are included in the broadcast content.

112.-114. (canceled)

115. The method of claim 93, wherein the retrieving non-broadcast information associated with any of the one or more players selected by the at least one participant for inclusion in the fantasy team associated with the at least participant comprises:
querying one or more networks for non-broadcast information that is associated with at least one of the one or more players that were selected by the at least one participant and then receiving the non-broadcast information that is associated with the at least one of the one or more players that were selected by the at least one participant.

116. (canceled)

117. The method of claim 93, wherein the retrieving non-broadcast information associated with any of the one or more players selected by the at least one participant for inclusion in the fantasy team associated with the at least participant comprises:
retrieving information associated with one or more events associated with at least one of the one or more players that were selected by the at least one participant.

118. (canceled)

119. The method of claim 93, wherein the transmitting one or more instructions to display a descriptor associated with at least one of the one or more players in accordance with their inclusion in the fantasy team associated with the at least one participant comprises:
transmitting one or more signals that include the one or more instructions to display the descriptor associated with the one or more players selected by the at least one participant.

120.-126. (canceled)

127. The method of claim 93, wherein the transmitting one or more instructions to display the non-broadcast information associated with at least one of the one or more players in accordance with their inclusion in the fantasy team associated with the at least one participant comprises:
transmitting one or more instructions to display at least one event associated with at least one of the one or more players selected by the at least one participant.

128. The method of claim 93, wherein the transmitting one or more instructions to display the at least one fantasy team attribute comprises:
transmitting one or more signals that include the one or more instructions to display the fantasy team attribute selected by the at least one participant.

129.-131. (canceled)

132. The method of claim 93, wherein the transmitting one or more instructions to display the at least one fantasy team attribute comprises:
transmitting one or more instructions to display at least one participant selected symbol associated with the at least one fantasy team.

133.-135. (canceled)

136. The method of claim 93, wherein the transmitting one or more instructions to display the broadcast content as an overlay display comprises:
transmitting one or more instructions to display the broadcast content as an overlay display with a name associated with each of the one or more players selected by the at least one participant, the non-broadcast information associated with the one or more players, and the at least one fantasy team attribute.

137. (canceled)

138. The method of claim 93, wherein the transmitting one or more instructions to display the broadcast content as an overlay display comprises:
transmitting one or more instructions to display at least one fantasy team attribute selected by the at least one participant mapped onto at least one displayed image of at least one player selected by the at least one participant through use of positional information associated with the at least one player.

139.-141. (canceled)

142. The method of claim 93, further comprising:
transmitting one or more instructions to display one or more indicators in response to one or events associated with the one or more players.

143. The method of claim 142, wherein the transmitting one or more instructions to display one or more indicators in response to one or events associated with the one or more players comprises:
transmitting one or more signals that include the one or more instructions to display the one or more indicators in response to the one or events associated with the one or more players selected by the at least one participant.

144.-147. (canceled)

148. A system comprising:
circuitry configured to receive information associated with one or more players selected by at least one participant in a fantasy league for inclusion in a fantasy team associated with the at least participant;
circuitry configured to receive information provided by the at least one participant associated with at least one fantasy team attribute of the fantasy team associated with the at least participant;
circuitry configured to receive broadcast content in response to a request from the at least one participant;
circuitry configured to retrieve non-broadcast information associated with any of the one or more players selected by the at least one participant for inclusion in the fantasy team associated with the at least participant;
circuitry configured to transmit one or more instructions to display a descriptor associated with at least one of the one or more players in accordance with their inclusion in the fantasy team associated with the at least one participant;
circuitry configured to transmit one or more instructions to display the non-broadcast information associated with at least one of the one or more players in accordance with their inclusion in the fantasy team associated with the at least one participant;
circuitry configured to transmit one or more instructions to display the at least one fantasy team attribute; and
circuitry configured to transmit one or more instructions to display the broadcast content as an overlay display.

149. The system of claim 148, wherein the circuitry configured to receive information associated with one or more players selected by at least one participant in a fantasy league for inclusion in a fantasy team associated with the at least participant comprises:
circuitry configured to receive one or more signals that include the information associated with the one or more players selected by the at least one participant in a fantasy league for inclusion in the fantasy team associated with the at least participant.

150.-152. (canceled)

153. The system of claim 148, wherein the circuitry configured to receive information associated with one or more players selected by at least one participant in a fantasy league for inclusion in a fantasy team associated with the at least participant comprises:
circuitry configured to group the one or more players selected by the at least one participant into the at least one fantasy team and linking the fantasy team attribute to the fantasy team.

154. (canceled)

155. The system of claim 148, wherein the circuitry configured to receive information provided by the at least one participant associated with at least one fantasy team attribute of the fantasy team associated with the at least participant comprises:
circuitry configured to receive one or more signals that include the information associated with the at least one fantasy team attribute selected by the at least one participant.

156.-158. (canceled)

159. The system of claim 148, wherein the circuitry configured to receive information provided by the at least one participant associated with at least one fantasy team attribute of the fantasy team associated with the at least participant comprises:
circuitry configured to receive information associated with at least one participant selected symbol associated with the at least one fantasy team.

160.-162. (canceled)

163. The system of claim 148, wherein the circuitry configured to receive broadcast content in response to a request from the at least one participant comprises:
circuitry configured to query one or more listings of broadcast content to determine broadcast content that is associated with at least one of the one or more players that were selected by the at least one participant and then receiving the broadcast content that is associated with the one or more players that were selected by the at least one participant.

164.-165. (canceled)

166. The system of claim 148, wherein the circuitry configured to receive broadcast content in response to a request from the at least one participant comprises:
circuitry configured to receive broadcast content that includes information associated with one or more players selected by the at least one participant and then doing optical character recognition analysis to obtain positional information associated with any of the one or more players selected by the at least one participant that are included in the broadcast content.

167.-169. (canceled)

170. The system of claim 148, wherein the circuitry configured to retrieve non-broadcast information associated with any of the one or more players selected by the at least one participant for inclusion in the fantasy team associated with the at least participant comprises:
circuitry configured to query one or more networks for non-broadcast information that is associated with at least one of the one or more players that were selected by the at least one participant and then receiving the non-broadcast information that is associated with the at least one of the one or more players that were selected by the at least one participant.

171. (canceled)

172. The system of claim 148, wherein the circuitry configured to retrieve non-broadcast information associated with any of the one or more players selected by the at least one participant for inclusion in the fantasy team associated with the at least participant comprises:
circuitry configured to retrieve information associated with one or more events associated with at least one of the one or more players that were selected by the at least one participant.

173. (canceled)

174. The system of claim 148, wherein the circuitry configured to transmit one or more instructions to display a descriptor associated with at least one of the one or more players in accordance with their inclusion in the fantasy team associated with the at least one participant comprises:
circuitry configured to transmit one or more signals that include the one or more instructions to display the descriptor associated with the one or more players selected by the at least one participant.

175.-181. (canceled)

182. The system of claim 148, wherein the circuitry configured to transmit one or more instructions to display the non-broadcast information associated with at least one of the one or more players in accordance with their inclusion in the fantasy team associated with the at least one participant comprises:
circuitry configured to transmit one or more instructions to display at least one event associated with at least one of the one or more players selected by the at least one participant.

183. The system of claim 148, wherein the circuitry configured to transmit one or more instructions to display the at least one fantasy team attribute comprises:
circuitry configured to transmit one or more signals that include the one or more instructions to display the fantasy team attribute selected by the at least one participant.

184.-186. (canceled)

187. The system of claim 148, wherein the circuitry configured to transmit one or more instructions to display the at least one fantasy team attribute comprises:
circuitry configured to transmit one or more instructions to display at least one participant selected symbol associated with the at least one fantasy team.

188.-190. (canceled)

191. The system of claim 148, wherein the circuitry configured to transmit one or more instructions to display the broadcast content as an overlay display comprises:
circuitry configured to transmit one or more instructions to display the broadcast content as an overlay display with a name associated with each of the one or more players selected by the at least one participant, the non-broadcast information associated with the one or more players, and the at least one fantasy team attribute.

192.-193. (canceled)

194. The system of claim 148, wherein the circuitry configured to transmit one or more instructions to display the broadcast content as an overlay display comprises:
circuitry configured to transmit one or more instructions to display at least one fantasy team name selected by the at least one participant mapped onto at least one displayed image of at least one player selected by the at least one participant through use of positional information associated with the at least one player.

195.-196. (canceled)

197. The system of claim 148, further comprising:
circuitry configured to transmit one or more instructions to display one or more indicators in response to one or events associated with the one or more players.

198. The system of claim 197, wherein the circuitry configured to transmit one or more instructions to display one or more indicators in response to one or events associated with the one or more players comprises:
circuitry configured to transmit one or more signals that include the one or more instructions to display the one or more indicators in response to the one or more events associated with the one or more players selected by the at least one participant.

199.-202. (canceled)

203. A system comprising:
a non-transitory signal-bearing medium bearing one or more instructions that, when executed by one or more processing components, direct performance of operations that include at least:
receiving information associated with one or more players selected by at least one participant in a fantasy league for inclusion in a fantasy team associated with the at least participant;
receiving information provided by the at least one participant associated with at least one fantasy team attribute of the fantasy team associated with the at least participant;
receiving broadcast content in response to a request from at least one participant;
retrieving non-broadcast information associated with any of the one or more players selected by the at least one participant for inclusion in the fantasy team associated with the at least participant;
transmitting one or more instructions to display a descriptor associated with at least one of the one or more players in accordance with their inclusion in the fantasy team associated with the at least one participant;
transmitting one or more instructions to display the non-broadcast information associated with at least one of the one or more players in accordance with their inclusion in the fantasy team associated with the at least one participant;
transmitting one or more instructions to display the at least one fantasy team attribute; and
transmitting one or more instructions to display the broadcast content as an overlay display.

204. The system of claim 203, wherein the non-transitory signal-bearing medium further comprises:
one or more instructions that direct performance of an operation that includes at least transmitting one or more instructions to display one or more indicators in response to one or events associated with the one or more players.

205.-454. (canceled)
